(19) United States
(12) Patent Application Publication
(10) Pub. No.: US 2015/0231012 A1
(43) Pub. Date: Aug. 20, 2015

(54) INCUBATOR DEPLOYABLE MULTI-FUNCTIONAL PANEL

(71) Applicant: ASPECT IMAGING LTD., Shoham (IL)

(72) Inventor: Uri RAPOPORT, Moshav Ben Shemen (IL)

(21) Appl. No.: 14/619,557

(22) Filed: Feb. 11, 2015

Related U.S. Application Data
(60) Provisional application No. 61/940,514, filed on Feb. 17, 2014.
(60) Provisional application No. 61/991,637, filed on May 12, 2014.

(51) Int. Cl. A61G 11/00

(52) U.S. Cl. CPC A61G 11/006; A61G 11/007; A61G 2210/30; A61G 2200/14; A61G 2200/32

(57) ABSTRACT

An incubator including a plurality of panels. At least one of the panels, or portion thereof, is a multi functional panel that is reversibly connected to at least one of the plurality of panels. The incubator can be opened and closed. In a closed configuration, the incubator sealingly encloses an internal environment. In an open configuration, the multi-functional panel is deployable as a countertop.

### FIELD OF THE INVENTION

The present invention generally relates to the field of incubators, and more particularly, to a multi-functional deployable panel of an incubator, providing a life support countertop and methods thereof.

### BACKGROUND OF THE INVENTION

Premature babies and health compromised neonates and infants require specialized attentive care. This includes stable appropriate environmental conditions such as temperature and humidity. The newborn are also sensitive to noise, light and excessive vibration. In many cases, the neonates require medical life support to facilitate or monitor breathing, feeding, fluid exchange, body temperature and cardiac activity.

In neonatal intensive care units (NICU), incubators are utilized in order to maintain environmental conditions and provide round the clock support for the premature baby. Incubators are enclosed chambers housing the neonate, comprising a system for controlling its environment, and connecting to medical life support and monitoring equipment.

In order to provide care within the incubator, the handler needs to maintain access to the neonate. From general maintenance functions such as cleaning, tube exchanging, drawing blood samples to life support essential functions such as placing sensors, ventilating equipment and fluid exchange, direct comfortable approach is necessary for proper treatment.

Many times additional treatment is given to neonates during their hospitalization. These include treatments such as MRI, light therapy, blood transfusion, post-surgery care, eye examination, etc. These treatments require access of the medical personal to the neonate, and in many times require extraction of the neonate out of the incubator in order to receive treatment.

Moreover, in situations where the neonate requires immediate emergency treatment, there is need for direct contact to the infant still connected to life support medical equipment.

As the incubator is an enclosed chamber, it is in many cases an obstacle to a quick and efficient approach to the neonate. Further, cumbersome approach to the neonate afflicts on care it is given. In addition, constantly changing the neonate's placement enhances the discomfort of the neonate and further enhances the opportunity for a falling accident. Any placement onto which the neonate is placed should be able to connect to life support equipment or accept the life support equipment already connected to the neonate in order to provide continuity in medical support and prevent health complications.

There is thus a long felt need in the art for an incubator that can be opened to provide direct and comfortable access to the neonate by medical personal, care givers, technicians and chaperons while deploying a life supporting countertop, keeping all of the life support equipment available and active.

Prior art incubators include Delaporte, US20100168502, which disclosed a neonatal care system integrated with a hospital bassinet which is made up of a bassinet bed and a frame. The frame for the bassinet acts as both a structural support system and a means for transportation when the neonatal care incubator is attached at the top of the frame. The neonatal intensive care system comprising: an infant incubator comprising: a base configured for supporting an infant, the base defining a low profile volume including an open top; and an adjustable hood coupled over the open top of the base, wherein in one configuration the hood collapses completely into the base.

However, the above mentioned incubator cannot supply the life-support environment to the neonate, in its open or collapsed configurations.

Accordingly, there is a need for an incubator that can be opened and deployed to a life supporting countertop, while keeping all of the life supporting equipment active and available.

### SUMMARY OF THE INVENTION

The present invention provides an incubator, comprising n panels, at least one of which or portion thereof is a multi functional panel (MFP), reversibly connected to at least one of the n panels; n is an integer equal to or greater than 3; the incubator is characterized by at least one first CLOSED CONFIGURATION, sealingly enclosing an internal environment of the incubator; and at least one first OPEN CONFIGURATION, in which the MFP is deployable as a countertop.

It is another object of the current invention to disclose the incubator defined in any of the above, wherein the incubator comprising life support equipment.

It is another object of the current invention to disclose the incubator defined in any of the above, wherein the incubator, in the closed configuration, encloses a neonate in an internal environment.

It is another object of the current invention to disclose the incubator defined in any of the above, wherein the incubator comprising internal environmental control means.

It is another object of the current invention to disclose the incubator defined in any of the above, wherein the open configuration forms an open environment incubator.

It is another object of the current invention to disclose the incubator defined in any of the above, wherein at least a portion of the life support equipment is integrated into at least one or a portion thereof selected from a group consisting of: one of the n panels, the MFP and any combination thereof.

It is another object of the current invention to disclose the incubator defined in any of the above, wherein the MFP is integrated into at least one of the n panels, when in the closed configuration.

It is another object of the current invention to disclose the incubator defined in any of the above, wherein the MFP is layered on at least one of the n panels, when in the closed configuration.

It is another object of the current invention to disclose the incubator defined in any of the above, wherein the MFP is maneuverably connected to the incubator by a mechanism selected from a group consisting of: hinge mechanism, pivot point mechanism, sliding mechanism, telescopic mechanism, magnetic attachment mechanism and any combination thereof.

It is another object of the current invention to disclose the incubator defined in any of the above, wherein the MFP is reversibly connectable to another apparatus selected from a group consisting of: operating table, stretcher, gurney, cart, bed, crib, imaging device, transport incubator, treatment table and any combination thereof.

It is another object of the current invention to disclose the incubator defined in any of the above, wherein the MFP is deployable to a planar surface selected from a group consisting of horizontal, vertical, angled and any combination thereof.

It is another object of the current invention to disclose the incubator defined in any of the above, wherein the MFP comprises at least two sections.

It is another object of the current invention to disclose the incubator defined in any of the above, wherein at least a section of the MFP is deployable to a planar surface selected from a group consisting of horizontal, vertical, angled and any combination thereof.

It is another object of the current invention to disclose the incubator defined in any of the above, wherein the MFP sections are maneuverably connected therebetween by a mechanism selected from a group consisting of: hinge mechanism, pivot point mechanism, sliding mechanism, telescopic mechanism, magnetic attachment mechanism and any combination thereof.

It is another object of the current invention to disclose the incubator defined in any of the above, wherein the MFP comprising side bars.

It is another object of the current invention to disclose the incubator defined in any of the above, comprising side bars, wherein the side bars are maneuverably connected to the MFP.

It is another object of the current invention to disclose the incubator defined in any of the above, wherein the MFP comprises at least one support connecting the MFP to an element selected from a group consisting of: the incubator, an incubator's cart, the ground, a vertical wall, a transport vehicle, an imaging system, and any combination thereof.

It is another object of the current invention to disclose the incubator defined in any of the above, wherein the MFP support is foldable.

It is another object of the current invention to disclose the incubator defined in any of the above, wherein at least a portion of the MFP comprising at least partially transparent material.

It is another object of the current invention to disclose the incubator defined in any of the above, wherein the MFP comprising at least one opening.

It is another object of the current invention to disclose the incubator defined in any of the above, wherein the MFP opening comprising a closable door.

It is another object of the current invention to disclose the incubator defined in any of the above, wherein the MFP opening is sized and shaped for the passage of life support equipment.

It is another object of the current invention to disclose the incubator defined in any of the above, wherein the MFP opening is sized and shaped for the passage of a handler's hand.

It is another object of the current invention to disclose the incubator defined in any of the above, wherein the MFP opening is connected to an element selected from a group consisting of: a container, a tube, ventilation equipment, life supporting element, viewing equipment, temperature regulating system, waste disposal, and any combination thereof.

It is another object of the current invention to disclose the incubator defined in any of the above, wherein at least a portion of the MFP is connected to life support equipment.

It is another object of the current invention to disclose the incubator defined in any of the above, wherein the MFP comprising at least one life support element.

It is another object of the current invention to disclose the incubator defined in any of the above, wherein at least a portion of the life support element is accommodated within the incubator.

It is another object of the current invention to disclose the incubator defined in any of the above, wherein the MFP comprising a temperature regulating system.

It is another object of the current invention to disclose the incubator defined in any of the above, wherein the temperature regulating system regulates the temperature of a selected from a group consisting of: the MFP, the incubator, a neonate, the incubator's inner volume and any combination thereof.

It is another object of the current invention to disclose the incubator defined in any of the above, wherein at least a portion of the MFP comprising at least one sterilizable material.

It is another object of the current invention to disclose the incubator defined in any of the above, wherein the incubator is reversibly connected to a mobile cart.

It is another object of the current invention to disclose the incubator defined in any of the above, wherein at least a portion of the MFP is reversibly connected to a mobile cart.

It is another object of the current invention to disclose the incubator defined in any of the above, wherein at least a portion of the incubator comprising MRI safe material.

It is another object of the current invention to disclose the incubator defined in any of the above, wherein the incubator comprising an ergonomic placement for at least a portion of a neonate.

It is another object of the current invention to disclose the incubator defined in any of the above, wherein the incubator comprising means to secure a neonate within the incubator.

It is another object of the current invention to disclose the incubator defined in any of the above, wherein the incubator comprising means to secure a neonate on top the MFP.

It is another object of the current invention to disclose the incubator defined in any of the above, wherein the MFP comprising at least one sensor selected from a group consisting of:

temperature, humidity, respiratory rate, weight, pressure, vibration, gas concentration, movement, closed or opened configuration of the incubator and any combination thereof.

It is another object of the current invention to disclose the incubator defined in any of the above, wherein the sensor is connected to a component selected from a group consisting of: a CPU, an alarm system, a user interface, life support equipment, at least one indicator and any combination thereof.

It is another object of the current invention to disclose the incubator defined in any of the above, wherein the incubator comprising a latching mechanism, configured to secure the incubator in a closed or opened configuration.

It is another object of the current invention to disclose the incubator defined in any of the above, wherein the incubator comprising at least one mechanism, connected to at least a portion of the MFP, configured to transform at least one first open configuration to at least one first closed configuration, at least one closed configuration to at least one open configuration, or both.

It is another object of the current invention to disclose the incubator defined in any of the above, wherein the opening mechanism is an emergency opening mechanism.

It is another object of the current invention to disclose the incubator defined in any of the above, wherein the mechanism is selected from a group consisting of: manual, automatic, and any combination thereof.

It is another object of the current invention to disclose the incubator defined in any of the above, wherein the MFP comprising a lighting system.

It is another object of the current invention to disclose the incubator defined in any of the above, wherein the lighting system comprising to have at least one mode of lighting for each configuration of the incubator.

It is another object of the current invention to disclose the incubator defined in any of the above, wherein the lighting system comprising at least one first lighting mode for within the incubator enclosed environment and at least one first lighting mode for the incubator from the outside.

It is another object of the current invention to disclose the incubator defined in any of the above, wherein the lighting system is maneuverable.

It is another object of the current invention to disclose the incubator defined in any of the above, wherein the lighting system is operable manually, automatically or both.

It is another object of the current invention to disclose the incubator defined in any of the above, wherein the lighting system comprising at least two light spectrums, at least two intensities, or both.

It is another object of the current invention to disclose the incubator defined in any of the above, wherein the lighting system is connected to one selected from a group consisting of: the incubator, the MFP, CPU, an alarm system, an interlock mechanism, a user interface, a power supply, and any combination thereof.

It is another object of the current invention to disclose the incubator defined in any of the above, wherein an interlock mechanism is connected to one selected from a group consisting of: the incubator, the MFP, a CPU, a user interface, an alarm system, an opening mechanism, a closing mechanism and any combination thereof.

It is another object of the current invention to disclose the incubator defined in any of the above, wherein the mechanism is set to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

It is another object of the current invention to disclose the incubator defined in any of the above, wherein the MFP comprising at least one indicator selected from a group consisting of: visual indicator, auditable indicator, sensible indicator and any combination thereof.

It is another object of the current invention to disclose the incubator defined in any of the above, wherein the MFP comprising a placement for an element selected from a group consisting of: life support equipment, medical tools, disposable waste, medical tubing, disposable mattress, cleaning and disinfecting equipment, and any combination thereof.

It is another object of the current invention to disclose the incubator defined in any of the above, wherein the MFP is reversibly connectable to another apparatus selected from a group consisting of: operating table, stretcher, gurney, cart, bed, crib, imaging device, transport incubator, treatment table and any combination thereof.

It is another object of the current invention to disclose the incubator defined in any of the above, wherein the MFP comprising an emergency release mechanism, configured to release a neonate from the incubator in one step.

It is another object of the current invention to disclose the incubator defined in any of the above, wherein the MFP is connected to a power supply selected from a group consisting of: external power supply, internal power supply and any combination thereof.

It is another object of the current invention to disclose the incubator defined in any of the above, wherein the incubator comprising a CPU configured to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose the incubator defined in any of the above, wherein the CPU is connected to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose the incubator defined in any of the above, comprising a remote control mechanism; wherein the remote control mechanism controls a component selected from a group consisting of: opening mechanism, closing mechanism, CPU, lighting, temperature regulating system, life support equipment, ventilating system, alarm system, power supply, and any combination thereof.

It is another object of the current invention to disclose the incubator defined in any of the above, wherein the incubator comprises a user interface.

It is another object of the current invention to disclose the incubator defined in any of the above, wherein at least a portion of the user interface is integrated into at least one selected from a group consisting of: at least one of the n panels, the MFP and any combination thereof.

It is another object of the current invention to disclose the incubator defined in any of the above, wherein the user interface is connected to a component selected from a group consisting of: the MFP, life support equipment, at least one sensor, CPU, power supply, temperature regulating system, lighting system, at least one indicator, display, and any combination thereof.

It is another object of the current invention to disclose the incubator defined in any of the above, wherein the incubator comprises an alarm system.

It is another object of the current invention to disclose the incubator defined in any of the above, wherein the alarm system is connected to a component selected from a group consisting of: the MFP, at least one sensor, at least one indicator, a user interface, a CPU, an interlock mechanism, life support equipment and any combination thereof.

It is another object of the current invention to disclose the incubator defined in any of the above, wherein the MFP comprises a handle.

It is another object of the current invention to disclose the incubator defined in any of the above, wherein the deployment of the incubator from an open configuration to a closed configuration maintains an accommodated neonate immovable.

It is another object of the current invention to disclose the incubator defined in any of the above, wherein the incubator comprising at least one opening and closing mechanism, the mechanism is connected to at least a portion of the MFP, and to at least a portion of at least a second of the n incubator panels, further wherein the mechanism is configured to maneuver the MFP such that the incubator is provided with the at least one first open configuration and the at least one first closed configuration.

It is another object of the current invention to disclose the incubator defined in any of the above, wherein the incubator comprising at least one collapsible column, useful for supporting the MFP, the column comprising an elongated member having at least two opposite ends, further wherein at least one first end is maneuverably connected to the MFP, and at least one second end is reversibly connected to an element selected from a group consisting of: a cart, a storage unit, a transport device, a wall, the floor, an imaging apparatus, a treatment table, and any combination thereof.

It is another object of the current invention to disclose the incubator defined in any of the above, wherein the column is configured to be NORMALLY DEPLOYED when the incubator is in an open configuration.

It is another object of the current invention to disclose the incubator defined in any of the above, wherein the column is connected to a mechanism configured to close the MFP when column is collapsed.

It is another object of the current invention to disclose the incubator defined in any of the above, comprising a collapsible column, wherein the column is connected to the MFP by a mechanism configured to collapse the column when the incubator is in a closed configuration.

It is another object of the current invention to disclose the incubator defined in any of the above, wherein the column is collapsible upon application of horizontal force in the axis of at least partial interception of the incubator within a selected from a group consisting of: an MRD, a medical treatment device, a transport device and any combination thereof.

It is another object of the current invention to disclose the incubator defined in any of the above, wherein the column is connected by a reversible connection, a maneuverable connection or both.

It is another object of the current invention to disclose the incubator defined in any of the above, wherein the column is foldable or retractable.

It is another object of the current invention to disclose the incubator defined in any of the above, wherein the column is of a shape selected from a group consisting of: round, multifaceted, geometric, non-geometric, compound shape, and any combination thereof.

It is another object of the current invention to disclose the incubator defined in any of the above, wherein the column is comprised of a plurality of interconnected pieces.

It is another object of the current invention to disclose the incubator defined in any of the above; wherein the incubator comprising at least one mechanism, connected to at least a portion of the MFP, configured to transform at least one first open configuration to at least one first closed configuration, at least one closed configuration to at least one open configuration, or both.

It is another object of the current invention to disclose the incubator defined in any of the above, wherein the mechanism comprises horizontal movement means, thereby enabling closing or opening of a sliding mechanism.

It is another object of the current invention to disclose the incubator defined in any of the above, wherein the mechanism comprises rotating movement means around a pivot point.

It is another object of the current invention to disclose the incubator defined in any of the above, wherein the mechanism comprises a magnetic opening and closing means.

It is another object of the current invention to disclose the incubator defined in any of the above, wherein the mechanism comprises an electromagnetic lock.

It is another object of the current invention to disclose the incubator defined in any of the above, comprising at least a portion of an external face exposed to the external environment and at least a portion of an internal face exposed to the internal environment, wherein the mechanism is selected from a group consisting of: a concealed mechanism, a mechanism mounted on at least a portion of the external face of the incubator, a mechanism mounted on at least a portion of the internal face of the incubator, at least partially embedded within at least a portion of the MFP, at least partially embedded within at least a portion of the incubator, and any combination thereof.

It is another object of the current invention to disclose the incubator defined in any of the above, wherein the mechanism is a normally closed mechanism, thereby maintaining the incubator in a closed configuration when in a resting position.

It is another object of the current invention to disclose the incubator defined in any of the above, wherein the mechanism is a normally opened mechanism, thereby maintaining the incubator in an open configuration when in a resting position.

It is another object of the current invention to disclose the incubator defined in any of the above, wherein the incubator comprises a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof.

It is another object of the current invention to disclose the incubator defined in any of the above, wherein the MFP is connected to the incubator by at least one living hinge.

It is another object of the current invention to disclose the incubator defined in any of the above, wherein the mechanism comprises a selected from a group consisting of: a push to open mechanism, a push to close mechanism, a self-closing mechanism, a soft closing mechanism, a soft opening mechanism, and any combination thereof.

It is another object of the current invention to disclose the incubator defined in any of the above, comprising a plurality of MFP, wherein the incubator comprises a plurality of sliding mechanism for each the MFP; wherein the mechanisms are interconnected so as to provide simultaneous movement, when the incubator transforms between the opened and closed configurations.

It is another object of the current invention to disclose the incubator defined in any of the above, comprising a plurality of MFPs, wherein maneuvering at least one first MFP, results in maneuvering of at least one second MFP.

It is another object of the current invention to disclose the incubator defined in any of the above, wherein the MFP comprises at least a portion of a flexible flap.

It is another object of the current invention to disclose the incubator defined in any of the above, wherein the incubator comprises a base, and at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

It is another object of the current invention to disclose the incubator defined in any of the above, wherein the incubator is connected to a mobile cart containing at least a portion of the mechanism.

It is another object of the current invention to disclose the incubator defined in any of the above, comprising a plurality of MFP's, at least one opening mechanism, closing mechanism, or both, connected to each MFP, at least two of the maneuvering systems are interconnected to at least one bar; the bar is further interconnected to a main moveable shaft having a protrusion external to the incubator, wherein the moveable shaft is configured to maneuvering the connected MFP's thereby closing or opening the incubator.

It is another object of the current invention to disclose the incubator defined in any of the above, wherein the mechanism is configured to have a controlled soft closure mechanism.

It is another object of the current invention to disclose the incubator defined in any of the above, wherein the mechanism is selected from a group consisting of: manual, automatic, and any combination thereof.

It is another object of the current invention to disclose the incubator defined in any of the above, wherein the mechanism is connected to a power supply selected from a group consisting of: AC, DC and any combination thereof.

It is another object of the current invention to disclose the incubator defined in any of the above, wherein the incubator alternates between the open configuration to a closed configuration by a remote control mechanism.

It is another object of the current invention to disclose the incubator defined in any of the above, wherein the opening mechanism is an emergency opening mechanism.

It is another object of the current invention to disclose the incubator defined in any of the above, wherein the mechanism comprises an interlock mechanism.

The present invention provides in an incubator, comprising n panels, a multi functional panel (MFP) reversibly connected to at least a one of the n panels; n is an integer equal to or greater than 3; characterized by at least one first CLOSED CONFIGURATION, sealingly enclosing internal environment of the incubator; and at least one first OPEN CONFIGURATION, in which the MFP is deployable as a countertop.

It is another object of the current invention to disclose the MFP defined in any of the above, wherein the incubator comprising life support equipment.

It is another object of the current invention to disclose the MFP defined in any of the above, wherein the incubator, in the closed configuration, encloses a neonate in an internal environment.

It is another object of the current invention to disclose the MFP defined in any of the above, wherein the incubator comprising internal environmental control means.

It is another object of the current invention to disclose the MFP defined in any of the above, wherein the open configuration forms an open environment incubator.

It is another object of the current invention to disclose the MFP defined in any of the above, wherein at least a portion of the life support equipment is integrated into at least one or a portion thereof selected from a group consisting of: one of the n panels, the MFP and any combination thereof.

It is another object of the current invention to disclose the MFP defined in any of the above, wherein the MFP is integrated into at least one of the n panels, when in the closed configuration.

It is another object of the current invention to disclose the MFP defined in any of the above, wherein the MFP is layered on at least one of the n panels, when in the closed configuration.

It is another object of the current invention to disclose the MFP defined in any of the above, wherein the MFP is maneuverably connected to the incubator by a mechanism selected from a group consisting of: hinge mechanism, pivot point mechanism, sliding mechanism, telescopic mechanism, magnetic attachment mechanism and any combination thereof.

It is another object of the current invention to disclose the MFP defined in any of the above, wherein the MFP is reversibly connectable to another apparatus selected from a group consisting of: operating table, stretcher, gurney, cart, bed, crib, imaging device, transport incubator, treatment table and any combination thereof.

It is another object of the current invention to disclose the MFP defined in any of the above, wherein the MFP is deployable to a planar surface selected from a group consisting of horizontal, vertical, angled and any combination thereof.

It is another object of the current invention to disclose the MFP defined in any of the above, wherein the MFP comprises at least two sections.

It is another object of the current invention to disclose the MFP defined in any of the above, wherein at least a section of the MFP is deployable to a planar surface selected from a group consisting of horizontal, vertical, angled and any combination thereof.

It is another object of the current invention to disclose the MFP defined in any of the above, wherein the MFP sections are maneuverably connected therebetween by a mechanism selected from a group consisting of: hinge mechanism, pivot point mechanism, sliding mechanism, telescopic mechanism, magnetic attachment mechanism and any combination thereof.

It is another object of the current invention to disclose the MFP defined in any of the above, wherein the MFP comprising side bars.

It is another object of the current invention to disclose the MFP defined in any of the above, comprising side bars, wherein the side bars are maneuverably connected to the MFP.

It is another object of the current invention to disclose the MFP defined in any of the above, wherein the MFP comprises at least one support connecting the MFP to an element selected from a group consisting of: the incubator, an incubator's cart, the ground, a vertical wall, a transport vehicle, an imaging system, and any combination thereof.

It is another object of the current invention to disclose the MFP defined in any of the above, wherein the MFP support is foldable.

It is another object of the current invention to disclose the MFP defined in any of the above, wherein at least a portion of the MFP comprising at least partially transparent material.

It is another object of the current invention to disclose the MFP defined in any of the above, wherein the MFP comprising at least one opening.

It is another object of the current invention to disclose the MFP defined in any of the above, wherein the MFP opening comprising a closable door.

It is another object of the current invention to disclose the MFP defined in any of the above, wherein the MFP opening is sized and shaped for the passage of life support equipment.

It is another object of the current invention to disclose the MFP defined in any of the above, wherein the MFP opening is sized and shaped for the passage of a handler's hand.

It is another object of the current invention to disclose the MFP defined in any of the above, wherein the MFP opening is connected to an element selected from a group consisting of: a container, a tube, ventilation equipment, life supporting element, viewing equipment, temperature regulating system, waste disposal, and any combination thereof.

It is another object of the current invention to disclose the MFP defined in any of the above, wherein at least a portion of the MFP is connected to life support equipment.

It is another object of the current invention to disclose the MFP defined in any of the above, wherein the MFP comprising at least one life support element.

It is another object of the current invention to disclose the MFP defined in any of the above, wherein at least a portion of the life support element is accommodated within the incubator.

It is another object of the current invention to disclose the MFP defined in any of the above, wherein the MFP comprising a temperature regulating system.

It is another object of the current invention to disclose the MFP defined in any of the above, wherein the temperature regulating system regulates the temperature of a selected from a group consisting of: the MFP, the incubator, a neonate, the incubator's inner volume and any combination thereof.

It is another object of the current invention to disclose the MFP defined in any of the above, wherein at least a portion of the MFP comprising at least one sterilizable material.

It is another object of the current invention to disclose the MFP defined in any of the above, wherein the incubator is reversibly connected to a mobile cart.

It is another object of the current invention to disclose the MFP defined in any of the above, wherein at least a portion of the MFP is reversibly connected to a mobile cart.

It is another object of the current invention to disclose the MFP defined in any of the above, wherein at least a portion of the incubator comprising MRI safe material.

It is another object of the current invention to disclose the MFP defined in any of the above, wherein the incubator comprising an ergonomic placement for at least a portion of a neonate.

It is another object of the current invention to disclose the MFP defined in any of the above, wherein the incubator comprising means to secure a neonate within the incubator.

It is another object of the current invention to disclose the MFP defined in any of the above, wherein the incubator comprising means to secure a neonate on top the MFP.

It is another object of the current invention to disclose the MFP defined in any of the above, wherein the MFP comprising at least one sensor selected from a group consisting of: temperature, humidity, respiratory rate, weight, pressure, vibration, gas concentration, movement, closed or opened configuration of the incubator and any combination thereof.

It is another object of the current invention to disclose the MFP defined in any of the above, wherein the sensor is connected to a component selected from a group consisting of: a CPU, an alarm system, a user interface, life support equipment, at least one indicator and any combination thereof.

It is another object of the current invention to disclose the MFP defined in any of the above, wherein the incubator comprising a latching mechanism, configured to secure the incubator in a closed or opened configuration.

It is another object of the current invention to disclose the MFP defined in any of the above, wherein the incubator comprising at least one mechanism, connected to at least a portion of the MFP, configured to transform at least one first open configuration to at least one first closed configuration, at least one closed configuration to at least one open configuration, or both.

It is another object of the current invention to disclose the MFP defined in any of the above, wherein the opening mechanism is an emergency opening mechanism.

It is another object of the current invention to disclose the MFP defined in any of the above, wherein the mechanism is selected from a group consisting of: manual, automatic, and any combination thereof.

It is another object of the current invention to disclose the MFP defined in any of the above, wherein the MFP comprising a lighting system.

It is another object of the current invention to disclose the MFP defined in any of the above, wherein the lighting system comprising to have at least one mode of lighting for each configuration of the incubator.

It is another object of the current invention to disclose the MFP defined in any of the above, wherein the lighting system comprising at least one first lighting mode for within the incubator enclosed environment and at least one first lighting mode for the incubator from the outside.

It is another object of the current invention to disclose the MFP defined in any of the above, wherein the lighting system is maneuverable.

It is another object of the current invention to disclose the MFP defined in any of the above, wherein the lighting system is operable manually, automatically or both.

It is another object of the current invention to disclose the MFP defined in any of the above, wherein the lighting system comprising at least two light spectrums, at least two intensities, or both.

It is another object of the current invention to disclose the MFP defined in any of the above, wherein the lighting system is connected to one selected from a group consisting of: the incubator, the MFP, CPU, an alarm system, an interlock mechanism, a user interface, a power supply, and any combination thereof.

It is another object of the current invention to disclose the MFP defined in any of the above, wherein an interlock mechanism is connected to one selected from a group consisting of: the incubator, the MFP, a CPU, a user interface, an alarm system, an opening mechanism, a closing mechanism and any combination thereof.

It is another object of the current invention to disclose the MFP defined in any of the above, wherein the mechanism is set to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

It is another object of the current invention to disclose the MFP defined in any of the above, wherein the MFP comprising at least one indicator selected from a group consisting of: visual indicator, auditable indicator, sensible indicator and any combination thereof.

It is another object of the current invention to disclose the MFP defined in any of the above, wherein the MFP comprising a placement for an element selected from a group consisting of: life support equipment, medical tools, disposable waste, medical tubing, disposable mattress, cleaning and disinfecting equipment, and any combination thereof.

It is another object of the current invention to disclose the MFP defined in any of the above, wherein the MFP is reversibly connectable to another apparatus selected from a group consisting of: operating table, stretcher, gurney, cart, bed, crib, imaging device, transport incubator, treatment table and any combination thereof.

It is another object of the current invention to disclose the MFP defined in any of the above, wherein the MFP comprising an emergency release mechanism, configured to release a neonate from the incubator in one step.

It is another object of the current invention to disclose the MFP defined in any of the above, wherein the MFP is connected to a power supply selected from a group consisting of: external power supply, internal power supply and any combination thereof.

It is another object of the current invention to disclose the MFP defined in any of the above, wherein the incubator comprising a CPU configured to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose the MFP defined in any of the above, wherein the CPU is connected to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose the MFP defined in any of the above, comprising a remote control mechanism; wherein the remote control mechanism controls a component selected from a group consisting of: opening mechanism, closing mechanism, CPU, lighting, temperature regulating system, life support equipment, ventilating system, alarm system, power supply, and any combination thereof.

It is another object of the current invention to disclose the MFP defined in any of the above, wherein the incubator comprises a user interface.

It is another object of the current invention to disclose the MFP defined in any of the above, wherein at least a portion of the user interface is integrated into at least one selected from a group consisting of: at least one of the n panels, the MFP and any combination thereof.

It is another object of the current invention to disclose the MFP defined in any of the above, wherein the user interface is connected to a component selected from a group consisting of: the MFP, life support equipment, at least one sensor, CPU, power supply, temperature regulating system, lighting system, at least one indicator, display, and any combination thereof.

It is another object of the current invention to disclose the MFP defined in any of the above, wherein the incubator comprises an alarm system.

It is another object of the current invention to disclose the MFP defined in any of the above, wherein the alarm system is connected to a component selected from a group consisting of: the MFP, at least one sensor, at least one indicator, a user interface, a CPU, an interlock mechanism, life support equipment and any combination thereof.

It is another object of the current invention to disclose the MFP defined in any of the above, wherein the MFP comprises a handle.

It is another object of the current invention to disclose the MFP defined in any of the above, wherein the deployment of the incubator from an open configuration to a closed configuration maintains an accommodated neonate immovable.

It is another object of the current invention to disclose the MFP defined in any of the above, wherein the incubator comprising at least one opening and closing mechanism, the mechanism is connected to at least a portion of the MFP, and to at least a portion of one of the n incubator panels, further wherein the mechanism is configured to maneuver the MFP such that the incubator is provided with the at least one first open configuration and the at least one first closed configuration.

It is another object of the current invention to disclose the MFP defined in any of the above, wherein the incubator comprising at least one collapsible column, useful for supporting the MFP, the column comprising an elongated member having at least two opposite ends, further wherein at least one first end is maneuverably connected to the MFP, and at least one second end is reversibly connected to an element selected from a group consisting of: a cart, a storage unit, a transport device, a wall, the floor, an imaging apparatus, a treatment table, and any combination thereof.

It is another object of the current invention to disclose the MFP defined in any of the above, wherein the column is configured to be NORMALLY DEPLOYED when the incubator is in an open configuration.

It is another object of the current invention to disclose the MFP defined in any of the above, comprising a collapsible column, wherein the column is connected to a mechanism configured to close the MFP when column is collapsed.

It is another object of the current invention to disclose the MFP defined in any of the above, comprising a collapsible column, wherein the column is connected to the MFP by a mechanism configured to collapse the column when the incubator is in a closed configuration.

It is another object of the current invention to disclose the MFP defined in any of the above, wherein the column is collapsible upon application of horizontal force in the axis of at least partial interception of the incubator within a selected from a group consisting of: an MRD, a medical treatment device, a transport device and any combination thereof.

It is another object of the current invention to disclose the MFP defined in any of the above, wherein the column is connected by a reversible connection, a maneuverable connection or both.

It is another object of the current invention to disclose the MFP defined in any of the above, wherein the column is foldable or retractable.

It is another object of the current invention to disclose the MFP defined in any of the above, wherein the column is of a shape selected from a group consisting of: round, multifaceted, geometric, non-geometric, compound shape, and any combination thereof.

It is another object of the current invention to disclose the MFP defined in any of the above, wherein the column is comprised of a plurality of interconnected pieces.

It is another object of the current invention to disclose the MFP defined in any of the above; wherein the incubator comprising at least one mechanism, connected to at least a portion of the MFP, configured to transform at least one first open configuration to at least one first closed configuration, at least one closed configuration to at least one open configuration, or both.

It is another object of the current invention to disclose the MFP defined in any of the above, wherein the mechanism comprises horizontal movement means, thereby enabling closing or opening of a sliding mechanism.

It is another object of the current invention to disclose the MFP defined in any of the above, wherein the mechanism comprises rotating movement means around a pivot point.

It is another object of the current invention to disclose the MFP defined in any of the above, wherein the mechanism comprises a magnetic opening and closing means.

It is another object of the current invention to disclose the MFP defined in any of the above, wherein the mechanism comprises an electromagnetic lock.

It is another object of the current invention to disclose the MFP defined in any of the above, comprising at least a portion of an external face exposed to the external environment and at least a portion of an internal face exposed to the internal environment, wherein the mechanism is selected from a group consisting of: a concealed mechanism, a mechanism mounted on at least a portion of the external face of the incubator, a mechanism mounted on at least a portion of the internal face of the incubator, at least partially embedded within at least a portion of the MFP, at least partially embedded within at least a portion of the incubator, and any combination thereof.

It is another object of the current invention to disclose the MFP defined in any of the above, wherein the mechanism is a normally closed mechanism, thereby maintaining the incubator in a closed configuration when in a resting position.

It is another object of the current invention to disclose the MFP defined in any of the above, wherein the mechanism is a normally opened mechanism, thereby maintaining the incubator in an open configuration when in a resting position.

It is another object of the current invention to disclose the MFP defined in any of the above, wherein the incubator comprises a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof.

It is another object of the current invention to disclose the MFP defined in any of the above, wherein the MFP is connected to the incubator by at least one living hinge.

It is another object of the current invention to disclose the MFP defined in any of the above, wherein the mechanism comprises a selected from a group consisting of: a push to open mechanism, a push to close mechanism, a self-closing mechanism, a soft closing mechanism, a soft opening mechanism, and any combination thereof.

It is another object of the current invention to disclose the MFP defined in any of the above, comprising a plurality of MFP, wherein the incubator comprises a plurality of sliding mechanism for each the MFP; wherein the mechanisms are interconnected so as to provide simultaneous movement, when the incubator transforms between the opened and closed configurations.

It is another object of the current invention to disclose the MFP defined in any of the above, comprising a plurality of MFPs, wherein maneuvering at least one first MFP, results in maneuvering of at least one second MFP.

It is another object of the current invention to disclose the MFP defined in any of the above, wherein the MFP comprises at least a portion of a flexible flap.

It is another object of the current invention to disclose the MFP defined in any of the above, wherein the incubator comprises a base, and at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

It is another object of the current invention to disclose the MFP defined in any of the above, wherein the incubator is connected to a mobile cart containing at least a portion of the mechanism.

It is another object of the current invention to disclose the MFP defined in any of the above, comprising a plurality of MFP's, at least one opening mechanism, closing mechanism, or both, connected to each MFP, at least two of the maneuvering systems are interconnected to at least one bar; the bar is further interconnected to a main moveable shaft having a protrusion external to the incubator, wherein the moveable shaft is configured to maneuvering the connected MFP's thereby closing or opening the incubator.

It is another object of the current invention to disclose the MFP defined in any of the above, wherein the mechanism is configured to have a controlled soft closure mechanism.

It is another object of the current invention to disclose the MFP defined in any of the above, wherein the mechanism is selected from a group consisting of: manual, automatic, and any combination thereof.

It is another object of the current invention to disclose the MFP defined in any of the above, wherein the mechanism is connected to a power supply selected from a group consisting of: AC, DC and any combination thereof.

It is another object of the current invention to disclose the MFP defined in any of the above, wherein the incubator alternates between the open configuration to a closed configuration by a remote control mechanism.

It is another object of the current invention to disclose the MFP defined in any of the above, wherein the opening mechanism is an emergency opening mechanism.

It is another object of the current invention to disclose the MFP defined in any of the above, wherein the mechanism comprises an interlock mechanism.

The present invention provides a method for manufacturing an incubator, comprising steps of: (a) obtaining an incubator, comprising n panels; n is an integer equals to or greater than 3; (b) obtaining at least one panel or portion thereof a multi functional panel (MFP); and (c) reversibly connecting the MFP to at least one of the n panels; wherein the step of reversibly connecting the MFP to at least one of the n panels is characterized by creating at least one first CLOSED CONFIGURATION, sealingly enclosing internal environment of the incubator; and at least one first OPEN CONFIGURATION, in which the MFP is deployed as a countertop.

It is another object of the current invention to disclose a method as described above, additionally comprising a step of constructing the closed configuration enclosing a neonate in an internal environment.

It is another object of the current invention to disclose a method as described above, additionally comprising a step of connecting the incubator to internal environmental control means.

It is another object of the current invention to disclose a method as described above, additionally comprising a step of forming the open configuration to an open environment incubator.

It is another object of the current invention to disclose a method as described above, additionally comprising a step of constructing the incubator having life support equipment.

It is another object of the current invention to disclose a method as described above, additionally comprising a step of at integrating at least a portion of the life support equipment into at least one selected from a group consisting of: one of the n panels, the MFP and any combination thereof.

It is another object of the current invention to disclose a method as described above, additionally comprising a step of integrating the MFP into at least one of n panels, when in the closed configuration.

It is another object of the current invention to disclose a method as described above, additionally comprising a step of layering the MFP on at least one of n panels, when in the closed configuration.

It is another object of the current invention to disclose a method as described above, additionally comprising a step of maneuverably connecting the MFP to the incubator by a mechanism selected from a group consisting of: hinge mechanism, pivot point mechanism, sliding mechanism, telescopic mechanism, magnetic attachment mechanism and any combination thereof.

It is another object of the current invention to disclose a method as described above, additionally comprising a step of constructing the MFP deploying to a planar surface selected from a group consisting of horizontal, vertical, angled and any combination thereof.

It is another object of the current invention to disclose a method as described above, additionally comprising a step of constructing the MFP having at least two sections.

It is another object of the current invention to disclose a method as described above, additionally comprising a step of constructing at least a section of the MFP deploying to a planar surface selected from a group consisting of horizontal, vertical, angled and any combination thereof.

It is another object of the current invention to disclose a method as described above, additionally comprising a step of maneuverably connecting the MFP sections therebetween by a mechanism selected from a group consisting of: hinge mechanism, pivot point mechanism, sliding mechanism, telescopic mechanism, magnetic attachment mechanism and any combination thereof.

It is another object of the current invention to disclose a method as described above, additionally comprising a step of the constructing the MFP with side bars.

It is another object of the current invention to disclose a method as described above, additionally comprising a step of maneuverably connecting the side bars to the MFP.

It is another object of the current invention to disclose a method as described above, additionally comprising a step of connecting at least one support to the MFP, connecting the MFP to an element selected from a group consisting of: the incubator, an incubator's cart, the ground, a vertical wall, a transport vehicle, an imaging system, and any combination thereof.

It is another object of the current invention to disclose a method as described above, additionally comprising a step of forming a foldable support to the MFP.

It is another object of the current invention to disclose a method as described above, additionally comprising a step of forming at least a portion of the MFP having at least partially transparent material.

It is another object of the current invention to disclose a method as described above, additionally comprising a step of forming least one opening in the MFP.

It is another object of the current invention to disclose a method as described above, additionally comprising a step of connecting a closable door to the MFP opening.

It is another object of the current invention to disclose a method as described above, additionally comprising a step of sizing and shaping the MFP opening for the passage of life support equipment.

It is another object of the current invention to disclose a method as described above, additionally comprising a step of sizing and shaping the MFP opening for the passage of a handler's hand.

It is another object of the current invention to disclose a method as described above, additionally comprising a step of connecting the MFP opening to an element selected from a group consisting of: a container, a tube, ventilation equipment, life supporting element, viewing equipment, temperature regulating system, waste disposal, and any combination thereof.

It is another object of the current invention to disclose a method as described above, additionally comprising a step of connecting at least a portion of the MFP to life support equipment.

It is another object of the current invention to disclose a method as described above, additionally comprising a step of constructing the MFP having at least one life support element.

It is another object of the current invention to disclose a method as described above, additionally comprising a step of accommodating at least a portion of the life support element within the incubator.

It is another object of the current invention to disclose a method as described above, additionally comprising a step of constructing the MFP having a temperature regulating system.

It is another object of the current invention to disclose a method as described above, additionally comprising a step of configuring the system to regulating the temperature of a selected from a group consisting of: the MFP, the incubator, a neonate, the incubator's inner volume and any combination thereof.

It is another object of the current invention to disclose a method as described above, additionally comprising a step of forming at least a portion of the MFP of at least one sterilizable material.

It is another object of the current invention to disclose a method as described above, additionally comprising a step of reversibly connecting the incubator to a mobile cart.

It is another object of the current invention to disclose a method as described above, additionally comprising a step of reversibly connecting at least a portion of the MFP is to a mobile cart.

It is another object of the current invention to disclose a method as described above, additionally comprising a step of forming at least a portion of the incubator of MRI safe material.

It is another object of the current invention to disclose a method as described above, additionally comprising a step of constructing the incubator having an ergonomic placement for at least a portion of a neonate.

It is another object of the current invention to disclose a method as described above, additionally comprising a step of connecting means to secure a neonate within the incubator.

It is another object of the current invention to disclose a method as described above, additionally comprising a step of connecting means to securing a neonate on top the MFP.

It is another object of the current invention to disclose a method as described above, additionally comprising a step of constructing the MFP having at least one sensor selected from a group consisting of: temperature, humidity, respiratory rate, weight, pressure, vibration, gas concentration, movement, closed or opened configuration of the incubator and any combination thereof.

It is another object of the current invention to disclose a method as described above, additionally comprising a step of connecting the sensor to a component selected from a group consisting of: a CPU, an alarm system, a user interface, life support equipment, at least one indicator and any combination thereof.

It is another object of the current invention to disclose a method as described above, additionally comprising a step of connecting a latching mechanism to the incubator.

It is another object of the current invention to disclose a method as described above, additionally comprising a step of configuring the latching mechanism to secure the incubator in a closed or opened configuration.

It is another object of the current invention to disclose a method as described above, additionally comprising a step of connecting the incubator to an opening mechanism, closing mechanism or both.

It is another object of the current invention to disclose a method as described above, additionally comprising a step of constructing the opening mechanism alternating the incubator between the closed configuration to the open configuration.

It is another object of the current invention to disclose a method as described above, additionally comprising a step of constructing the opening mechanism as an emergency opening mechanism.

It is another object of the current invention to disclose a method as described above, additionally comprising a step of selecting the mechanism from a group consisting of: manual, automatic, and any combination thereof.

It is another object of the current invention to disclose a method as described above, additionally comprising a step of constructing the MFP having a lighting system.

It is another object of the current invention to disclose a method as described above, additionally comprising a step of constructing the lighting system having at least one mode of lighting for each configuration of the incubator.

It is another object of the current invention to disclose a method as described above, additionally comprising a step of configuring the lighting system to have at least one first lighting mode for within the incubator enclosed environment and at least one first lighting mode for the incubator from the outside.

It is another object of the current invention to disclose a method as described above, additionally comprising a step of maneuverably connecting the lighting system.

It is another object of the current invention to disclose a method as described above, additionally comprising a step of installing the lighting system with an operating system either manual, automatic or both.

It is another object of the current invention to disclose a method as described above, additionally comprising a step of installing the lighting system having at least two light spectrums, at least two intensities or both.

It is another object of the current invention to disclose a method as described above, additionally comprising a step of connecting the lighting system to one selected from a group consisting of: the incubator, the MFP, CPU, an alarm system, an interlock mechanism, a user interface, a power supply, and any combination thereof.

It is another object of the current invention to disclose a method as described above, additionally comprising a step of connecting an interlock mechanism connected to one selected from a group consisting of: the incubator, the MFP, a CPU, a user interface, an alarm system, an opening mechanism, a closing mechanism and any combination thereof.

It is another object of the current invention to disclose a method as described above, additionally comprising a step of setting the mechanism to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

It is another object of the current invention to disclose a method as described above, additionally comprising a step of constructing the MFP having at least one indicator selected from a group consisting of: visual indicator, auditable indicator, sensible indicator and any combination thereof.

It is another object of the current invention to disclose a method as described above, additionally comprising a step of constructing the MFP having a placement for an element selected from a group consisting of: life support equipment, medical tools, disposable waste, medical tubing, disposable mattress, cleaning and disinfecting equipment, and any combination thereof.

It is another object of the current invention to disclose a method as described above, additionally comprising a step of reversibly connecting the MFP to another apparatus selected from a group consisting of: operating table, stretcher, gurney, cart, bed, crib, imaging device, transport incubator, treatment table and any combination thereof.

It is another object of the current invention to disclose a method as described above, additionally comprising a step of constructing the MFP having an emergency release mechanism, configured to release a neonate from the incubator in one step.

It is another object of the current invention to disclose a method as described above, additionally comprising a step of connecting the MFP is to a power supply selected from a group consisting of: external power supply, internal power supply and any combination thereof.

It is another object of the current invention to disclose a method as described above, additionally comprising a step of constructing the incubator having a CPU configured to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose a method as described above, additionally comprising a step of connecting the CPU to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose a method as described above, additionally comprising a step of configuring a remote control mechanism to control a component selected from a group consisting of: opening mechanism, closing mechanism, CPU, lighting, temperature regulating system, life support equipment, ventilating system, alarm system, power supply, and any combination thereof.

It is another object of the current invention to disclose a method as described above, additionally comprising a step of constructing the incubator having a user interface.

It is another object of the current invention to disclose a method as described above, additionally comprising a step of integrating at least a portion of the user interface into at least one selected from a group consisting of: at least one of the n panels, the MFP and any combination thereof.

It is another object of the current invention to disclose a method as described above, additionally comprising a step of connecting the user interface to a component selected from a group consisting of: the MFP, life support equipment, at least one sensor, CPU, power supply, temperature regulating system, lighting system, at least one indicator, display, and any combination thereof.

It is another object of the current invention to disclose a method as described above, additionally comprising a step of constructing the incubator having an alarm system.

It is another object of the current invention to disclose a method as described above, additionally comprising a step of connecting the alarm system to a component selected from a group consisting of: the MFP, at least one sensor, at least one indicator, a user interface, a CPU, an interlock mechanism, life support equipment and any combination thereof.

It is another object of the current invention to disclose a method as described above, additionally comprising a step of connecting a handle to the MFP.

It is another object of the current invention to disclose a method as described above, additionally comprising a step of installing at least one opening and closing mechanism, the mechanism is connected to at least a portion of the MFP, and to at least a portion of one of the n incubator panels, further wherein the mechanism is configured to maneuver the MFP thereby providing the incubator with the at least one first open configuration and the at least one first closed configuration.

It is another object of the current invention to disclose a method as described above, additionally comprising a step of connecting at least one collapsible column, useful for supporting the MFP, the column comprising an elongated shape having at least two ends, having at least one first end of the column is maneuverably connected to the MFP, the column is configured to be NORMALLY DEPLOYED when the incubator is in an open configuration having at least one second end reversibly connected to a selected from a group consisting of a cart, a storage unit, a transport device, a wall, the floor, a medical treatment or imaging apparatus and any combination thereof.

It is another object of the current invention to disclose a method as described above, additionally comprising a step of connecting the column to a maneuverable mechanism, configured to close the MFP when column is collapsed.

It is another object of the current invention to disclose a method as described above, additionally comprising a step of configuring the column's maneuverable mechanism to collapse when the incubator is in a closed configuration.

It is another object of the current invention to disclose a method as described above, additionally comprising a step of configuring the column to be collapsible upon application of horizontal force in the axis of at least partial interception of the incubator within a selected from a group consisting of: an MRD, a medical treatment device, a transport device and any combination thereof.

It is another object of the current invention to disclose a method as described above, additionally comprising a step of connecting the column by a reversible connection, a maneuverable connection or both.

It is another object of the current invention to disclose a method as described above, additionally comprising a step of constructing the column with a foldable or retractable configuration.

It is another object of the current invention to disclose a method as described above, additionally comprising a step of constructing the column to a shape selected from a group consisting of: round, multifaceted, geometric, non-geometric, compound shape, and any combination thereof.

It is another object of the current invention to disclose a method as described above, additionally comprising a step of constructing the column is comprised of a plurality of interconnected pieces.

It is another object of the current invention to disclose a method as described above, additionally comprising a step of connecting at least one mechanism, to the incubator, interconnecting at least a portion of the MFP, configured to transform at least one first open configuration to at least one first closed configuration, at least one closed configuration to at least one open configuration, or both.

It is another object of the current invention to disclose a method as described above, additionally comprising a step of connecting the mechanism having horizontal movement means, thereby enabling closing or opening of a sliding mechanism.

It is another object of the current invention to disclose a method as described above, additionally comprising a step of connecting the mechanism having rotating movement means around a pivot point.

It is another object of the current invention to disclose a method as described above, additionally comprising a step of connecting the mechanism having a magnetic opening and closing means.

It is another object of the current invention to disclose a method as described above, additionally comprising a step of connecting a mechanism having an electromagnetic lock.

It is another object of the current invention to disclose a method as described above, additionally comprising a step of connecting a mechanism selected from a group consisting of: a concealed mechanism, a mechanism mounted on at least a portion of an external face of the incubator, a mechanism mounted on at least a portion of an internal face of the incubator, at least partially embedded within at least a portion of the MFP, at least partially embedded within at least a portion of the incubator, and any combination thereof.

It is another object of the current invention to disclose a method as described above, additionally comprising a step of configuring the mechanism to be a normally closed mechanism, thereby maintaining the incubator in a closed configuration when in a resting position.

It is another object of the current invention to disclose a method as described above, additionally comprising a step of configuring the mechanism to be a normally opened mechanism, thereby maintaining the incubator in an open configuration when in a resting position.

It is another object of the current invention to disclose a method as described above, additionally comprising a step of connecting a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof to the incubator.

It is another object of the current invention to disclose a method as described above, additionally comprising a step of connecting the MFP to the incubator by at least one living hinge.

It is another object of the current invention to disclose a method as described above, additionally comprising a step of constructing the mechanism to have at least one latch, configured to maintain the open configuration, the closed configuration, or both.

It is another object of the current invention to disclose a method as described above, additionally comprising a step of connecting a mechanism selected from a group consisting of: a push to open mechanism, a push to close mechanism, a self-closing mechanism, a soft closing mechanism, a soft opening mechanism, and any combination thereof.

It is another object of the current invention to disclose a method as described above, additionally comprising a step of connecting a plurality of MFPs, the incubator comprises a plurality of sliding mechanism for each the MFP; the mechanisms are interconnected so as to provide simultaneous movement, when the incubator transforms between the opened and closed configurations.

It is another object of the current invention to disclose a method as described above, additionally comprising a step of connecting a plurality of MFPs, configured so that maneuvering at least one first MFP, results in maneuvering of at least one second MFP.

It is another object of the current invention to disclose a method as described above, additionally comprising a step of constructing at least a portion of the incubator with flexible material.

It is another object of the current invention to disclose a method as described above, additionally comprising a step of connecting at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

It is another object of the current invention to disclose a method as described above, additionally comprising a step of connecting the incubator to a mobile cart containing at least a portion of the mechanism.

It is another object of the current invention to disclose a method as described above, additionally comprising a step of connecting a plurality of MFP's, to at least one opening mechanism, closing mechanism, or both, at least two of the maneuvering systems are interconnected to at least one bar; the bar is further interconnected to a main moveable shaft having a protrusion external to the incubator, and configuring the moveable shaft to maneuvering the connected MFP's thereby closing or opening the incubator.

It is another object of the current invention to disclose a method as described above, additionally comprising a step of configuring the mechanism to have a controlled soft closure mechanism.

It is another object of the current invention to disclose a method as described above, additionally comprising a step of selecting the mechanism from a group consisting of: manual, automatic, and any combination thereof.

It is another object of the current invention to disclose a method as described above, additionally comprising a step of connecting the mechanism to a power supply selected from a group consisting of: AC, DC and any combination thereof.

It is another object of the current invention to disclose a method as described above, additionally comprising a step of configuring a remote control to control the transition between open configuration and the closed configuration.

It is another object of the current invention to disclose a method as described above, additionally comprising a step of connecting an emergency opening mechanism to the incubator.

It is another object of the current invention to disclose a method as described above, additionally comprising a step of connecting an interlock to the opening mechanism.

The present invention provides a method for deploying an incubator's panel or a portion thereof into a countertop, comprising steps of: (a) obtaining an incubator comprising n panels, at least one of which or portion thereof is a multi functional panel (MFP), reversibly connecting to at least one of the n panels; n is an integer greater than 3; and (b) maneuvering at least one MFP or a portion thereof, wherein the step of maneuvering at least one MFP is deploying the incubator from at least one first CLOSED CONFIGURATION, sealingly enclosing internal environment of the incubator; and at least one first OPEN CONFIGURATION, in which the MFP is deployable as a countertop.

It is another object of the current invention to disclose a method as described above, additionally comprising a step of enclosing a neonate in an internal environment when the incubator is in closed configuration.

It is another object of the current invention to disclose a method as described above, additionally comprising a step of connecting the incubator to internal environmental control means.

It is another object of the current invention to disclose a method as described above, additionally comprising a step of regulating the internal environment conditions.

It is another object of the current invention to disclose a method as described above, additionally comprising a step of forming an open environment incubator the when deploying to the open configuration.

It is another object of the current invention to disclose a method as described above, additionally comprising a step of treating a neonate when accommodated in the incubator in a closed configuration.

It is another object of the current invention to disclose a method as described above, additionally comprising a step of treating a neonate when accommodated in an open configuration deployed incubator.

It is another object of the current invention to disclose a method as described above, additionally comprising a step of connecting life support equipment to the incubator.

It is another object of the current invention to disclose a method as described above, additionally comprising a step of at integrating at least a portion of the life support equipment into at least one selected from a group consisting of: one of the n panels, the MFP and any combination thereof.

It is another object of the current invention to disclose a method as described above, additionally comprising a step of integrating the MFP into at least one incubator panel, when in the closed configuration.

It is another object of the current invention to disclose a method as described above, additionally comprising a step of layering the MFP on at least one of n panels, when in the closed configuration.

It is another object of the current invention to disclose a method as described above, additionally comprising a step of maneuverably connecting the MFP to the incubator by a mechanism selected from a group consisting of: hinge mechanism, pivot point mechanism, sliding mechanism, telescopic mechanism, magnetic attachment mechanism and any combination thereof.

It is another object of the current invention to disclose a method as described above, additionally comprising a step of deploying the MFP to a planar surface selected from a group consisting of horizontal, vertical, angled and any combination thereof.

It is another object of the current invention to disclose a method as described above, additionally comprising a step of selecting the MFP having at least two sections.

It is another object of the current invention to disclose a method as described above, additionally comprising a step of deploying at least a section of the MFP to a planar surface selected from a group consisting of horizontal, vertical, angled and any combination thereof.

It is another object of the current invention to disclose a method as described above, additionally comprising a step of maneuverably connecting the MFP sections are therebetween by a mechanism selected from a group consisting of: hinge mechanism, pivot point mechanism, sliding mechanism, telescopic mechanism, magnetic attachment mechanism and any combination thereof.

It is another object of the current invention to disclose a method as described above, additionally comprising a step of maneuvering the MFP section thereby deploying the incubator.

It is another object of the current invention to disclose a method as described above, additionally comprising a step of maneuverably connecting side bars to the MFP.

It is another object of the current invention to disclose a method as described above, additionally comprising a step of maneuvering the side bars.

It is another object of the current invention to disclose a method as described above, additionally comprising a step of connecting at least one support to the MFP connecting the MFP to an element selected from a group consisting of: the incubator, an incubator's cart, the ground, a vertical wall, a transport vehicle, an imaging system, and any combination thereof, thereby supporting the MFP.

It is another object of the current invention to disclose a method as described above, additionally comprising a step of selecting the MFP having at least a portion of at least partially transparent material.

It is another object of the current invention to disclose a method as described above, additionally comprising a step of viewing a neonate.

It is another object of the current invention to disclose a method as described above, additionally comprising a step of selecting the MFP having an opening.

It is another object of the current invention to disclose a method as described above, additionally comprising a step of connecting a closable door to the MFP opening.

It is another object of the current invention to disclose a method as described above, additionally comprising a step of closing or opening the MFP door.

It is another object of the current invention to disclose a method as described above, additionally comprising a step of selecting the MFP having an opening sized and shaped for the passage of a selected from a group consisting of: life support equipment, a handlers hand, medical equipment tubing and any combination thereof.

It is another object of the current invention to disclose a method as described above, additionally comprising a step of passing through the MFP opening a selected from a group consisting of: life support equipment, a handler's hand, medical equipment tubing and any combination thereof.

It is another object of the current invention to disclose a method as described above, additionally comprising a step of connecting the MFP opening is to an element selected from a group consisting of: a container, a tube, ventilation equipment, life supporting element, viewing equipment, temperature regulating system, waste disposal, and any combination thereof.

It is another object of the current invention to disclose a method as described above, additionally comprising a step of connecting at least a portion of the MFP to life support equipment.

It is another object of the current invention to disclose a method as described above, additionally comprising a step of selecting the MFP having at least one life support element.

It is another object of the current invention to disclose a method as described above, additionally comprising a step of accommodating at least a portion of the life support element within the incubator.

It is another object of the current invention to disclose a method as described above, additionally comprising a step of regulating the temperature of a selected from a group consisting of: the MFP, the incubator, a neonate, the incubator's inner volume and any combination thereof.

It is another object of the current invention to disclose a method as described above, additionally comprising a step of sterilizing at least a portion of the incubator.

It is another object of the current invention to disclose a method as described above, additionally comprising a step of sterilizing at least a portion of the MFP.

It is another object of the current invention to disclose a method as described above, additionally comprising a step of reversibly connecting the incubator to a mobile cart.

It is another object of the current invention to disclose a method as described above, additionally comprising a step of reversibly connecting at least a portion of the MFP is to a mobile cart.

It is another object of the current invention to disclose a method as described above, additionally comprising a step of forming at least a portion of the incubator of MRI safe material.

It is another object of the current invention to disclose a method as described above, additionally comprising a step of imaging a neonate when accommodated within the incubator.

It is another object of the current invention to disclose a method as described above, additionally comprising a step of accommodating at least a portion of a neonate in an ergonomic placement connected to the incubator.

It is another object of the current invention to disclose a method as described above, additionally comprising a step of securing at least a portion of a neonate with securing means connected within the incubator.

It is another object of the current invention to disclose a method as described above, additionally comprising a step of securing at least a portion of a neonate with securing means connected on top of the MFP.

It is another object of the current invention to disclose a method as described above, additionally comprising a step of constructing the MFP having at least one sensor selected from a group consisting of: temperature, humidity, respiratory rate, weight, pressure, vibration, gas concentration, movement, closed or opened configuration of the incubator and any combination thereof.

It is another object of the current invention to disclose a method as described above, additionally comprising a step of connecting the sensor to a component selected from a group consisting of: a CPU, an alarm system, a user interface, life support equipment, at least one indicator and any combination thereof.

It is another object of the current invention to disclose a method as described above, additionally comprising a step of opening or closing a latching mechanism connected to the incubator.

It is another object of the current invention to disclose a method as described above, additionally comprising a step of securing the latching mechanism thereby maintaining the incubator in a closed or opened configuration.

It is another object of the current invention to disclose a method as described above, additionally comprising a step of connecting the incubator to an opening mechanism, closing mechanism or both.

It is another object of the current invention to disclose a method as described above, additionally comprising a step of alternating the opening mechanism between the closed configuration to the open configuration.

It is another object of the current invention to disclose a method as described above, additionally comprising a step of connecting an emergency opening mechanism thereby enabling immediate opening the incubator.

It is another object of the current invention to disclose a method as described above, additionally comprising a step of selecting operating the opening mechanism manually, automatically, or both.

It is another object of the current invention to disclose a method as described above, additionally comprising a step of installing a lighting system.

It is another object of the current invention to disclose a method as described above, additionally comprising a step of choosing at least one lighting mode for each configuration of the incubator.

It is another object of the current invention to disclose a method as described above, additionally comprising a step of configuring the lighting system to have to have at least one first lighting mode for within the incubator enclosed environment and at least one first lighting mode for the incubator from the outside.

It is another object of the current invention to disclose a method as described above, additionally comprising a step of maneuverably connecting the lighting system.

It is another object of the current invention to disclose a method as described above, additionally comprising a step of controlling the lighting system manually, automatically or both.

It is another object of the current invention to disclose a method as described above, additionally comprising a step of configuring the lighting system having lighting in at least two light spectrums, at least two intensities or both.

It is another object of the current invention to disclose a method as described above, additionally comprising a step of connecting the lighting system to one selected from a group consisting of: the incubator, the MFP, CPU, an alarm system, an interlock mechanism, a user interface, a power supply, and any combination thereof.

It is another object of the current invention to disclose a method as described above, additionally comprising a step of connecting an interlock mechanism connected to one selected from a group consisting of: the incubator, the MFP, a CPU, a user interface, an alarm system, an opening mechanism, a closing mechanism and any combination thereof.

It is another object of the current invention to disclose a method as described above, additionally comprising a step of setting the mechanism to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

It is another object of the current invention to disclose a method as described above, additionally comprising a step of connecting at least one indicator to the MFP selected from a group consisting of: visual indicator, auditable indicator, sensible indicator and any combination thereof.

It is another object of the current invention to disclose a method as described above, additionally comprising a step of connecting a placement to the MFP for an element selected from a group consisting of: life support equipment, medical tools, disposable waste, medical tubing, disposable mattress, cleaning and disinfecting equipment, and any combination thereof.

It is another object of the current invention to disclose a method as described above, additionally comprising a step of reversibly connecting the MFP to another apparatus selected from a group consisting of: operating table, stretcher, gurney, cart, bed, crib, imaging device, transport incubator, treatment table and any combination thereof.

It is another object of the current invention to disclose a method as described above, additionally comprising a step of connecting an emergency release mechanism to the MFP having, configured to release a neonate from the incubator in one step.

It is another object of the current invention to disclose a method as described above, additionally comprising a step of one step releasing a neonate from the incubator.

It is another object of the current invention to disclose a method as described above, additionally comprising a step of connecting the MFP is to a power supply selected from a group consisting of: external power supply, internal power supply and any combination thereof.

It is another object of the current invention to disclose a method as described above, additionally comprising a step of connecting a CPU to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose a method as described above, additionally comprising a step of configuring the CPU to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

It is another object of the current invention to disclose a method as described above, additionally comprising a step of configuring a remote control mechanism to control a component selected from a group consisting of: opening mechanism, closing mechanism, CPU, lighting, temperature regulating system, life support equipment, ventilating system, alarm system, power supply, and any combination thereof.

It is another object of the current invention to disclose a method as described above, additionally comprising a step of connecting a user interface.

It is another object of the current invention to disclose a method as described above, additionally comprising a step of integrating at least a portion of the user interface into at least one selected from a group consisting of: at least one of the n panels, the MFP and any combination thereof.

It is another object of the current invention to disclose a method as described above, additionally comprising a step of connecting the user interface to a component selected from a group consisting of: the MFP, life support equipment, at least one sensor, CPU, power supply, temperature regulating system, lighting system, at least one indicator, display, and any combination thereof.

It is another object of the current invention to disclose a method as described above, additionally comprising a step of maneuvering the MFP through the user interface.

It is another object of the current invention to disclose a method as described above, additionally comprising a step of connecting an alarm system to a component selected from a group consisting of: the MFP, at least one sensor, at least one indicator, a user interface, a CPU, an interlock mechanism, life support equipment and any combination thereof.

It is another object of the current invention to disclose a method as described above, additionally comprising a step of maneuvering at least one of n panels or a portion thereof, to deploy to the open configuration.

It is another object of the current invention to disclose a method as described above, additionally comprising a step of connecting a handle to the MFP.

It is another object of the current invention to disclose a method as described above, additionally comprising a step of using a handle to deploy the MFP.

It is another object of the current invention to disclose a method as described above, additionally comprising a step of opening and/or closing an opening and closing mechanism, the mechanism is connected to at least a portion of the MFP, and to at least a portion of one of the n incubator panels, further wherein the mechanism is configured to maneuver the MFP thereby providing the incubator with the at least one first open configuration and the at least one first closed configuration.

It is another object of the current invention to disclose a method as described above, additionally comprising a step of selecting an incubator having at least one collapsible column, useful for supporting the MFP, the column comprising an elongated shape having at least two ends, having at least one first end of the column is maneuverably connected to the MFP, the column is configured to be NORMALLY DEPLOYED when the incubator is in an open configuration having at least one second end reversibly connected to a selected from a group consisting of a cart, a storage unit, a transport device, a wall, the floor, a medical treatment or imaging apparatus and any combination thereof.

It is another object of the current invention to disclose a method as described above, additionally comprising a step of closing the MFP by collapsing the column.

It is another object of the current invention to disclose a method as described above, additionally comprising a step of collapsing the column when closing the MFP.

It is another object of the current invention to disclose a method as described above, additionally comprising a step of collapsing the column upon application of horizontal force in the axis of at least partial interception of the incubator within a selected from a group consisting of: an MRD, a medical treatment device, a transport device and any combination thereof.

It is another object of the current invention to disclose a method as described above, additionally comprising a step of selecting the column connected to the incubator by a reversible connection, a maneuverable connection or both.

It is another object of the current invention to disclose a method as described above, additionally comprising a step of folding or retracting the column.

It is another object of the current invention to disclose a method as described above, additionally comprising a step of unfolding or advancing the column.

It is another object of the current invention to disclose a method as described above, additionally comprising a step of selecting the column of a shape selected from a group consisting of: round, multifaceted, geometric, non-geometric, compound shape, and any combination thereof.

It is another object of the current invention to disclose a method as described above, additionally comprising a step of selecting the column comprised of a plurality of interconnected pieces.

It is another object of the current invention to disclose a method as described above, additionally comprising a step of selecting the incubator having at least one mechanism, interconnecting at least a portion of the MFP to the incubator, configured to transform at least one first open configuration to at least one first closed configuration, at least one closed configuration to at least one open configuration, or both.

It is another object of the current invention to disclose a method as described above, additionally comprising a step of moving the mechanism horizontally, thereby enabling closing or opening of a sliding mechanism.

It is another object of the current invention to disclose a method as described above, additionally comprising a step of rotating or tilting the mechanism around a pivot point.

It is another object of the current invention to disclose a method as described above, additionally comprising a step of utilizing magnetism to open or close the incubator.

It is another object of the current invention to disclose a method as described above, additionally comprising a step of closing or opening the incubator by utilizing an electromagnetic lock.

It is another object of the current invention to disclose a method as described above, additionally comprising a step of selecting an incubator having a mechanism selected from a group consisting of: a concealed mechanism, a mechanism mounted on at least a portion of an external face of the incubator, a mechanism mounted on at least a portion of an internal face of the incubator, at least partially embedded within at least a portion of the MFP, at least partially embedded within at least a portion of the incubator, and any combination thereof.

It is another object of the current invention to disclose a method as described above, additionally comprising a step of selecting the incubator having a normally closed mechanism, thereby maintaining the incubator in a closed configuration when in a resting position.

It is another object of the current invention to disclose a method as described above, additionally comprising a step of selecting the incubator having a normally opened mechanism, thereby maintaining the incubator in an open configuration when in a resting position.

It is another object of the current invention to disclose a method as described above, additionally comprising a step of operating a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof connected to the incubator, thereby deploying or closing the MFP.

It is another object of the current invention to disclose a method as described above, additionally comprising a step of maintaining the open configuration, closed configuration or both by utilizing at least one latch.

It is another object of the current invention to disclose a method as described above, additionally comprising a step of operating the mechanism by a selected from a group consisting of: pushing to open, pushing to close, a self-closing, a soft closing, a soft opening, and any combination thereof.

It is another object of the current invention to disclose a method as described above, additionally comprising a step of simultaneously closing a plurality of MFPs by operating a plurality of opening mechanism, closing mechanism or both for each the MFP interconnected therebetween.

It is another object of the current invention to disclose a method as described above, additionally comprising a step of simultaneously closing a plurality of MFPs by maneuvering at least one first MFP, interconnected to at least one second MFP or at least one second opening, closing, or both mechanism.

It is another object of the current invention to disclose a method as described above, additionally comprising a step of moving at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

It is another object of the current invention to disclose a method as described above, additionally comprising a step of selecting the incubator connected to a mobile cart containing at least a portion of the opening, closing or both mechanism.

It is another object of the current invention to disclose a method as described above, additionally comprising a step of maneuvering a moveable shaft, having a protrusion external to the incubator, interconnected to a side bar further connected to a maneuvering mechanism connected to a plurality of MFP's, thereby closing or opening the incubator.

It is another object of the current invention to disclose a method as described above, additionally comprising a step of selecting the incubator having a controlled soft close, soft open mechanism or both.

It is another object of the current invention to disclose a method as described above, additionally comprising a step of selecting the incubator having the opening mechanism, closing mechanism or both selected from a group consisting of: manual, automatic, and any combination thereof.

It is another object of the current invention to disclose a method as described above, additionally comprising a step of connecting the mechanism to a power supply selected from a group consisting of: AC, DC and any combination thereof.

It is another object of the current invention to disclose a method as described above, additionally comprising a step of remote controlling the transition between open configuration and the closed configuration.

It is another object of the current invention to disclose a method as described above, additionally comprising a step of emergency opening the incubator by utilizing an emergency opening mechanism.

It is another object of the current invention to disclose a method as described above, additionally comprising a step of operating an interlock connected to the opening mechanism.

### BRIEF DESCRIPTION OF THE DRAWINGS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured. In the accompanying drawing:

FIGS. 1A and 1B are schematic illustrations of an embodiment of a deployable MFP in an incubator, providing closed and opened configurations;

FIGS. 2A and 2B are schematic illustrations of an embodiment of a deployable MFP in an incubator, where the MFP comprises two sections and is integrated into two incubators faces when is closed configuration;

FIGS. 3A and 3B are schematic illustrations of an embodiment of a deployable MFP in an incubator, accommodated upon a mobile cart, in closed and opened configurations;

FIG. 3C is a schematic illustration of an embodiment of a deployable MFP in an incubator showing the deployable MFP in closed configuration accommodated upon a mobile cart, having mechanical-means for conveying the incubator into and out of the imaging-device;

FIG. 4 is a schematic illustration of a cylindered embodiment of a deployable MFP in an incubator;

FIG. 5 is a schematic illustration of a rectangular embodiment of a deployable hingedly connected MFP in an incubator;

FIG. 6 is a schematic illustration of a rectangular embodiment of a deployable MFP in connected via a pivot point to an incubator;

FIG. 7 is a schematic illustration of a rectangular embodiment of a deployable slide able MFP in an incubator;

FIG. 8 is a schematic illustration of a rectangular embodiment of multiple deployable MFPs in an incubator;

FIGS. 9A and 9B are a schematic illustration of a rectangular embodiment of an MFP deployable as a drawer in an incubator;

FIG. 10 is a schematic illustration of an embodiment of multiple MFPs in an incubator, comprising a foldable support;

FIG. 11 is a schematic illustration of an embodiment of multiple MFPs in an incubator, integrated with a heating system;

FIG. 12 is a schematic illustration of an embodiment of multiple MFPs in an incubator, comprising a side panel support;

FIG. 13 is a schematic illustration of an embodiment of multiple MFPs in an incubator, comprising an ergonomic placement for a neonate;

FIG. 14 is a schematic illustration of a part of a deployed incubator having a collapsible column;

FIG. 15 is a schematic illustration of an embodiment of a part of column having a telescopic mechanism;

FIG. 16 is a schematic illustration of an embodiment of a deployable incubator having an embedded collapsible column;

FIG. 17 is a schematic illustration of an embodiment of a deployable incubator having a maneuverable internal mechanism for opening or closing the MFP;

FIG. 18 is a schematic illustration of an embodiment of a part of a deployable incubator having a maneuverable hinge mechanism for opening or closing the MFP;

FIG. 19 is a schematic illustration of an embodiment of a deployable incubator having an external opening mechanism;

FIG. 20 is a schematic illustration of an embodiment of a deployable incubator having a belt closing and opening mechanism;

FIG. 21 is a schematic illustration of an embodiment of a magnetic resonance system showing multiple MFPs in a deployable incubator closable when inserted to an MRD; and

FIG. 22 is a schematic illustration of an embodiment of a magnetic resonance system showing a deployable MFP in an incubator closable when inserted to an MRD having a designated sliding mechanism.

### DETAILED DESCRIPTION OF THE SPECIFIC EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The essence of the present invention is to provide a deployable incubator, comprising multiple panels, at least one of which or portion thereof is a multi-functional panel (MFP), reversibly connected to at least one of the panels; the incubator is characterized by at least one first CLOSED CONFIGURATION, sealingly enclosing an internal environment of the incubator; and at least one first OPEN CONFIGURATION, in which the MFP is deployable as a countertop.

Further this invention provides a multi-functional panel (MFP), reversibly connectable to an incubator or a panel thereof, providing the incubator with a closed configuration in which the incubator and MFP sealingly enclose an internal environment and deploys into an open configuration with a countertop.

The term “incubator” interchangeably refers hereinafter to a special unit specializing in the care of ill or premature newborn infants. This includes a stationary incubator, a moveable incubator, a transport incubator, a disposable incubator, a healthcare facility incubator, portable incubator, an intensive care incubator, an incubator intended for home use, an incubator for imaging a neonate, a treatment incubator, a modular incubator, an isolating incubator and any combination thereof. The neonatal incubator is a box-like enclosure in which an infant can be kept in a controlled environment for observation and care. The incubator usually includes observation means to the accommodated neonate, and openings for the passage of life support equipment, and the handler's hands.

The term “closed environment incubator” interchangeably refers hereinafter to an enclosed environment for the neonate. The closed environment is at least partially isolated from the external environment conditions such as noise, vibration, drift, temperature, light, gas concentrations, humidity, microorganisms, etc. The closed environment can be controlled by environment control systems such as temperature regulating, ventilating, humidifying, lighting, moving, noise reduction systems, vibration reducing systems, etc. The closed environment enclosure prevents passage of micro-organisms.

The term “opened configuration”, in reference to the deployable neonate incubator (INCUBATOR), interchangeably refers hereinafter to a deployed state of the incubator in which the neonate is exposed at least in part to the conditions of the external environment.

The term “panel” interchangeably refers hereinafter to a wall, wainscot, ceiling, door, shutter, fence, face, façade, screen, enclosure, surface, barricade, barrier, rampart, retainer, side, fortification, seal, block, partition, blockade, dam, curtain, trench, board, etc., or a distinct portion, section, or division thereof, etc.

The term “hinge” interchangeably refers hereinafter to any maneuverable connection for rotational motion between the current invention parts, portions and modules, such as a flexible mechanism or material, joint, hook, thread, axis, juncture, fold, bend, elbow, knee, corner, fork, axis, pole, ball and socket, condyloid joint, mechanical device, fold hinge, joint, bearing, barrel hinge, pivot hinges, butt/mortise hinges, case hinges, continuous hinges, piano hinges, concealed hinges, cup hinge, euro hinge, butterfly hinges, parliament hinges, dovetail hinges, flag hinges, flag hinge, strap hinges, H hinges, HL hinges, counter-flap hinge, flush hinge, coach hinge, rising butt hinge, double action spring hinge, tee hinge, friction hinge, security hinge, cranked hinge, lift-off hinge, self-closing hinge, butt hinge, butler tray hinge, card table hinge, drop leaf table hinge, floating hinge, living hinge, and any combination thereof.

The term “pivot pin” interchangeably refers hereinafter to any maneuverable connection for rotational motion between the current invention parts, portions and modules at least partially around a pivot point.

The term “track”, interchangeably refers hereinafter to such as a track, guide, path, groove, rail, line, route, duct, channel, passage, course, trail, lineament, lane, road, seam, length, axis, tract, pathway, course, highway, roadway, alley, artery, avenue, boulevard, clearing, cut, drag, thoroughfare, trajectory, walk, track way, belt, swath, glider, circuit, stretch, runway, caterpillar track, half-track, flat track, soft close track, pivoted sliding track, adjustable track, etc. Further this track maybe a physical or a virtual motion path along which a maneuverable portion is moved.

The term “sliding mechanism”, interchangeably refers hereinafter to a mechanism in with a body is movable in a sliding motion along a track. A portion of the movable body is mounted on, suspended from, inserted to, threaded to, interweaved with, integrated to, fitted to, following, etc. a track. In reference to a physical track, the connection of the moveable portion to the track is directly by geometrical shape fit of on part with the other and/or via a third element such as wheels, rack wheels, ball bearings, rollers, rolling discs, lubricant, location guide, belts, pulleys etc. In reference to a virtual motion track, the movable portion is connected to a sliding motion providing mechanism such as telescopic arms, folding arms, arms, angled arms, etc. connected at a pivotal point, allowing for sliding movement along a predefined virtual path. In addition this sliding mechanism may enable straight sliding, curved sliding, folding slide, sliding around a corner, rolling door sliding, etc.

The term “neonate” or “patient” interchangeably refers herein after to a term selected from a group of: patient, neonate, baby, infant, toddler, child, adolescent, adult, elderly, etc.; further this term refers to person or animal.

The term “handler” interchangeably refers herein after to any person that is in contact with the incubator such as medical personal, maintenance personal, parent, chaperon and technician.

The term “bar” interchangeably refers hereinafter to a peace of matter acting as a blockade that may be a panel, rod, bar, plank, wire, etc., attached to at least a portion of the incubator or MFP.

The bar can prevent fall of the neonate or equipment from the incubator or MFP, assist the handler being a hand grip, function as a stand for the placement of external objects, and any combination thereof.

The term “opening mechanism” or “closing mechanism” interchangeably refers hereinafter to a device designed to transform input forces and movement into opening or closing the incubator. This device may be automatic or manual.

The term “automatic” in respect to the movement of a part, a portion and/or a module of the incubator or MFP interchangeably refers herein after to a pre-defined movement having a start location and an end location. Further this movement could be derived from an engine, a self-sliding movement when a latching mechanism is released, pneumatic mechanism (compressed from the self-sliding movement), hydraulic cylinder, using a gear shift system, etc.

The term “manual” in respect to the movement of a part, a portion and/or a module of the incubator or MFP interchangeably refers herein after to any application of force by the handler aimed at maneuvering at least a portion of the incubator or MFP. This force is generated by an action such as pushing, pulling, lifting, levering, turning, twisting, hitting, lowering, etc.

The term “countertop” interchangeably refers hereinafter to at least a partially planar surface, stable and useful as a functional object selected from a group consisting of: a treatment bed, a treatment table, an extra surface, a hand rest for the handler, a medical tray, a shelf, housing for life support equipment, medical equipment tubing, housing for systems (such as power supply, temperature regulating system, ventilating system), housing for user interface (including a display, indicators, control buttons for connected systems or monitors), at least partially perpendicular surface, a hanging device. This surface can be kept in the same sterile and temperature conditions as the incubator.

The term “emergency release mechanism”, interchangeably refers hereinafter to a mechanism used in immediate need of extracting a neonate from the incubator that allows in one step the dislocation of at least a portion of the incubator providing access to the neonate.

The term “visual indicators” interchangeably refers hereinafter to a representation of light in the visible light range of about 380 nanometers to about 740 nm. More generally the terms refer to any light within the visible range that will be noticeable by the user of the invention (light, flashing light, flickering light, blinking light, change of spectrum of colors of light etc.).

The term “audible indicators” interchangeably refers hereinafter to a representation of sound, typically as an electrical voltage. Audible indicators have frequencies in the audio frequency range of roughly 20 to 20,000 Hz (the limits of human hearing). Audible indicators are either synthesized directly, or originate at a transducer such as a microphone, musical instrument pickup, phonograph cartridge, or tape head.

The term “sensible indicators” interchangeably refers hereinafter to a physical movement of at least a portion of the user interface, which is noticeable to the user (shaking, vibrating, quivering, etc.).

The term “ergonomic” interchangeably refers hereinafter to the design of the incubator to minimize discomfort of the neonate, handler or both. The incubator is designed in a manner that fits the neonate's body and its cognitive needs and abilities. More specifically this term relates to the placement within the inner volume of the incubator to be fitting by means of size, shape, surface properties, sound transmission, light transmission, etc., to be appropriate for maximizing the well-being of the neonate. This term further relates to the human interface of the incubator designed for the handler, parts such as the user interface, open and close mechanisms, overall size and shape, handles, accessibility to the neonate, connections to other equipment, etc., are all designed in a manner that takes into consideration human factors.

The term “life supporting equipment” interchangeably refers hereinafter to any element that provides an environmental condition, a medical condition or monitoring of an environmental or medical condition thereof that assists in sustaining the life of a neonate or bettering their physical and physiological wellbeing. This element can be: (a) any medical equipment: all devices, tubes, connectors, wires, liquid carriers, needles, sensors, monitors, etc., that are used by medical personal in association with the patient. This equipment is such as bilirubin light, an IV (intravenous) pump, oxygen supplementation systems by head hood or nasal cannula, continuous positive airway pressure system, a feeding tube, an umbilical artery catheter, a fluid transport device, hemofiltration system, hemodialysis system, MRI contras solution injection, imaging the neonate etc.; (b) medical measurement and observation systems (including sensors and/or monitors) of temperature, respiration, cardiac function, oxygenation, brain activity such as ECG (electrocardiography) monitor, blood pressure monitor, cardio-respiratory monitor, pulse oximeter; and (c) environmental control systems such as ventilator, air conditioner, humidifier, temperature regulator, climate control systems, noise muffling device, vibration muffling device, etc. and any combination thereof.

The term “medical equipment tubing” interchangeably refers hereinafter to all tubes, cables, connectors, wires, liquid carriers, gas carriers, electrical wires, monitoring cables, viewing cables, data cables, etc., that is used in connection to life support equipment, medical equipment or physical environment maintenance or monitoring.

The term “placement” interchangeably refers hereinafter to a predefined location for placing one or more Item. This is achieved by a mean such as a clip, anchor, catch, clasp, strip, nest, socket, tray, dent, duct, channel, bridge, clamp, harness, concave shape, crater, gap, pocket, cavity, grip, belt, catch, snap, fastener, hook, hold, support, buckle, latch, lock, hasp, affixer, binder, joiner, band, ring, string, tie, link, chain, fastener, draw latch, lock, bolt, grip, bar, bond, clasp, connection, fixture, buckle, pin, peg, grapnel, band, pin, insertion, label designation etc.

The term “interlock mechanism” interchangeably refers hereinafter to a mechanism used to help prevent incubator from harming the handler, neonate, medical equipment or damaging itself by stopping the movement of the incubator parts portions or modules or the MFP parts portions or modules when a body is detected in the movement range.

The term “magnetic resonance device” (MRD), specifically applies hereinafter to any Magnetic Resonance Imaging (MRI) device, any Nuclear Magnetic Resonance (NMR) spectroscope, any Electron Spoint Resonance (ESR) spectroscope, any Nuclear Quadruple Resonance (NQR) or any combination thereof. The term, in this invention, also applies to any other analyzing and imaging instruments comprising a volume of interest, such as computerized tomography (CT), ultrasound (US) etc. The MRD hereby disclosed is optionally a portable MRI device, such as the ASPECT-MR Ltd commercially available devices, or a commercially available non-portable device.

The term “user interface” interchangeably refers hereinafter to at least one defined area in which the user interacts with the incubator or MFP. This area harbors elements such as: passage for medical equipment, display, CPU, alarm system, monitoring system, power supply, open mechanism, close mechanism, visual indicators, auditory indicators, sensible indicators, handles, etc. The user interface is designed for the handler, neonate or both.

The term “latching mechanism” interchangeably refers hereinafter to a mechanism such as: fastener, draw latch, latch, lock, belt, bolt, grip, bar, bond, clamp, clasp, connection, fixture, link, hook, hasp, buckle, brake, harness, clip, snap, pin, peg, grapnel, lock, brake mechanism, point insertion, etc., that is able to lock the configuration of a maneuverable part in respect to another part.

The term “environmental control means” interchangeably refers hereinafter to means to manage and regulate the physical conditions of a predefined area. The physical conditions are such as temperature, radiation, sound, light, ventilation, gas concentration, humidity, movement, texture and softness of materials, etc. These means are either passive (such as isolating materials, refractive materials, filtering materials, etc.), active (such as temperature regulating system, ventilation system, lighting system, sound muffling, sound transmitting, vibration shock absorbers, humidifying, moving, tilting, rocking).

The term “temperature regulating system” interchangeably refers hereinafter to a system that controls the temperature either by heating or by cooling or both. More specifically the term relates to an air conditioned system, an infrared heater, a water/oil-heated radiator, a coiled heater, an open coil air heater, a round open coil air heater, a convection heater, straight or formed tubular heaters, a quartz tube air heater, a capacitor-type heater, a Pelletier module, a refrigerator, vent, etc.

The term “lighting system” interchangeably refers hereinafter to a system that provides lighting to the MBP, to the incubator, to the handler, and any combination thereof. The lighting system can provide a different light spectrum in different locations for example the inner volume of the incubator and the outer environment. Further, this lighting system can be maneuvered manually or automatically to act as spot lights to a specific direction. This system can be configured to have at least two modes, relating to the opened or closed configurations of the incubator. The lighting can be variable in its lighting spectrum wave length (300-1100 nm), the infrared wave length (700 nm-1 mm), the UV wave length (400 nm and 10 nm), and luminous intensity (lm/sr).

The term “power supply” interchangeably refers hereinafter to a source of power such as electrical power generated from internally supplied DC, externally supplied AC or DC, or both.

The term “transparent material” interchangeably refers hereinafter to materials that enable at least a partial see though, such as, poly-methyl methacrylate, thermoplastic polyurethane, polyethylene, polyethylene terephthalate, isophthalic acid modified polyethylene terephthalate, glycol modified polyethylene terephthalate, polypropylene, polystyrene, acrylic, polyacetate, cellulose acetate, polycarbonate, nylon, glass, polyvinyl chloride, etc. Further in some embodiments at least a portion of this material is imbedded with non-transparent materials for means of strength and/or conductivity such as metallic wires.

The term “connected” in reference to the INCUBATOR, MFP, parts and connecting elements or components thereof, interchangeably refers hereinafter to any contact, relation, association, integration, interconnection, joining, inserting, sewing, welding, interweaving, placing, nesting, layering, placing akin, linkage, unity, alliance, bracketed, combination, coupling, banding, bonding, affiliation, fitting, pairing, attachment, hooking, hinging, welding, adhering, fusion, fixing, tying, sewing, embedding, weaving, etc., of incubator, MFP, parts and connecting elements or components thereof, to each other and to a third party.

The term “CPU”, central processing unit, interchangeably refers hereinafter to the hardware within a computer that carries out the instructions of a computer program by performing the basic arithmetical, logical, and input/output operations of the system.

The term “sensor” interchangeably refers hereinafter to any device that receives a signal or stimulus (heat, pressure, light, motion, sound, humidity etc.) and responds to it in a distinctive manner.

The term “modular” interchangeably refers hereinafter to an incubator or panel thereof, which is subdivided into smaller parts (modules) that can be independently created and then used in different embodiments and configurations to drive multiple functionalities.

The term “open environment incubator” interchangeably refers hereinafter to an incubator that comprises at least a partially open shape, thereby creating direct contact between the internal environment of the incubator and the outside world. This formation of an incubator can, in an embodiment, still maintains the function of life support equipment and/or environment control equipment.

The term “belt” interchangeably refers hereinafter to a band of material flexible or not, for at least partially encircling at least a portion of the incubator such as a band, strip, stripe, supporting band, ribbon, ring, strap, string, cincture, cummerbund, girdle, sash, waistband, bandage, bandeau, belt, binding, bond, braid, cable, chain, circle, circuit, copula, cord, fillet, harness, hoop, ligature, line, link, manacle, ribbon, ring, rope, sash, scarf, shackle, snood, stay, strap, string, strip, tape, tie, truss, frame, scaffold, enclosure, cage, framework, etc.

The terms “normally closed”, mechanism in reference to the incubator parts, modules, support, panels, portions, etc., interchangeably refers hereinafter to a state or position of an element connected by a maneuverable connection (in for example a hinge with a spring loaded system). A normally closed state is configured so that the closed position maintains the maneuverable mechanism in a relaxed or resting position. The position of the element will only change following application of force (for example mechanical force), and will always aim to return to its relaxed closed position when the application of force is removed.

The term “normally opened” mechanism in reference to the incubator parts, modules, support, panels, portions, etc., interchangeably refers hereinafter to a state or position of an element connected by a maneuverable connection (in for example a hinge with a spring loaded system). A normally opened state is configured so that the opened position maintains the maneuverable mechanism in a relaxed or resting position. The position of the element will only change following application of force (for example mechanical force), and will always aim to return to its relaxed opened position when the application of force is removed.

The term an “electrical motor powered system” interchangeably refers hereinafter to an automated electrically powered mechanism can engage an automated system for opening and/or closing, or a combination of an automated system with a return spring, or an automated closing and a return on a spring. An opening and/or closing system can contain a default manual operation status when not connected to an electrical source. This mechanism converts electrical power into a mechanical movement. This can be such as an electromechanical mechanism where the motor uses purely mechanical means to open the door: gears, cams, levers and such; electro-hydraulic mechanism where the motor drives a hydraulic pump, which pressurizes the oil in a door closer, which in turn turns the door closer and opens the door; Electro-pneumatic mechanism where the motor drives an air compressor and may be located away from the door. The air pressure is used to drive the operator above the door.

The term “electromagnetic lock” interchangeably refers hereinafter to a mechanism useful for looking the connection between to objects such as panels, a door and a wall, a door and a door frame, etc. An electromagnetic lock, is a locking device that consists of an electromagnet and an armature plate. Typically the electromagnet is connected to the door and the armored plate is connected to the door frame, where the two elements are connected when the door is closed. The electromagnetic lock can be either “fail safe” or “fail secure”. A fail-secure locking device remains locked when power is lost. Fail-safe locking devices are unlocked when de-energized. As depicted in Wikipedia, when the electromagnet is energized, a current passing through the electromagnet creates a magnetic flux that causes the armature plate to attract to the electromagnet, creating a locking action. Because the mating area of the electromagnet and armature is relatively large, the force created by the magnetic flux is strong enough to keep the door locked even under stress. Typically a separate release button that cuts the lock power supply is mounted near the door. This button usually has a timer that, once the button is pressed, keeps the lock unlocked for either 15 or 30 seconds in accordance with fire codes. Additionally a second release is required by fire code. Additionally or alternatively, either a motion sensor or crash bar with internal switch is used to unlock to door on the egress side of the door automatically.

The term “normally deployed” in reference to any of the cart parts, pillar, support, column, interchangeably refers herein after to a description of the state, or position of an element connected in a maneuverable connection (in for example a hinge with a spring loaded system). A normally deployed state means that mechanism for example are in a relaxed or resting position when the element is deployed. The position of the element will only change after application of force (for example mechanical force), and will always return to its relaxed deployed position when the application of force is removed. In an embodiment, for example when the column is maneuverably connected to for example the base, the default position of the column is to stand perpendicular to the base, upon application of horizontal force the column collapses toward for example the cart base, were it can be either at least partially embedded into the base, embedded into a designated placement, collapse on top of the base, or any angle in-between the primary perpendicular position to a horizontal position.

The terms “push to open”, “push to close” interchangeably refer hereinafter to a mechanism enabling opening or closing of a panel, a drawer, a door, by pushing the panel, drawer face, the door. This is usually done without utilizing a mounted handle. Further these mechanisms can be concealed within the object (panel). These mechanisms such as “push to open” commercially available from Southco©, or TIP-ON commercially available from Blum Inc.©.

The term “soft closure mechanism” interchangeably refers hereinafter to a mechanism with a buffered, controlled movement providing silent and soft closure, when alternating between open and closed configuration such as “Blumotion” commercially available from Blum Inc.©.

The term “living hinge” interchangeably refers hereinafter to a thin flexible hinge (flexure bearing) made from the same material as the two rigid pieces it connects, and not be an addition of another material, or some other flexible substance. It is typically thinned or cut to allow the rigid pieces to bend along the line of the hinge. This hinge is known for having minimal friction and very little wear, combined with low cost and ease of manufacturing and recycling.

The term “column” refers hereinafter to a support, rod, tripod, stand, mount, frame, easel, stool, pedestal, quadrated, tetrapod, quintuple legged, footing, hold, post, rib, reinforcement, etc. further the column can be made of or constructed of a single piece, multiple pieces, at least partially connected multiple pieces.

The term “plurality” interchangeably refers hereinafter to an integer a, when a>1.

The term “about” refers hereinafter to 20% more or less than the defied value.

The term “MRI-safe”, interchangeably refers hereinafter to any device, part, element, component or implant that is completely non-magnetic, non-electrically conductive, and non-RF reactive, eliminating all of the primary potential threats during an MRI procedure.

According to one embodiment of the present invention, a deployable neonate's incubator, comprising n panels; n is an integer equal to or greater than 3, forming an enclosure sized and shaped to accommodate a neonate. The incubator comprises at least one multi functional panel (MFP), out of the n panels or portion thereof. This MFP is reversibly attached to at least one or a portion thereof, of the n panels. The incubator is characterized by at least one first CLOSED CONFIGURATION, in which the neonate is sealingly enclosed within the closed environment of the incubator, and at least one first OPEN CONFIGURATION, in which the neonate is loosely accommodated within of the incubator and the MFP is unintermittedly deployed into a countertop.

According to another embodiment of the invention, an incubator as defined above is disclosed, wherein the incubator, in the closed configuration, encloses a neonate in an internal environment.

According to another embodiment of the invention, an incubator as defined above is disclosed, wherein the incubator comprising internal environmental control means.

According to another embodiment of the invention, an incubator as defined above is disclosed, wherein the open configuration forms an open environment incubator.

According to another embodiment of the invention, an incubator as defined above is disclosed, wherein the incubator comprising life support equipment. Additionally or alternatively, at least a portion of the life support equipment is integrated into at least one selected from a group consisting of: one of the n panels, the MFP and any combination thereof.

According to another embodiment of the invention, an incubator as defined above is disclosed, wherein the life support is configured to remain operating and connected to the neonate, the incubator or both during transition of the incubator between configurations, and additionally or alternatively while in both closed configuration opened configuration or both.

According to another embodiment of the invention, an incubator as defined above is disclosed, wherein the MFP is integrated into at least one of the n panels, when in the closed configuration.

According to another embodiment of the invention, an incubator as defined above is disclosed, wherein the MFP is layered on at least one of the n panels, when in the closed configuration.

According to another embodiment of the invention, an incubator as defined above is disclosed, wherein the MFP is connected to the incubator by a mechanism selected from a group consisting of: hinge mechanism, pivot point mechanism, sliding mechanism, telescopic mechanism, magnetic attachment mechanism and any combination thereof, providing a maneuverable connection.

According to another embodiment of the invention, an incubator as defined above is disclosed, wherein the MFP is deployable to a planar surface selected from a group consisting of horizontal, vertical, angled and any combination thereof.

According to another embodiment of the invention, an incubator as defined above is disclosed, wherein the MFP has at least two sections. Additionally or alternatively, at least a section of the MFP is deployable to a planar surface selected from a group consisting of horizontal, vertical, angled and any combination thereof.

According to another embodiment of the invention, an incubator as defined above is disclosed, wherein the MFP sections maneuverable in reference to each other, and are additionally or alternatively connected therebetween by a maneuverable mechanism selected from a group consisting of: hinge mechanism, pivot point mechanism, sliding mechanism, telescopic mechanism, magnetic attachment mechanism and any combination thereof.

According to another embodiment of the invention, an incubator as defined above is disclosed, wherein the MFP comprising side bars. Additionally or alternatively the side bars are maneuverably connected to the MFP.

According to another embodiment of the invention, an incubator as defined above is disclosed, wherein the MFP comprises at least one support connecting the MFP to an element selected from a group consisting of: the incubator, an incubator's cart, the ground, a vertical wall, a transport vehicle, an imaging system, and any combination thereof.

According to another embodiment of the invention, an incubator as defined above is disclosed, wherein the MFP support is foldable.

According to another embodiment of the invention, an incubator as defined above is disclosed, wherein at least a portion of the MFP comprising at least partially transparent material.

According to another embodiment of the invention, an incubator as defined above is disclosed, wherein the MFP comprising at least one opening.

According to another embodiment of the invention, an incubator as defined above is disclosed, wherein the MFP opening comprising a closable door.

According to another embodiment of the invention, an incubator as defined above is disclosed, wherein the MFP opening is sized and shaped for the passage of life support equipment.

According to another embodiment of the invention, an incubator as defined above is disclosed, wherein the MFP opening is sized and shaped for the passage of a handler's hand.

According to another embodiment of the invention, an incubator as defined above is disclosed, wherein the MFP opening is connected to an element selected from a group consisting of: a container, a tube, ventilation equipment, life supporting element, viewing equipment, temperature regulating system, waste disposal, and any combination thereof.

According to another embodiment of the invention, an incubator as defined above is disclosed, wherein at least a portion of the MFP is connected to life support equipment.

According to another embodiment of the invention, an incubator as defined above is disclosed, wherein the MFP comprising at least one life support element.

According to another embodiment of the invention, an incubator as defined above is disclosed, wherein at least a portion of the life support element is accommodated within the incubator.

According to another embodiment of the invention, an incubator as defined above is disclosed, wherein the MFP comprising a temperature regulating system. Additionally, the temperature regulating system is provided to regulate the temperature of a selected from a group consisting of: the MFP, the incubator, the neonate, the incubator's inner volume and any combination thereof.

According to another embodiment of the invention, an incubator as defined above is disclosed, wherein at least a portion of the MFP comprising at least one sterilizable material.

According to another embodiment of the invention, an incubator as defined above is disclosed, wherein the incubator is reversibly connected to a mobile cart.

According to another embodiment of the invention, an incubator as defined above is disclosed, wherein at least a portion of the MFP is reversibly connected to a mobile cart.

According to another embodiment of the invention, an incubator as defined above is disclosed, wherein at least a portion of the incubator comprising MRI safe material.

According to another embodiment of the invention, an incubator as defined above is disclosed, wherein the incubator comprising an ergonomic placement for at least a portion of the neonate.

According to another embodiment of the invention, an incubator as defined above is disclosed, wherein the incubator comprising means to secure the neonate within the incubator.

According to another embodiment of the invention, an incubator as defined above is disclosed, wherein the incubator comprising means to secure the neonate on top the MFP.

According to another embodiment of the invention, an incubator as defined above is disclosed, wherein the MFP comprising at least one sensor selected from a group consisting of: temperature, humidity, respiratory rate, weight, pressure, vibration, gas concentration, movement, closed or opened configuration of the incubator and any combination thereof.

According to another embodiment of the invention, an incubator as defined above is disclosed, wherein the sensor is connected to a component selected from a group consisting of: a CPU, an alarm system, a user interface, life support equipment, at least one indicator and any combination thereof.

According to another embodiment of the invention, an incubator as defined above is disclosed, wherein the incubator comprising a latching mechanism, configured to secure the incubator in a closed or opened configuration.

According to another embodiment of the invention, an incubator as defined above is disclosed, wherein the incubator comprising an opening mechanism, closing mechanism or both.

According to another embodiment of the invention, an incubator as defined above is disclosed, wherein the opening mechanism alternates between the closed configuration to the open configuration.

According to another embodiment of the invention, an incubator as defined above is disclosed, wherein the opening mechanism is an emergency opening mechanism.

According to another embodiment of the invention, an incubator as defined above is disclosed, wherein the mechanism is selected from a group consisting of: manual, automatic, and any combination thereof.

According to another embodiment of the invention, an incubator as defined above is disclosed, wherein the MFP comprising a lighting system.

According to another embodiment of the invention, an incubator as defined above is disclosed, wherein the lighting system comprising to have at least one mode of lighting for each configuration of the incubator.

According to another embodiment of the invention, an incubator as defined above is disclosed, wherein the lighting system comprising at least one first lighting mode for within the incubator enclosed environment and at least one first lighting mode for the incubator from the outside.

According to another embodiment of the invention, an incubator as defined above is disclosed, wherein the lighting system is maneuverable.

According to another embodiment of the invention, an incubator as defined above is disclosed, wherein the lighting system is operable manually, automatically or both.

According to another embodiment of the invention, an incubator as defined above is disclosed, wherein the lighting system comprising at least two light spectrums, at least two intensities, or both.

According to another embodiment of the invention, an incubator as defined above is disclosed, wherein the lighting system is connected to one selected from a group consisting of: the incubator, the MFP, CPU, an alarm system, an interlock mechanism, a user interface, a power supply, and any combination thereof.

According to another embodiment of the invention, an incubator as defined above is disclosed, wherein an interlock mechanism is connected to one selected from a group consisting of: the incubator, the MFP, a CPU, a user interface, an alarm system, an opening mechanism, a closing mechanism and any combination thereof.

According to another embodiment of the invention, an incubator as defined above is disclosed, wherein the mechanism is set to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

According to another embodiment of the invention, an incubator as defined above is disclosed, wherein the MFP comprising at least one indicator selected from a group consisting of: visual indicator, auditable indicator, sensible indicator and any combination thereof.

According to another embodiment of the invention, an incubator as defined above is disclosed, wherein the MFP comprising a placement for an element selected from a group consisting of: life support equipment, medical tools, disposable waste, medical tubing, disposable mattress, cleaning and disinfecting equipment, and any combination thereof.

According to another embodiment of the invention, an incubator as defined above is disclosed, wherein the MFP is reversibly connectable to another apparatus selected from a group consisting of: operating table, stretcher, gurney, cart, bed, crib, imaging device, transport incubator, treatment table and any combination thereof.

According to another embodiment of the invention, an incubator as defined above is disclosed, wherein the MFP comprising an emergency release mechanism, configured to release the neonate from the incubator in one step.

According to another embodiment of the invention, an incubator as defined above is disclosed, wherein the MFP is connected to a power supply selected from a group consisting of: external power supply, internal power supply and any combination thereof.

According to another embodiment of the invention, an incubator as defined above is disclosed, wherein the incubator comprising a CPU configured to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, an incubator as defined above is disclosed, wherein the CPU is connected to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, an incubator as defined above is disclosed, comprising a remote control mechanism; wherein the remote control mechanism controls a component selected from a group consisting of: opening mechanism, closing mechanism, CPU, lighting, temperature regulating system, life support equipment, ventilating system, alarm system, power supply, and any combination thereof.

According to another embodiment of the invention, an incubator as defined above is disclosed, wherein the incubator comprising a user interface.

According to another embodiment of the invention, an incubator as defined above is disclosed, wherein at least a portion of the user interface is integrated into at least one selected from a group consisting of: at least one of the n panels, the MFP and any combination thereof.

According to another embodiment of the invention, an incubator as defined above is disclosed, wherein the user interface is connected to a component selected from a group consisting of: the MFP, life support equipment, at least one sensor, CPU, power supply, temperature regulating system, lighting system, at least one indicator, display, and any combination thereof.

According to another embodiment of the invention, an incubator as defined above is disclosed, wherein the incubator comprises an alarm system. In an embodiment the alarm system is connected to a component selected from a group consisting of: the MFP, at least one sensor, at least one indicator, a user interface, a CPU, an interlock mechanism, life support equipment and any combination thereof.

According to another embodiment of the invention, an incubator as defined above is disclosed, wherein the incubator, comprising a housing sized and shaped to accommodate a neonate.

According to another embodiment of the invention, an incubator as defined above is disclosed, wherein the incubator housing encloses an internal environment.

According to another embodiment of the invention, an incubator as defined above is disclosed, wherein the incubator comprising means for controlling the incubator internal environment selected from a group consisting of: temperature regulating, ventilation, light, sound transmission, vibration, humidity, drift, movement and any combination thereof.

According to another embodiment of the invention, an incubator as defined above is disclosed, wherein the means for controlling the incubator internal environment temperature induce a homogenized temperature throughout the incubator inner environment.

According to another embodiment of the invention, an incubator as defined above is disclosed, wherein the means for controlling the incubator internal environment are connected to a user interface.

According to another embodiment of the invention, an incubator as defined above is disclosed, wherein the means for controlling the incubator internal environment are embedded within the incubator.

According to another embodiment of the invention, an incubator as defined above is disclosed, wherein the means for controlling the incubator internal environment are remotely controlled.

According to another embodiment of the invention, an incubator as defined above is disclosed, wherein the incubator comprises a closable door.

According to another embodiment of the invention, an incubator as defined above is disclosed, wherein the incubator door is sized and shaped to provide access to the neonate.

According to another embodiment of the invention, an incubator as defined above is disclosed, wherein at least a portion of the incubator comprising at least partially transparent material.

According to another embodiment of the invention, an incubator as defined above is disclosed, wherein the incubator comprising at least a portion of sterilizable material.

According to another embodiment of the invention, an incubator as defined above is disclosed, wherein the incubator comprising at least a portion of disposable material.

According to another embodiment of the invention, an incubator as defined above is disclosed, wherein the incubator is a one time use disposable incubator.

According to another embodiment of the invention, an incubator as defined above is disclosed, wherein the incubator is foldable.

According to another embodiment of the invention, an incubator as defined above is disclosed, wherein the MFP is a modular panel or portion thereof, interchangeable according to need.

According to another embodiment of the invention, an incubator as defined above is disclosed, wherein the incubator is constructible of modular pieces.

According to another embodiment of the invention, an incubator as defined above is disclosed, wherein the incubator comprising a CPU.

According to another embodiment of the invention, an incubator as defined above is disclosed, wherein the incubator comprising life support equipment.

According to another embodiment of the invention, an incubator as defined above is disclosed, wherein the incubator comprising at least one indicator.

According to another embodiment of the invention, an incubator as defined above is disclosed, wherein the incubator comprising an alarm system.

According to another embodiment of the invention, an incubator as defined above is disclosed, wherein the incubator CPU is connected to an element selected from a group consisting of: at least one sensor, a user interface, temperature regulating system, ventilating system, humidifying system, lighting system, life support equipment, a power supply, an alarm, at least one indicator and any combination thereof.

According to another embodiment of the invention, an incubator as defined above is disclosed, wherein the incubator comprises at least one opening.

According to another embodiment of the invention, an incubator as defined above is disclosed, wherein the opening is sized and shaped for the passage of an item selected from a group consisting of: life support equipment, medical equipment tubing, a handler's hand and any combination thereof.

According to another embodiment of the invention, an incubator as defined above is disclosed, wherein the incubator comprises bedding for a neonate.

According to another embodiment of the invention, an incubator as defined above is disclosed, wherein the incubator is connected to power supply.

According to another embodiment of the invention, an incubator as defined above is disclosed, wherein the incubator is connected to an incubators cart.

According to another embodiment of the invention, an incubator as defined above is disclosed, wherein the incubator comprising at least one sensor.

According to another embodiment of the invention, an incubator as defined above is disclosed, wherein the incubator comprising sensors.

According to another embodiment of the invention an incubator as defined above is disclosed comprising multiple panels, of which at least one panel is a multifunctional panel (MFP) having at least one life support element, providing the incubator with at least a closed configuration providing a closed environment incubator and an deployable open configuration into a life supporting countertop.

According to another embodiment of the invention an incubator as defined above is disclosed, the deployment of the incubator from an open configuration to a closed configuration maintains an accommodated neonate immovable.

According to another embodiment of the invention an incubator as defined above is disclosed, wherein the incubator is sized and shaped for insertion to an MRI apparatus for imaging.

According to another embodiment of the invention an incubator as defined above is disclosed, wherein the open configuration provides access to the neonate.

According to another embodiment of the invention, an incubator as defined above is disclosed, wherein the MFP comprises a handle.

According to another embodiment of the invention an incubator as defined above is disclosed, wherein the incubator comprising at least one opening and closing mechanism, the mechanism is connected to at least a portion of the MFP, and to at least a portion of at least a second of the n incubator panels, further wherein the mechanism is configured to maneuver the MFP such that the incubator is provided with the at least one first open configuration and the at least one first closed configuration.

According to another embodiment of the invention an incubator as defined above is disclosed, wherein the incubator comprising at least one collapsible column, useful for supporting the MFP, the column comprising an elongated member having at least two opposite ends, further wherein at least one first end is maneuverably connected to the MFP, and at least one second end is reversibly connected to an element selected from a group consisting of: a cart, a storage unit, a transport device, a wall, the floor, an imaging apparatus, a treatment table, and any combination thereof.

According to another embodiment of the invention an incubator as defined above is disclosed, wherein the column is configured to be NORMALLY DEPLOYED when the incubator is in an open configuration.

According to another embodiment of the invention an incubator as defined above is disclosed, wherein the column is reversibly collapsible.

According to another embodiment of the invention an incubator as defined above is disclosed, wherein the column is detachable from the incubator.

According to another embodiment of the invention an incubator as defined above is disclosed, comprising a collapsible column, wherein the column is connected to a mechanism configured to close the MFP when column is collapsed.

According to another embodiment of the invention an incubator as defined above is disclosed, comprising a collapsible column, wherein the column is connected to the MFP by a mechanism configured to collapse the column when the incubator is in a closed configuration.

According to another embodiment of the invention, an incubator as defined above is disclosed, wherein the column is collapsible upon application of horizontal force in the axis of at least partial interception of the incubator within a selected from a group consisting of: an MRD, a medical treatment device, a transport device and any combination thereof.

According to another embodiment of the invention, an incubator as defined above is disclosed, wherein the column is connected by a reversible connection, a maneuverable connection or both.

According to another embodiment of the invention, an incubator as defined above is disclosed, wherein the column is foldable or retractable.

According to another embodiment of the invention, an incubator as defined above is disclosed, wherein the column is of a shape selected from a group consisting of: round, multifaceted, geometric, non-geometric, compound shape, and any combination thereof.

According to another embodiment of the invention, an incubator as defined above is disclosed, wherein the column is comprised of a plurality of interconnected pieces.

According to another embodiment of the invention, an incubator as defined above is disclosed, wherein the column is collapsible toward an incubator's panel to a position relative to the panel selected from a group consisting of: at least partly embedded within the panel, placed on the panel, placed proximal to the panel, and any combination thereof.

According to another embodiment of the invention, an incubator as defined above is disclosed, wherein the column is maneuverable manually, automatically or both.

According to another embodiment of the invention, an incubator as defined above is disclosed, wherein at least a portion of the column is made of MRI-safe material.

According to another embodiment of the invention, an incubator as defined above is disclosed, wherein the incubator comprising at least one mechanism, connected to at least a portion of the MFP, configured to transform at least one first open configuration to at least one first closed configuration, at least one closed configuration to at least one open configuration, or both.

According to another embodiment of the invention, an incubator as defined above is disclosed, wherein the mechanism comprises horizontal movement means, thereby enabling closing or opening of a sliding mechanism.

According to another embodiment of the invention, an incubator as defined above is disclosed, wherein the mechanism comprises rotating movement means around a pivot point.

According to another embodiment of the invention, an incubator as defined above is disclosed, wherein the mechanism comprises a magnetic opening and closing means.

According to another embodiment of the invention, an incubator as defined above is disclosed, wherein the mechanism comprises an electromagnetic lock.

According to another embodiment of the invention, an incubator as defined above is disclosed, comprising at least a portion of an external face exposed to the external environment and at least a portion of an internal face exposed to the internal environment, wherein the mechanism is selected from a group consisting of: a concealed mechanism, a mechanism mounted on at least a portion of the external face of the incubator, a mechanism mounted on at least a portion of the internal face of the incubator, at least partially embedded within at least a portion of the MFP, at least partially embedded within at least a portion of the incubator, and any combination thereof.

According to another embodiment of the invention, an incubator as defined above is disclosed, wherein the mechanism is a normally closed mechanism, thereby maintaining the incubator in a closed configuration when in a resting position.

According to another embodiment of the invention, an incubator as defined above is disclosed, wherein the mechanism is a normally opened mechanism, thereby maintaining the incubator in an open configuration when in a resting position.

According to another embodiment of the invention, an incubator as defined above is disclosed, wherein the incubator comprises a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof.

According to another embodiment of the invention, an incubator as defined above is disclosed, wherein the MFP is connected to the incubator by at least one living hinge.

According to another embodiment of the invention, an incubator as defined above is disclosed, wherein the incubator comprises at least a portion of elastic material, enveloping an at least partially inflatable volume, at least partly connected to a frame, and an inflate and deflate mechanism; the elastic material is further connected to at least one hinge.

According to another embodiment of the invention, an incubator as defined above is disclosed, comprising an inflated configuration and a deflated configuration, wherein an inflated configuration deploys the MFP, and a deflated configuration encloses the incubator.

According to another embodiment of the invention, an incubator as defined above is disclosed, wherein the mechanism comprises a selected from a group consisting of: a push to open mechanism, a push to close mechanism, a self-closing mechanism, a soft closing mechanism, a soft opening mechanism, and any combination thereof.

According to another embodiment of the invention, an incubator as defined above is disclosed, comprising a plurality of MFP, wherein the incubator comprises a plurality of sliding mechanism for each the MFP; wherein the mechanisms are interconnected so as to provide simultaneous movement, when the incubator transforms between the opened and closed configurations.

According to another embodiment of the invention, an incubator as defined above is disclosed, comprising a plurality of MFPs, wherein maneuvering at least one first MFP, results in maneuvering of at least one second MFP.

According to another embodiment of the invention, an incubator as defined above is disclosed, wherein the incubator comprising at least one slide-able element, and at least one sliding mechanism, along the perimeter between at least one MPF to at least one incubator panel; the slide-able element comprises a recess along its longitudinal axis in which at least a portion of at least one of the n panels and at least a portion of the MFP are passed therethrough, thereby transforming the incubator between the opened and closed configurations.

According to another embodiment of the invention, an incubator as defined above is disclosed, wherein the MFP comprises at least a portion of a flexible flap.

According to another embodiment of the invention, an incubator as defined above is disclosed, wherein the incubator comprises a base, and at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

According to another embodiment of the invention, an incubator as defined above is disclosed, wherein the incubator is connected to a mobile cart containing at least a portion of the mechanism.

According to another embodiment of the invention, an incubator as defined above is disclosed, wherein the mechanism is configured to simultaneously close or open a plurality of MFPs.

According to another embodiment of the invention, an incubator as defined above is disclosed, comprising a plurality of MFP's, at least one opening mechanism, closing mechanism, or both, connected to each MFP, at least two of the maneuvering systems are interconnected to at least one bar; the bar is further interconnected to a main moveable shaft having a protrusion external to the incubator, wherein the moveable shaft is configured to maneuvering the connected MFP's thereby closing or opening the incubator.

According to another embodiment of the invention, an incubator as defined above is disclosed, wherein the mechanism is configured to have a controlled soft closure mechanism.

According to another embodiment of the invention, an incubator as defined above is disclosed, wherein the mechanism is selected from a group consisting of: manual, automatic, and any combination thereof.

According to another embodiment of the invention, an incubator as defined above is disclosed, wherein the mechanism is connected to a power supply selected from a group consisting of: AC, DC and any combination thereof.

According to another embodiment of the invention, an incubator as defined above is disclosed, wherein the incubator alternates between the open configuration to a closed configuration by a remote control mechanism.

According to another embodiment of the invention, an incubator as defined above is disclosed, wherein the opening mechanism is an emergency opening mechanism.

According to another embodiment of the invention, an incubator as defined above is disclosed, wherein the mechanism comprises an interlock mechanism.

According to one embodiment of the present invention, a method for manufacturing a deployable neonate's incubator, comprising at least the following steps: first, obtaining a neonate's incubator, comprising n panels; n is an integer equals to or greater than 3; secondly obtaining at least one panel or portion thereof a multi functional panel (MFP); and third, reversibly connecting the MFP to the incubator, wherein the step of reversibly connecting the MFP to the incubator is characterized by creating at least one first CLOSED CONFIGURATION, in which the neonate is sealingly enclosed within the closed environment of the incubator; and at least one first OPEN CONFIGURATION, in which the neonate is loosely accommodated within of the incubator and the MFP is unintermittedly deployed into a countertop.

According to another embodiment of the invention, a method as defined above is disclosed, additionally comprising a step of constructing the closed configuration enclosing the neonate in an internal environment.

It is another object of the current invention to disclose a method as described above, additionally comprising a step of connecting the incubator to internal environmental control means.

According to another embodiment of the invention, a method as defined above is disclosed, additionally comprising a step of forming the open configuration to an open environment incubator.

According to another embodiment of the invention, a method as defined above is disclosed, additionally comprising a step of constructing the incubator having life support equipment.

According to another embodiment of the invention, a method as defined above is disclosed, additionally comprising a step of at integrating at least a portion of the life support equipment into at least one selected from a group consisting of: one of the n panels, the MFP and any combination thereof.

According to another embodiment of the invention, a method as defined above is disclosed, additionally comprising a step of integrating the MFP into at least one of n panels, when in the closed configuration.

According to another embodiment of the invention, a method as defined above is disclosed, additionally comprising a step of layering the MFP on at least one of n panels, when in the closed configuration.

According to another embodiment of the invention, a method as defined above is disclosed, additionally comprising a step of maneuverably connecting the MFP to the incubator by a mechanism selected from a group consisting of: hinge mechanism, pivot point mechanism, sliding mechanism, telescopic mechanism, magnetic attachment mechanism and any combination thereof.

According to another embodiment of the invention, a method as defined above is disclosed, additionally comprising a step of constructing the MFP deploying to a planar surface selected from a group consisting of horizontal, vertical, angled and any combination thereof.

According to another embodiment of the invention, a method as defined above is disclosed, additionally comprising a step of constructing the MFP having at least two sections.

According to another embodiment of the invention, a method as defined above is disclosed, additionally comprising a step of constructing at least a section of the MFP deploying to a planar surface selected from a group consisting of horizontal, vertical, angled and any combination thereof.

According to another embodiment of the invention, a method as defined above is disclosed, additionally comprising a step of maneuverably connecting the MFP sections therebetween by a mechanism selected from a group consisting of: hinge mechanism, pivot point mechanism, sliding mechanism, telescopic mechanism, magnetic attachment mechanism and any combination thereof.

According to another embodiment of the invention, a method as defined above is disclosed, additionally comprising a step of the constructing the MFP with side bars.

According to another embodiment of the invention, a method as defined above is disclosed, additionally comprising a step of maneuverably connecting the side bars to the MFP.

According to another embodiment of the invention, a method as defined above is disclosed, additionally comprising a step of connecting at least one support to the MFP, connecting the MFP to an element selected from a group consisting of: the incubator, an incubator's cart, the ground, a vertical wall, a transport vehicle, an imaging system, and any combination thereof.

According to another embodiment of the invention, a method as defined above is disclosed, additionally comprising a step of forming a foldable support to the MFP.

According to another embodiment of the invention, a method as defined above is disclosed, additionally comprising a step of forming at least a portion of the MFP having at least partially transparent material.

According to another embodiment of the invention, a method as defined above is disclosed, additionally comprising a step of forming least one opening in the MFP.

According to another embodiment of the invention, a method as defined above is disclosed, additionally comprising a step of connecting a closable door to the MFP opening.

According to another embodiment of the invention, a method as defined above is disclosed, additionally comprising a step of sizing and shaping the MFP opening for the passage of life support equipment.

According to another embodiment of the invention, a method as defined above is disclosed, additionally comprising a step of sizing and shaping the MFP opening for the passage of a handler's hand.

According to another embodiment of the invention, a method as defined above is disclosed, additionally comprising a step of connecting the MFP opening to an element selected from a group consisting of: a container, a tube, ventilation equipment, life supporting element, viewing equipment, temperature regulating system, waste disposal, and any combination thereof.

According to another embodiment of the invention, a method as defined above is disclosed, additionally comprising a step of connecting at least a portion of the MFP to life support equipment.

According to another embodiment of the invention, a method as defined above is disclosed, additionally comprising a step of constructing the MFP having at least one life support element.

According to another embodiment of the invention, a method as defined above is disclosed, additionally comprising a step of accommodating at least a portion of the life support element within the incubator.

According to another embodiment of the invention, a method as defined above is disclosed, additionally comprising a step of constructing the MFP having a temperature regulating system.

According to another embodiment of the invention, a method as defined above is disclosed, additionally comprising a step of configuring the system to regulating the temperature of a selected from a group consisting of: the MFP, the incubator, the neonate, the incubator's inner volume and any combination thereof.

According to another embodiment of the invention, a method as defined above is disclosed, additionally comprising a step of forming at least a portion of the MFP of at least one sterilizable material.

According to another embodiment of the invention, a method as defined above is disclosed, additionally comprising a step of reversibly connecting the incubator to a mobile cart.

According to another embodiment of the invention, a method as defined above is disclosed, additionally comprising a step of reversibly connecting at least a portion of the MFP is to a mobile cart.

According to another embodiment of the invention, a method as defined above is disclosed, additionally comprising a step of forming at least a portion of the incubator of MRI safe material.

According to another embodiment of the invention, a method as defined above is disclosed, additionally comprising a step of constructing the incubator having an ergonomic placement for at least a portion of the neonate.

According to another embodiment of the invention, a method as defined above is disclosed, additionally comprising a step of connecting means to securing the neonate within the incubator.

According to another embodiment of the invention, a method as defined above is disclosed, additionally comprising a step of connecting means to securing the neonate on top the MFP.

According to another embodiment of the invention, a method as defined above is disclosed, additionally comprising a step of constructing the MFP having at least one sensor selected from a group consisting of: temperature, humidity, respiratory rate, weight, pressure, vibration, gas concentration, movement, closed or opened configuration of the incubator and any combination thereof.

According to another embodiment of the invention, a method as defined above is disclosed, additionally comprising a step of connecting the sensor to a component selected from a group consisting of: a CPU, an alarm system, a user interface, life support equipment, at least one indicator and any combination thereof.

According to another embodiment of the invention, a method as defined above is disclosed, additionally comprising a step of connecting a latching mechanism to the incubator.

According to another embodiment of the invention, a method as defined above is disclosed, additionally comprising a step of configuring the latching mechanism to secure the incubator in a closed or opened configuration.

According to another embodiment of the invention, a method as defined above is disclosed, additionally comprising a step of connecting the incubator to an opening mechanism, closing mechanism or both.

According to another embodiment of the invention, a method as defined above is disclosed, additionally comprising a step of constructing the opening mechanism alternating the incubator between the closed configuration to the open configuration.

According to another embodiment of the invention, a method as defined above is disclosed, additionally comprising a step of constructing the opening mechanism as an emergency opening mechanism.

According to another embodiment of the invention, a method as defined above is disclosed, additionally comprising a step of selecting the mechanism from a group consisting of: manual, automatic, and any combination thereof.

According to another embodiment of the invention, a method as defined above is disclosed, additionally comprising a step of constructing the MFP having a lighting system.

According to another embodiment of the invention, a method as defined above is disclosed, additionally comprising a step of constructing the lighting system having at least one mode of lighting for each configuration of the incubator.

According to another embodiment of the invention, a method as defined above is disclosed, additionally comprising a step of configuring the lighting system to have at least one first lighting mode for within the incubator enclosed environment and at least one first lighting mode for the incubator from the outside.

According to another embodiment of the invention, a method as defined above is disclosed, additionally comprising a step of maneuverably connecting the lighting system.

According to another embodiment of the invention, a method as defined above is disclosed, additionally comprising a step of installing the lighting system with an operating system either manual, automatic or both.

According to another embodiment of the invention, a method as defined above is disclosed, additionally comprising a step of installing the lighting system having at least two light spectrums, at least two intensities or both.

According to another embodiment of the invention, a method as defined above is disclosed, additionally comprising a step of connecting the lighting system to one selected from a group consisting of: the incubator, the MFP, CPU, an alarm system, an interlock mechanism, a user interface, a power supply, and any combination thereof.

According to another embodiment of the invention, a method as defined above is disclosed, additionally comprising a step of connecting an interlock mechanism connected to one selected from a group consisting of: the incubator, the MFP, a CPU, a user interface, an alarm system, an opening mechanism, a closing mechanism and any combination thereof.

According to another embodiment of the invention, a method as defined above is disclosed, additionally comprising a step of setting the mechanism to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

According to another embodiment of the invention, a method as defined above is disclosed, additionally comprising a step of constructing the MFP having at least one indicator selected from a group consisting of: visual indicator, auditable indicator, sensible indicator and any combination thereof.

According to another embodiment of the invention, a method as defined above is disclosed, additionally comprising a step of constructing the MFP having a placement for an element selected from a group consisting of: life support equipment, medical tools, disposable waste, medical tubing, disposable mattress, cleaning and disinfecting equipment, and any combination thereof.

According to another embodiment of the invention, a method as defined above is disclosed, additionally comprising a step of reversibly connecting the MFP to another apparatus selected from a group consisting of: operating table, stretcher, gurney, cart, bed, crib, imaging device, transport incubator, treatment table and any combination thereof.

According to another embodiment of the invention, a method as defined above is disclosed, additionally comprising a step of constructing the MFP having an emergency release mechanism, configured to release the neonate from the incubator in one step.

According to another embodiment of the invention, a method as defined above is disclosed, additionally comprising a step of connecting the MFP is to a power supply selected from a group consisting of: external power supply, internal power supply and any combination thereof.

According to another embodiment of the invention, a method as defined above is disclosed, additionally comprising a step of constructing the incubator having a CPU configured to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, a method as defined above is disclosed, additionally comprising a step of connecting the CPU to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, a method as defined above is disclosed, additionally comprising a step of configuring a remote control mechanism to control a component selected from a group consisting of: opening mechanism, closing mechanism, CPU, lighting, temperature regulating system, life support equipment, ventilating system, alarm system, power supply, and any combination thereof.

According to another embodiment of the invention, a method as defined above is disclosed, additionally comprising a step of constructing the incubator having a user interface.

According to another embodiment of the invention, a method as defined above is disclosed, additionally comprising a step of integrating at least a portion of the user interface into at least one selected from a group consisting of: at least one of the n panels, the MFP and any combination thereof.

According to another embodiment of the invention, a method as defined above is disclosed, additionally comprising a step of connecting the user interface to a component selected from a group consisting of: the MFP, life support equipment, at least one sensor, CPU, power supply, temperature regulating system, lighting system, at least one indicator, display, and any combination thereof.

According to another embodiment of the invention, a method as defined above is disclosed, additionally comprising a step of constructing the incubator having an alarm system.

According to another embodiment of the invention, a method as defined above is disclosed, additionally comprising a step of connecting the alarm system to a component selected from a group consisting of: the MFP, at least one sensor, at least one indicator, a user interface, a CPU, an interlock mechanism, life support equipment and any combination thereof.

According to another embodiment of the invention, a method as defined above is disclosed, additionally comprising a step of connecting a handle to the MFP.

According to another embodiment of the invention, a method as defined above is disclosed, additionally comprising a step of connecting at least one collapsible column, useful for supporting the MFP, the column comprising an elongated shape having at least two ends, having at least one first end of the column is maneuverably connected to the MFP, the column is configured to be NORMALLY DEPLOYED when the incubator is in an open configuration having at least one second end reversibly connected to a selected from a group consisting of a cart, a storage unit, a transport device, a wall, the floor, a medical treatment or imaging apparatus and any combination thereof.

According to another embodiment of the invention, a method as defined above is disclosed, additionally comprising a step of connecting the column to a maneuverable mechanism, configured to close the MFP when column is collapsed.

According to another embodiment of the invention, a method as defined above is disclosed, additionally comprising a step of configuring the column's maneuverable mechanism to collapse when the incubator is in a closed configuration.

According to another embodiment of the invention, a method as defined above is disclosed, additionally comprising a step of configuring the column to be collapsible upon application of horizontal force in the axis of at least partial interception of the incubator within a selected from a group consisting of: an MRD, a medical treatment device, a transport device and any combination thereof.

According to another embodiment of the invention, a method as defined above is disclosed, additionally comprising a step of connecting the column by a reversible connection, a maneuverable connection or both.

According to another embodiment of the invention, a method as defined above is disclosed, additionally comprising a step of constructing the column with a foldable or retractable configuration.

According to another embodiment of the invention, a method as defined above is disclosed, additionally comprising a step of constructing the column to a shape selected from a group consisting of: round, multifaceted, geometric, non-geometric, compound shape, and any combination thereof.

According to another embodiment of the invention, a method as defined above is disclosed, additionally comprising a step of constructing the column is comprised of a plurality of interconnected pieces.

According to another embodiment of the invention, a method as defined above is disclosed, additionally comprising a step of connecting at least one mechanism, to the incubator, interconnecting at least a portion of the MFP, configured to transform at least one first open configuration to at least one first closed configuration, at least one closed configuration to at least one open configuration, or both.

According to another embodiment of the invention, a method as defined above is disclosed, additionally comprising a step of connecting a mechanism having at least one first wing element connected to at least a portion of one first MFP and at least one second wing element connected to at least a portion of at least one additional panel; the wing is maneuverably coupled to the second wing; the mechanism is configured to transform at least one first open configuration to at least one first closed configuration and contrariwise.

According to another embodiment of the invention, a method as defined above is disclosed, additionally comprising a step of connecting the mechanism having horizontal movement means, thereby enabling closing or opening of a sliding mechanism.

According to another embodiment of the invention, a method as defined above is disclosed, additionally comprising a step of connecting the mechanism having rotating movement means around a pivot point.

According to another embodiment of the invention, a method as defined above is disclosed, additionally comprising a step of connecting the mechanism having a magnetic opening and closing means.

According to another embodiment of the invention, a method as defined above is disclosed, additionally comprising a step of connecting a mechanism having an electromagnetic lock.

According to another embodiment of the invention, a method as defined above is disclosed, additionally comprising a step of connecting a mechanism selected from a group consisting of: a concealed mechanism, a mechanism mounted on at least a portion of an external face of the incubator, a mechanism mounted on at least a portion of an internal face of the incubator, at least partially embedded within at least a portion of the MFP, at least partially embedded within at least a portion of the incubator, and any combination thereof.

According to another embodiment of the invention, a method as defined above is disclosed, additionally comprising a step of configuring the mechanism to be a normally closed mechanism, thereby maintaining the incubator in a closed configuration when in a resting position.

According to another embodiment of the invention, a method as defined above is disclosed, additionally comprising a step of configuring the mechanism to be a normally opened mechanism, thereby maintaining the incubator in an open configuration when in a resting position.

According to another embodiment of the invention, a method as defined above is disclosed, additionally comprising a step of connecting a selected from a group consisting of: a movement sensor, an electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof to the incubator.

According to another embodiment of the invention, a method as defined above is disclosed, additionally comprising a step of connecting the MFP to the incubator by at least one living hinge.

According to another embodiment of the invention, a method as defined above is disclosed, additionally comprising a step of constructing at least a portion of the MFP of elastic material, enveloping an at least partially inflatable volume, at least partly connected to a frame, and an inflate and deflate mechanism; the elastic material is further connected to at least one hinge.

According to another embodiment of the invention, a method as defined above is disclosed, additionally comprising a step of configuring inflate-deflate mechanism to provide an inflated configuration and a deflated configuration, where an inflated configuration deploys the MFP, and a deflated configuration encloses the incubator.

According to another embodiment of the invention, a method as defined above is disclosed, additionally comprising a step of constructing the mechanism to have at least one latch, configured to maintain the open configuration, the closed configuration, or both.

According to another embodiment of the invention, a method as defined above is disclosed, additionally comprising a step of connecting a mechanism selected from a group consisting of: a push to open mechanism, a push to close mechanism, a self-closing mechanism, a soft closing mechanism, a soft opening mechanism, and any combination thereof.

According to another embodiment of the invention, a method as defined above is disclosed, additionally comprising a step of connecting a plurality of MFPs, the incubator comprises a plurality of sliding mechanism for each the MFP; the mechanisms are interconnected so as to provide simultaneous movement, when the incubator transforms between the opened and closed configurations.

According to another embodiment of the invention, a method as defined above is disclosed, additionally comprising a step of connecting a plurality of MFPs, configured so that maneuvering at least one first MFP, results in maneuvering of at least one second MFP.

According to another embodiment of the invention, a method as defined above is disclosed, additionally comprising a step of connecting at least one slide-able element to the incubator, and at least one sliding mechanism, along the perimeter between at least one MPF to at least one incubator panel; the slide-able element comprises a recess along its longitudinal axis in which at least a portion of at least one of the n panels and at least a portion of the MFP are passed therethrough, thereby transforming the incubator between the opened and closed configurations.

According to another embodiment of the invention, a method as defined above is disclosed, additionally comprising a step of constructing at least a portion of the incubator with flexible material.

According to another embodiment of the invention, a method as defined above is disclosed, additionally comprising a step of connecting at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

According to another embodiment of the invention, a method as defined above is disclosed, additionally comprising a step of connecting the incubator to a mobile cart containing at least a portion of the mechanism.

According to another embodiment of the invention, a method as defined above is disclosed, additionally comprising a step of connecting a plurality of MFP's, to at least one opening mechanism, closing mechanism, or both, at least two of the maneuvering systems are interconnected to at least one bar; the bar is further interconnected to a main moveable shaft having a protrusion external to the incubator, and configuring the moveable shaft to maneuvering the connected MFP's thereby closing or opening the incubator.

According to another embodiment of the invention, a method as defined above is disclosed, additionally comprising a step of configuring the mechanism to have a controlled soft closure mechanism.

According to another embodiment of the invention, a method as defined above is disclosed, additionally comprising a step of selecting the mechanism from a group consisting of: manual, automatic, and any combination thereof.

According to another embodiment of the invention, a method as defined above is disclosed, additionally comprising a step of connecting the mechanism to a power supply selected from a group consisting of: AC, DC and any combination thereof.

According to another embodiment of the invention, a method as defined above is disclosed, additionally comprising a step of configuring a remote control to control the transition between open configuration and the closed configuration.

According to another embodiment of the invention, a method as defined above is disclosed, additionally comprising a step of connecting an emergency opening mechanism to the incubator.

According to another embodiment of the invention, a method as defined above is disclosed, additionally comprising a step of connecting an interlock to the opening mechanism.

According to one embodiment of the present invention, a method for deploying a neonate incubator's side panel or a portion thereof into a countertop, in at least the following steps: first, obtaining a deployable neonate's incubator, comprising n panels, at least one of which or portion thereof is a multi functional panel (MFP), reversibly attached to at least one of the n panels; n is an integer greater than 3; and second maneuvering at least one MFP or a portion thereof; wherein the step of maneuvering the MFP is deploying the incubator from at least one first CLOSED CONFIGURATION, in which the neonate is sealingly enclosed within the closed environment of the incubator; and at least one first OPEN CONFIGURATION, in which the neonate is loosely accommodated within of the incubator, and the MFP is deployed into a countertop smoothly without interference. Additionally or alternatively all the life support equipment, the neonate, the environment, the handler, are not hindered during this deployment. Additionally or alternatively, the life support equipment continues to operate, and portions of which connected to the neonate, the incubator or both remain connected and operational.

According to another embodiment of the invention, a method as defined above is disclosed, additionally comprising a step of enclosing the neonate in an internal environment when the incubator is in closed configuration.

According to another embodiment of the invention, a method as defined above is disclosed, additionally comprising a step of connecting the incubator to internal environmental control means.

According to another embodiment of the invention, a method as defined above is disclosed, additionally comprising a step of deploying the MFP thereby providing access to the neonate.

According to another embodiment of the invention, a method as defined above is disclosed, additionally comprising a step of deploying the incubator without moving the neonate.

According to another embodiment of the invention, a method as defined above is disclosed, additionally comprising a step of regulating the internal environment conditions.

According to another embodiment of the invention, a method as defined above is disclosed, additionally comprising a step of forming an open environment incubator the when deploying to the open configuration.

According to another embodiment of the invention, a method as defined above is disclosed, additionally comprising a step of treating the neonate when accommodated in the incubator in a closed configuration.

According to another embodiment of the invention, a method as defined above is disclosed, additionally comprising a step of treating the neonate when accommodated in an open configuration deployed incubator.

According to another embodiment of the invention, a method as defined above is disclosed, additionally comprising a step of connecting life support equipment to the incubator.

According to another embodiment of the invention, a method as defined above is disclosed, additionally comprising a step of at integrating at least a portion of the life support equipment into at least one selected from a group consisting of: one of the n panels, the MFP and any combination thereof.

According to another embodiment of the invention, a method as defined above is disclosed, additionally comprising a step of integrating the MFP into at least one incubator panel, when in the closed configuration.

According to another embodiment of the invention, a method as defined above is disclosed, additionally comprising a step of layering the MFP on at least one of n panels, when in the closed configuration.

According to another embodiment of the invention, a method as defined above is disclosed, additionally comprising a step of maneuverably connecting the MFP to the incubator by a mechanism selected from a group consisting of: hinge mechanism, pivot point mechanism, sliding mechanism, telescopic mechanism, magnetic attachment mechanism and any combination thereof.

According to another embodiment of the invention, a method as defined above is disclosed, additionally comprising a step of deploying the MFP to a planar surface selected from a group consisting of horizontal, vertical, angled and any combination thereof.

According to another embodiment of the invention, a method as defined above is disclosed, additionally comprising a step of selecting the MFP having at least two sections.

According to another embodiment of the invention, a method as defined above is disclosed, additionally comprising a step of deploying at least a section of the MFP to a planar surface selected from a group consisting of horizontal, vertical, angled and any combination thereof.

According to another embodiment of the invention, a method as defined above is disclosed, additionally comprising a step of maneuverably connecting the MFP sections are therebetween by a mechanism selected from a group consisting of: hinge mechanism, pivot point mechanism, sliding mechanism, telescopic mechanism, magnetic attachment mechanism and any combination thereof.

According to another embodiment of the invention, a method as defined above is disclosed, additionally comprising a step of maneuvering the MFP section thereby deploying the incubator.

According to another embodiment of the invention, a method as defined above is disclosed, additionally comprising a step of maneuverably connecting side bars to the MFP.

According to another embodiment of the invention, a method as defined above is disclosed, additionally comprising a step of maneuvering the side bars.

According to another embodiment of the invention, a method as defined above is disclosed, additionally comprising a step of connecting at least one support to the MFP connecting the MFP to an element selected from a group consisting of: the incubator, an incubator's cart, the ground, a vertical wall, a transport vehicle, an imaging system, and any combination thereof, thereby supporting the MFP.

According to another embodiment of the invention, a method as defined above is disclosed, additionally comprising a step of selecting the MFP having at least a portion of at least partially transparent material.

According to another embodiment of the invention, a method as defined above is disclosed, additionally comprising a step of viewing the neonate.

According to another embodiment of the invention, a method as defined above is disclosed, additionally comprising a step of selecting the MFP having an opening.

According to another embodiment of the invention, a method as defined above is disclosed, additionally comprising a step of connecting a closable door to the MFP opening.

According to another embodiment of the invention, a method as defined above is disclosed, additionally comprising a step of closing or opening the MFP door.

According to another embodiment of the invention, a method as defined above is disclosed, additionally comprising a step of selecting a the MFP having an opening sized and shaped for the passage of a selected from a group consisting of: life support equipment, a handlers hand, medical equipment tubing and any combination thereof.

According to another embodiment of the invention, a method as defined above is disclosed, additionally comprising a step of passing through the MFP opening a selected from a group consisting of: life support equipment, a handler's hand, medical equipment tubing and any combination thereof.

According to another embodiment of the invention, a method as defined above is disclosed, additionally comprising a step of connecting the MFP opening is to an element selected from a group consisting of: a container, a tube, ventilation equipment, life supporting element, viewing equipment, temperature regulating system, waste disposal, and any combination thereof.

According to another embodiment of the invention, a method as defined above is disclosed, additionally comprising a step of connecting at least a portion of the MFP to life support equipment.

According to another embodiment of the invention, a method as defined above is disclosed, additionally comprising a step of selecting the MFP having at least one life support element.

According to another embodiment of the invention, a method as defined above is disclosed, additionally comprising a step of accommodating at least a portion of the life support element within the incubator.

According to another embodiment of the invention, a method as defined above is disclosed, additionally comprising a step of regulating the temperature of a selected from a group consisting of: the MFP, the incubator, the neonate, the incubator's inner volume and any combination thereof.

According to another embodiment of the invention, a method as defined above is disclosed, additionally comprising a step of sterilizing at least a portion of the incubator.

According to another embodiment of the invention, a method as defined above is disclosed, additionally comprising a step of sterilizing at least a portion of the MFP.

According to another embodiment of the invention, a method as defined above is disclosed, additionally comprising a step of reversibly connecting the incubator to a mobile cart.

According to another embodiment of the invention, a method as defined above is disclosed, additionally comprising a step of reversibly connecting at least a portion of the MFP is to a mobile cart.

According to another embodiment of the invention, a method as defined above is disclosed, additionally comprising a step of forming at least a portion of the incubator of MRI safe material.

According to another embodiment of the invention, a method as defined above is disclosed, additionally comprising a step of imaging the neonate when accommodated within the incubator.

According to another embodiment of the invention, a method as defined above is disclosed, additionally comprising a step of accommodating at least a portion of the neonate in an ergonomic placement connected to the incubator.

According to another embodiment of the invention, a method as defined above is disclosed, additionally comprising a step of securing at least a portion of the neonate with securing means connected within the incubator.

According to another embodiment of the invention, a method as defined above is disclosed, additionally comprising a step of securing at least a portion of the neonate with securing means connected on top of the MFP.

According to another embodiment of the invention, a method as defined above is disclosed, additionally comprising a step of constructing the MFP having at least one sensor selected from a group consisting of: temperature, humidity, respiratory rate, weight, pressure, vibration, gas concentration, movement, closed or opened configuration of the incubator and any combination thereof.

According to another embodiment of the invention, a method as defined above is disclosed, additionally comprising a step of connecting the sensor to a component selected from a group consisting of: a CPU, an alarm system, a user interface, life support equipment, at least one indicator and any combination thereof.

According to another embodiment of the invention, a method as defined above is disclosed, additionally comprising a step of opening or closing a latching mechanism connected to the incubator.

According to another embodiment of the invention, a method as defined above is disclosed, additionally comprising a step of securing the latching mechanism thereby maintaining the incubator in a closed or opened configuration.

According to another embodiment of the invention, a method as defined above is disclosed, additionally comprising a step of connecting the incubator to an opening mechanism, closing mechanism or both.

According to another embodiment of the invention, a method as defined above is disclosed, additionally comprising a step of alternating the opening mechanism between the closed configuration to the open configuration.

According to another embodiment of the invention, a method as defined above is disclosed, additionally comprising a step of connecting an emergency opening mechanism thereby enabling immediate opening the incubator.

According to another embodiment of the invention, a method as defined above is disclosed, additionally comprising a step of selecting operating the opening mechanism manually, automatically, or both.

According to another embodiment of the invention, a method as defined above is disclosed, additionally comprising a step of installing a lighting system.

According to another embodiment of the invention, a method as defined above is disclosed, additionally comprising a step of choosing at least one lighting mode for each configuration of the incubator.

According to another embodiment of the invention, a method as defined above is disclosed, additionally comprising a step of configuring the lighting system to have to have at least one first lighting mode for within the incubator enclosed environment and at least one first lighting mode for the incubator from the outside.

According to another embodiment of the invention, a method as defined above is disclosed, additionally comprising a step of maneuverably connecting the lighting system.

According to another embodiment of the invention, a method as defined above is disclosed, additionally comprising a step of controlling the lighting system manually, automatically or both.

According to another embodiment of the invention, a method as defined above is disclosed, additionally comprising a step of configuring the lighting system having lighting in at least two light spectrums, at least two intensities or both.

According to another embodiment of the invention, a method as defined above is disclosed, additionally comprising a step of connecting the lighting system to one selected from a group consisting of: the incubator, the MFP, CPU, an alarm system, an interlock mechanism, a user interface, a power supply, and any combination thereof.

According to another embodiment of the invention, a method as defined above is disclosed, additionally comprising a step of connecting an interlock mechanism connected to one selected from a group consisting of: the incubator, the MFP, a CPU, a user interface, an alarm system, an opening mechanism, a closing mechanism and any combination thereof.

According to another embodiment of the invention, a method as defined above is disclosed, additionally comprising a step of setting the mechanism to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

According to another embodiment of the invention, a method as defined above is disclosed, additionally comprising a step of connecting at least one indicator to the MFP selected from a group consisting of: visual indicator, auditable indicator, sensible indicator and any combination thereof.

According to another embodiment of the invention, a method as defined above is disclosed, additionally comprising a step of connecting a placement to the MFP for an element selected from a group consisting of: life support equipment, medical tools, disposable waste, medical tubing, disposable mattress, cleaning and disinfecting equipment, and any combination thereof.

According to another embodiment of the invention, a method as defined above is disclosed, additionally comprising a step of reversibly connecting the MFP to another apparatus selected from a group consisting of: operating table, stretcher, gurney, cart, bed, crib, imaging device, transport incubator, treatment table and any combination thereof.

According to another embodiment of the invention, a method as defined above is disclosed, additionally comprising a step of connecting an emergency release mechanism to the MFP having, configured to release the neonate from the incubator in one step.

According to another embodiment of the invention, a method as defined above is disclosed, additionally comprising a step of one step releasing the neonate from the incubator.

According to another embodiment of the invention, a method as defined above is disclosed, additionally comprising a step of connecting the MFP is to a power supply selected from a group consisting of: external power supply, internal power supply and any combination thereof.

According to another embodiment of the invention, a method as defined above is disclosed, additionally comprising a step of connecting a CPU to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, a method as defined above is disclosed, additionally comprising a step of configuring the CPU to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, a method as defined above is disclosed, additionally comprising a step of configuring a remote control mechanism to control a component selected from a group consisting of: opening mechanism, closing mechanism, CPU, lighting, temperature regulating system, life support equipment, ventilating system, alarm system, power supply, and any combination thereof.

According to another embodiment of the invention, a method as defined above is disclosed, additionally comprising a step of connecting a user interface.

According to another embodiment of the invention, a method as defined above is disclosed, additionally comprising a step of integrating at least a portion of the user interface into at least one selected from a group consisting of: at least one of the n panels, the MFP and any combination thereof.

According to another embodiment of the invention, a method as defined above is disclosed, additionally comprising a step of connecting the user interface to a component selected from a group consisting of: the MFP, life support equipment, at least one sensor, CPU, power supply, temperature regulating system, lighting system, at least one indicator, display, and any combination thereof.

According to another embodiment of the invention, a method as defined above is disclosed, additionally comprising a step of maneuvering the MFP through the user interface.

According to another embodiment of the invention, a method as defined above is disclosed, additionally comprising a step of connecting an alarm system to a component selected from a group consisting of: the MFP, at least one sensor, at least one indicator, a user interface, a CPU, an interlock mechanism, life support equipment and any combination thereof.

According to another embodiment of the invention, a method as defined above is disclosed, additionally comprising a step of maneuvering at least one of n panels or a portion thereof, to deploy to the open configuration.

According to another embodiment of the invention, a method as defined above is disclosed, additionally comprising a step of connecting a handle to the MFP.

According to another embodiment of the invention, a method as defined above is disclosed, additionally comprising a step of using a handle to deploy the MFP.

According to another embodiment of the invention, a method as defined above is disclosed, additionally comprising a step of selecting an incubator having at least one collapsible column, useful for supporting the MFP, the column comprising an elongated shape having at least two ends, having at least one first end of the column is maneuverably connected to the MFP, the column is configured to be NORMALLY DEPLOYED when the incubator is in an open configuration having at least one second end reversibly connected to a selected from a group consisting of a cart, a storage unit, a transport device, a wall, the floor, a medical treatment or imaging apparatus and any combination thereof.

According to another embodiment of the invention, a method as defined above is disclosed, additionally comprising a step of closing the MFP by collapsing the column.

It is another object of the current invention to disclose a method as described above, additionally comprising a step of collapsing the column when closing the MFP.

According to another embodiment of the invention, a method as defined above is disclosed, additionally comprising a step of collapsing the column upon application of horizontal force in the axis of at least partial interception of the incubator within a selected from a group consisting of: an MRD, a medical treatment device, a transport device and any combination thereof.

According to another embodiment of the invention, a method as defined above is disclosed, additionally comprising a step of selecting the column connected to the incubator by a reversible connection, a maneuverable connection or both.

According to another embodiment of the invention, a method as defined above is disclosed, additionally comprising a step of folding or retracting the column.

According to another embodiment of the invention, a method as defined above is disclosed, additionally comprising a step of unfolding or advancing the column.

According to another embodiment of the invention, a method as defined above is disclosed, additionally comprising a step of selecting the column of a shape selected from a group consisting of: round, multifaceted, geometric, non-geometric, compound shape, and any combination thereof.

According to another embodiment of the invention, a method as defined above is disclosed, additionally comprising a step of selecting the column comprised of a plurality of interconnected pieces.

According to another embodiment of the invention, a method as defined above is disclosed, additionally comprising a step of selecting the incubator having at least one mechanism, interconnecting at least a portion of the MFP to the incubator, configured to transform at least one first open configuration to at least one first closed configuration, at least one closed configuration to at least one open configuration, or both.

According to another embodiment of the invention, a method as defined above is disclosed, additionally comprising a step of maneuvering a mechanism having at least one first wing element connected to at least a portion of one first MFP and at least one second wing element connected to at least a portion of at least one additional panel; the wing is maneuverably coupled to the second wing; the mechanism is configured to transforming at least one first open configuration to at least one first closed configuration and contrariwise.

According to another embodiment of the invention, a method as defined above is disclosed, additionally comprising a step of moving the mechanism horizontally, thereby enabling closing or opening of a sliding mechanism.

According to another embodiment of the invention, a method as defined above is disclosed, additionally comprising a step of rotating or tilting the mechanism around a pivot point.

According to another embodiment of the invention, a method as defined above is disclosed, additionally comprising a step of utilizing magnetism to open or close the incubator.

According to another embodiment of the invention, a method as defined above is disclosed, additionally comprising a step of closing or opening the incubator by utilizing an electromagnetic lock.

According to another embodiment of the invention, a method as defined above is disclosed, additionally comprising a step of selecting an incubator having a mechanism selected from a group consisting of: a concealed mechanism, a mechanism mounted on at least a portion of an external face of the incubator, a mechanism mounted on at least a portion of an internal face of the incubator, at least partially embedded within at least a portion of the MFP, at least partially embedded within at least a portion of the incubator, and any combination thereof.

According to another embodiment of the invention, a method as defined above is disclosed, additionally comprising a step of selecting the incubator having a normally closed mechanism, thereby maintaining the incubator in a closed configuration when in a resting position.

According to another embodiment of the invention, a method as defined above is disclosed, additionally comprising a step of selecting the incubator having a normally opened mechanism, thereby maintaining the incubator in an open configuration when in a resting position.

According to another embodiment of the invention, a method as defined above is disclosed, additionally comprising a step of operating a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof connected to the incubator, thereby deploying or closing the MFP.

According to another embodiment of the invention, a method as defined above is disclosed, additionally comprising a step of selecting the incubator having at least a portion of elastic material, enveloping an at least partially inflatable volume, at least partly connected to a frame, and an inflate and deflate mechanism; the elastic material is further connected to at least one hinge.

According to another embodiment of the invention, a method as defined above is disclosed, additionally comprising a step of inflating or deflating the mechanism thereby providing an inflated configuration and a deflated configuration, where an inflated configuration deploys the MFP, and a deflated configuration encloses the incubator.

According to another embodiment of the invention, a method as defined above is disclosed, additionally comprising a step of maintaining the open configuration, closed configuration or both by utilizing at least one latch.

According to another embodiment of the invention, a method as defined above is disclosed, additionally comprising a step of operating the mechanism by a selected from a group consisting of: pushing to open, pushing to close, a self-closing, a soft closing, a soft opening, and any combination thereof.

According to another embodiment of the invention, a method as defined above is disclosed, additionally comprising a step of simultaneously closing a plurality of MFPs by operating a plurality of opening mechanism, closing mechanism or both for each the MFP interconnected therebetween.

According to another embodiment of the invention, a method as defined above is disclosed, additionally comprising a step of simultaneously closing a plurality of MFPs by maneuvering at least one first MFP, interconnected to at least one second MFP or at least one second opening, closing, or both mechanism.

According to another embodiment of the invention, a method as defined above is disclosed, additionally comprising a step of sliding at least one slide able element along the perimeter between at least one MPF to at least one incubator panel; the slide-able element comprises a recess along its longitudinal axis in which at least a portion of at least one of the n panels and at least a portion of the MFP are passed therethrough, thereby transforming the incubator between the opened and closed configurations.

According to another embodiment of the invention, a method as defined above is disclosed, additionally comprising a step of moving at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

According to another embodiment of the invention, a method as defined above is disclosed, additionally comprising a step of selecting the incubator connected to a mobile cart containing at least a portion of the opening, closing or both mechanism.

According to another embodiment of the invention, a method as defined above is disclosed, additionally comprising a step of maneuvering a moveable shaft, having a protrusion external to the incubator, interconnected to a side bar further connected to a maneuvering mechanism connected to a plurality of MFP's, thereby closing or opening the incubator.

According to another embodiment of the invention, a method as defined above is disclosed, additionally comprising a step of selecting the incubator having a controlled soft close, soft open mechanism or both.

According to another embodiment of the invention, a method as defined above is disclosed, additionally comprising a step of selecting the incubator having the opening mechanism, closing mechanism or both selected from a group consisting of: manual, automatic, and any combination thereof.

According to another embodiment of the invention, a method as defined above is disclosed, additionally comprising a step of connecting the mechanism to a power supply selected from a group consisting of: AC, DC and any combination thereof.

According to another embodiment of the invention, a method as defined above is disclosed, additionally comprising a step of remote controlling the transition between open configuration and the closed configuration.

According to another embodiment of the invention, a method as defined above is disclosed, additionally comprising a step of emergency opening the incubator by utilizing an emergency opening mechanism.

According to another embodiment of the invention, a method as defined above is disclosed, additionally comprising a step of operating an interlock connected to the opening mechanism.

According to one embodiment of the present invention, in a deployable neonate's incubator, comprising n panels, a multi functional panel (MFP) that is reversibly attachable to at least a one of the n panels; n is an integer equal to or greater than 3, the MFP is characterized by at least one first CLOSED CONFIGURATION, in which the neonate is sealingly enclosed within the closed environment of the incubator; and at least one first OPEN CONFIGURATION, in which the neonate is loosely accommodated within of the incubator and the MFP is unintermittedly deployed into a countertop.

According to another embodiment of the invention, a MFP as defined above is disclosed, wherein the incubator, in the closed configuration, encloses the neonate in an internal environment.

According to another embodiment of the invention, a MFP as defined above is disclosed, wherein the incubator comprising internal environmental control means.

According to another embodiment of the invention, a MFP as defined above is disclosed, wherein the open configuration forms an open environment incubator.

According to another embodiment of the invention, a MFP as defined above is disclosed, wherein the incubator comprising life support equipment.

According to another embodiment of the invention, a MFP as defined above is disclosed, wherein at least a portion of the life support equipment is integrated into at least one selected from a group consisting of: one of the n panels, the MFP and any combination thereof.

According to another embodiment of the invention, a MFP as defined above is disclosed, wherein the MFP is at least a portion of at least one of n panels.

According to another embodiment of the invention, a MFP as defined above is disclosed, wherein the MFP is integrated into at least one of the n panels, when in the closed configuration.

According to another embodiment of the invention, a MFP as defined above is disclosed, wherein the MFP is layered on at least one of n panels, when in the closed configuration.

According to another embodiment of the invention, a MFP as defined above is disclosed, wherein the MFP is maneuverably connected to the incubator by a mechanism selected from a group consisting of: hinge mechanism, pivot point mechanism, sliding mechanism, telescopic mechanism, magnetic attachment mechanism and any combination thereof.

According to another embodiment of the invention, a MFP as defined above is disclosed, wherein the MFP is deployable to a planar surface selected from a group consisting of horizontal, vertical, angled and any combination thereof.

According to another embodiment of the invention, a MFP as defined above is disclosed, wherein the MFP comprises at least two sections.

According to another embodiment of the invention, a MFP as defined above is disclosed, wherein at least a section of the MFP is deployable to a planar surface selected from a group consisting of horizontal, vertical, angled and any combination thereof.

According to another embodiment of the invention, a MFP as defined above is disclosed, wherein the MFP sections are maneuverably connected therebetween by a mechanism selected from a group consisting of: hinge mechanism, pivot point mechanism, sliding mechanism, telescopic mechanism, magnetic attachment mechanism and any combination thereof.

According to another embodiment of the invention, a MFP as defined above is disclosed, wherein the MFP comprising side bars.

According to another embodiment of the invention, a MFP as defined above is disclosed, comprising side bars, wherein the side bars are maneuverably connected to the MFP.

According to another embodiment of the invention, a MFP as defined above is disclosed, wherein the MFP comprises at least one support connecting the MFP to an element selected from a group consisting of: the incubator, an incubator's cart, the ground, a vertical wall, a transport vehicle, an imaging system, and any combination thereof.

According to another embodiment of the invention, a MFP as defined above is disclosed, wherein the MFP support is foldable.

According to another embodiment of the invention, a MFP as defined above is disclosed, wherein at least a portion of the MFP comprising at least partially transparent material.

According to another embodiment of the invention, a MFP as defined above is disclosed, wherein the MFP comprising at least one opening.

According to another embodiment of the invention, a MFP as defined above is disclosed, wherein the MFP opening comprising a closable door.

According to another embodiment of the invention, a MFP as defined above is disclosed, wherein the MFP opening is sized and shaped for the passage of life support equipment.

According to another embodiment of the invention, a MFP as defined above is disclosed, wherein the MFP opening is sized and shaped for the passage of a handler's hand.

According to another embodiment of the invention, a MFP as defined above is disclosed, wherein the MFP opening is connected to an element selected from a group consisting of: a container, a tube, ventilation equipment, life supporting element, viewing equipment, temperature regulating system, waste disposal, and any combination thereof.

According to another embodiment of the invention, a MFP as defined above is disclosed, wherein at least a portion of the MFP is connected to life support equipment.

According to another embodiment of the invention, a MFP as defined above is disclosed, wherein the MFP comprising at least one life support element.

According to another embodiment of the invention, a MFP as defined above is disclosed, wherein at least a portion of the life support element is accommodated within the incubator.

According to another embodiment of the invention, a MFP as defined above is disclosed, wherein the MFP comprising a temperature regulating system.

According to another embodiment of the invention, a MFP as defined above is disclosed, wherein the temperature regulating system regulates the temperature of a selected from a group consisting of: the MFP, the incubator, the neonate, the incubator's inner volume and any combination thereof.

According to another embodiment of the invention, a MFP as defined above is disclosed, wherein at least a portion of the MFP comprising at least one sterilizable material.

According to another embodiment of the invention, a MFP as defined above is disclosed, wherein the incubator is reversibly connected to a mobile cart.

According to another embodiment of the invention, a MFP as defined above is disclosed, wherein at least a portion of the MFP is reversibly connected to a mobile cart.

According to another embodiment of the invention, a MFP as defined above is disclosed, wherein at least a portion of the incubator comprising MRI safe material.

According to another embodiment of the invention, a MFP as defined above is disclosed, wherein the incubator comprising an ergonomic placement for at least a portion of the neonate.

According to another embodiment of the invention, a MFP as defined above is disclosed, wherein the incubator comprising means to secure the neonate within the incubator.

According to another embodiment of the invention, a MFP as defined above is disclosed, wherein the incubator comprising means to secure the neonate on top the MFP.

According to another embodiment of the invention, a MFP as defined above is disclosed, wherein the MFP comprising at least one sensor selected from a group consisting of: temperature, humidity, respiratory rate, weight, pressure, vibration, gas concentration, movement, closed or opened configuration of the incubator and any combination thereof.

According to another embodiment of the invention, a MFP as defined above is disclosed, wherein the sensor is connected to a component selected from a group consisting of: a CPU, an alarm system, a user interface, life support equipment, at least one indicator and any combination thereof.

According to another embodiment of the invention, a MFP as defined above is disclosed, wherein the incubator comprising a latching mechanism, configured to secure the incubator in a closed or opened configuration.

According to another embodiment of the invention, a MFP as defined above is disclosed, wherein the incubator comprising an opening mechanism, closing mechanism or both.

According to another embodiment of the invention, a MFP as defined above is disclosed, wherein the opening mechanism alternates between the closed configuration to the open configuration.

According to another embodiment of the invention, a MFP as defined above is disclosed, wherein the opening mechanism is an emergency opening mechanism.

According to another embodiment of the invention, a MFP as defined above is disclosed, wherein the mechanism is selected from a group consisting of: manual, automatic, and any combination thereof.

According to another embodiment of the invention, a MFP as defined above is disclosed, wherein the MFP comprising a lighting system.

According to another embodiment of the invention, a MFP as defined above is disclosed, wherein the lighting system comprising to have at least one mode of lighting for each configuration of the incubator.

According to another embodiment of the invention, a MFP as defined above is disclosed, wherein the lighting system comprising different lighting within the incubator enclosed environment and the outside.

According to another embodiment of the invention, a MFP as defined above is disclosed, wherein the lighting system is maneuverable.

According to another embodiment of the invention, a MFP as defined above is disclosed, wherein the lighting system is operable manually, automatically or both.

According to another embodiment of the invention, a MFP as defined above is disclosed, wherein the lighting system comprising lighting in at least two light spectrums, at least two intensities, or both.

According to another embodiment of the invention, a MFP as defined above is disclosed, wherein the lighting system is connected to one selected from a group consisting of: the incubator, the MFP, CPU, an alarm system, an interlock mechanism, a user interface, a power supply, and any combination thereof.

According to another embodiment of the invention, a MFP as defined above is disclosed, wherein an interlock mechanism is connected to one selected from a group consisting of: the incubator, the MFP, a CPU, a user interface, an alarm system, an opening mechanism, a closing mechanism and any combination thereof.

According to another embodiment of the invention, a MFP as defined above is disclosed, wherein the mechanism is set to prevent closure of the incubator when detecting a condition selected from a group consisting of: protrusion of an object or body portion from within the incubator to the outside through the opening or contrariwise, when receiving predetermined signal from life support equipment, when structural integrity of incubator or other incubator portion is compromised, and any combination thereof.

According to another embodiment of the invention, a MFP as defined above is disclosed, wherein the MFP comprising at least one indicator selected from a group consisting of: visual indicator, auditable indicator, sensible indicator and any combination thereof.

According to another embodiment of the invention, a MFP as defined above is disclosed, wherein the MFP comprising a placement for an element selected from a group consisting of: life support equipment, medical tools, disposable waste, medical tubing, disposable mattress, cleaning and disinfecting equipment, and any combination thereof.

According to another embodiment of the invention, a MFP as defined above is disclosed, wherein the MFP is reversibly connectable to another apparatus selected from a group consisting of: operating table, stretcher, gurney, cart, bed, crib, imaging device, transport incubator, treatment table and any combination thereof.

According to another embodiment of the invention, a MFP as defined above is disclosed, wherein the MFP comprising an emergency release mechanism, configured to release the neonate from the incubator in one step.

According to another embodiment of the invention, a MFP as defined above is disclosed, wherein the MFP is connected to a power supply selected from a group consisting of: external power supply, internal power supply and any combination thereof.

According to another embodiment of the invention, a MFP as defined above is disclosed, wherein the incubator comprising a CPU configured to control a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, a MFP as defined above is disclosed, wherein the CPU is connected to a component selected from a group consisting of: a user interface, an alarm system, opening mechanism, closing mechanism, lighting system, life support element, an interlock mechanism, temperature regulating system, a ventilation system, a power supply, at least one indicator and any combination thereof.

According to another embodiment of the invention, a MFP as defined above is disclosed, comprising a remote control mechanism; wherein the remote control mechanism controls a component selected from a group consisting of: opening mechanism, closing mechanism, CPU, lighting, temperature regulating system, life support equipment, ventilating system, alarm system, power supply, and any combination thereof.

According to another embodiment of the invention, a MFP as defined above is disclosed, wherein the incubator comprising a user interface.

According to another embodiment of the invention, a MFP as defined above is disclosed, wherein at least a portion of the user interface is integrated into at least one selected from a group consisting of: at least one of the n panels, the MFP and any combination thereof.

According to another embodiment of the invention, a MFP as defined above is disclosed, wherein the user interface is connected to a component selected from a group consisting of: the MFP, life support equipment, at least one sensor, CPU, power supply, temperature regulating system, lighting system, at least one indicator, display, and any combination thereof.

According to another embodiment of the invention, a MFP as defined above is disclosed, wherein the incubator comprises an alarm system.

According to another embodiment of the invention, a MFP as defined above is disclosed, wherein the alarm system is connected to a component selected from a group consisting of: the MFP, at least one sensor, at least one indicator, a user interface, a CPU, an interlock mechanism, life support equipment and any combination thereof.

According to another embodiment of the invention, a MFP as defined above is disclosed, wherein the MFP comprises a handle.

According to another embodiment of the invention, a MFP as defined above is disclosed, a multifunctional panel (MFP) comprising at least one life supporting element, useful for shutting an opening of a neonate's incubator, maneuverably connected to provide at least one closed configuration in which the neonate resides in an enclosed environment and deployed into an at least one open configuration as a life supporting countertop in which the neonate resides in an open environment.

According to another embodiment of the invention a MFP as defined above is disclosed, the deployment of the incubator from an open configuration to a closed configuration, configured to maintain the accommodated neonate immovable.

According to another embodiment of the invention a MFP as defined above is disclosed, wherein the incubator comprising at least one opening and closing mechanism, the mechanism is connected to at least a portion of the MFP, and to at least a portion of at least a second of the n incubator panels, further wherein the mechanism is configured to maneuver the MFP such that the incubator is provided with the at least one first open configuration and the at least one first closed configuration.

According to another embodiment of the invention a MFP as defined above is disclosed, wherein the incubator comprising at least one collapsible column, useful for supporting the MFP, the column comprising an elongated member having at least two opposite ends, further wherein at least one first end is maneuverably connected to the MFP, and at least one second end is reversibly connected to an element selected from a group consisting of: a cart, a storage unit, a transport device, a wall, the floor, an imaging apparatus, a treatment table, and any combination thereof.

According to another embodiment of the invention a MFP as defined above is disclosed, wherein the column is configured to be NORMALLY DEPLOYED when the incubator is in an open configuration.

According to another embodiment of the invention a MFP as defined above is disclosed, comprising a collapsible column, wherein the column is connected to a mechanism configured to close the MFP when column is collapsed.

According to another embodiment of the invention a MFP as defined above is disclosed, comprising a collapsible column, wherein the column is connected to the MFP by a mechanism configured to collapse the column when the incubator is in a closed configuration.

According to another embodiment of the invention, a MFP as defined above is disclosed, wherein the column is collapsible upon application of horizontal force in the axis of at least partial interception of the incubator within a selected from a group consisting of: an MRD, a medical treatment device, a transport device and any combination thereof.

According to another embodiment of the invention, a MFP as defined above is disclosed, wherein the column is connected by a reversible connection, a maneuverable connection or both.

According to another embodiment of the invention, a MFP as defined above is disclosed, wherein the column is foldable or retractable.

According to another embodiment of the invention, a MFP as defined above is disclosed, wherein the column is of a shape selected from a group consisting of: round, multifaceted, geometric, non-geometric, compound shape, and any combination thereof.

According to another embodiment of the invention, a MFP as defined above is disclosed, wherein the column is comprised of a plurality of interconnected pieces.

According to another embodiment of the invention, a MFP as defined above is disclosed, wherein the incubator comprising at least one mechanism, connected to at least a portion of the MFP, configured to transform at least one first open configuration to at least one first closed configuration, at least one closed configuration to at least one open configuration, or both.

According to another embodiment of the invention, a MFP as defined above is disclosed, wherein the mechanism comprises at least one first wing element connected to at least a portion of one first MFP and at least one second wing element connected to at least a portion of at least one additional panel; the wing is maneuverably coupled to the second wing; the mechanism is configured to transform at least one first open configuration to at least one first closed configuration and contrariwise.

According to another embodiment of the invention, a MFP as defined above is disclosed, wherein the mechanism comprises horizontal movement means, thereby enabling closing or opening of a sliding mechanism.

According to another embodiment of the invention, a MFP as defined above is disclosed, wherein the mechanism comprises rotating movement means around a pivot point.

According to another embodiment of the invention, a MFP as defined above is disclosed, wherein the mechanism comprises a magnetic opening and closing means.

According to another embodiment of the invention, a MFP as defined above is disclosed, wherein the mechanism comprises an electromagnetic lock.

According to another embodiment of the invention, a MFP as defined above is disclosed, comprising at least a portion of an external face exposed to the external environment and at least a portion of an internal face exposed to the internal environment, wherein the mechanism is selected from a group consisting of: a concealed mechanism, a mechanism mounted on at least a portion of the external face of the incubator, a mechanism mounted on at least a portion of the internal face of the incubator, at least partially embedded within at least a portion of the MFP, at least partially embedded within at least a portion of the incubator, and any combination thereof.

According to another embodiment of the invention, a MFP as defined above is disclosed, wherein the mechanism is a normally closed mechanism, thereby maintaining the incubator in a closed configuration when in a resting position.

According to another embodiment of the invention, a MFP as defined above is disclosed, wherein the mechanism is a normally opened mechanism, thereby maintaining the incubator in an open configuration when in a resting position.

According to another embodiment of the invention, a MFP as defined above is disclosed, wherein the incubator comprises a selected from a group consisting of: a movement sensor, a electromagnetic signal receiving device, an infrared sensor, a light sensor, a sound sensor, a contact sensor, a thermal sensor, an RF sensor, a receiver, a blue tooth technology device, Wi-Fi, Li-Fi, data receiving device, and any combination thereof.

According to another embodiment of the invention, a MFP as defined above is disclosed, wherein the MFP is connected to the incubator by at least one living hinge.

According to another embodiment of the invention, a MFP as defined above is disclosed, wherein the incubator comprises at least a portion of elastic material, enveloping an at least partially inflatable volume, at least partly connected to a frame, and an inflate and deflate mechanism; the elastic material is further connected to at least one hinge.

According to another embodiment of the invention, a MFP as defined above is disclosed, comprising an inflated configuration and a deflated configuration, wherein an inflated configuration deploys the MFP, and a deflated configuration encloses the incubator.

According to another embodiment of the invention, a MFP as defined above is disclosed, wherein the mechanism comprises a selected from a group consisting of: a push to open mechanism, a push to close mechanism, a self-closing mechanism, a soft closing mechanism, a soft opening mechanism, and any combination thereof.

According to another embodiment of the invention, a MFP as defined above is disclosed, comprising a plurality of MFP, wherein the incubator comprises a plurality of sliding mechanism for each the MFP; wherein the mechanisms are interconnected so as to provide simultaneous movement, when the incubator transforms between the opened and closed configurations.

According to another embodiment of the invention, a MFP as defined above is disclosed, comprising a plurality of MFPs, wherein maneuvering at least one first MFP, results in maneuvering of at least one second MFP.

According to another embodiment of the invention, a MFP as defined above is disclosed, wherein the incubator comprising at least one slideable element, and at least one sliding mechanism, along the perimeter between at least one MPF to at least one incubator panel; the slide able element comprises a recess along its longitudinal axis in which at least a portion of at least one of the n panels and at least a portion of the MFP are passed therethrough, thereby transforming the incubator between the opened and closed configurations.

According to another embodiment of the invention, a MFP as defined above is disclosed, wherein the MFP comprises at least a portion of a flexible flap.

According to another embodiment of the invention, a MFP as defined above is disclosed, wherein the incubator comprises a base, and at least one belt surrounding at least a portion of the incubator horizontal circumference, and at least a portion of the MFP, the belt is configure to have at least one first position at least partially adjacent to the incubator base, and at least one second position vertically elevated from first position; the belt is at least partially moveable along a vertical axis of the incubator, thereby transforming the incubator between a closed and open configuration.

According to another embodiment of the invention, a MFP as defined above is disclosed, wherein the incubator is connected to a mobile cart containing at least a portion of the mechanism.

According to another embodiment of the invention, a MFP as defined above is disclosed, comprising a plurality of MFP's, at least one opening mechanism, closing mechanism, or both, connected to each MFP, at least two of the maneuvering systems are interconnected to at least one bar; the bar is further interconnected to a main moveable shaft having a protrusion external to the incubator, wherein the moveable shaft is configured to maneuvering the connected MFP's thereby closing or opening the incubator.

According to another embodiment of the invention, a MFP as defined above is disclosed, wherein the mechanism is configured to have a controlled soft closure mechanism.

According to another embodiment of the invention, a MFP as defined above is disclosed, wherein the mechanism is selected from a group consisting of: manual, automatic, and any combination thereof.

According to another embodiment of the invention, a MFP as defined above is disclosed, wherein the mechanism is configured to simultaneously close or open a plurality of MFPs.

According to another embodiment of the invention, a MFP as defined above is disclosed, wherein the mechanism is connected to a power supply selected from a group consisting of: AC, DC and any combination thereof.

According to another embodiment of the invention, a MFP as defined above is disclosed, wherein the incubator alternates between the open configuration to a closed configuration by a remote control mechanism.

According to another embodiment of the invention, a MFP as defined above is disclosed, wherein the opening mechanism is an emergency opening mechanism.

According to another embodiment of the invention, a MFP as defined above is disclosed, wherein the mechanism comprises an interlock mechanism.

According to one embodiment of the present invention, a magnetic resonance system (MRS), useful for imaging a patient, comprising: (a) a magnetic resonance device (MRD) at least partially encased in an envelope, having at least one longitudinal axis with a distal and proximal ends, an open bore extended along the axis, and a sliding mechanism connected to at least a portion of the envelope within the open bore; and, (b) an incubator, comprising n panels, at least one of which, or portion thereof, is a multi-functional panel (MFP), reversibly connected to at least one of the n panels; n is an integer equal to or greater than 3; the incubator having at least one first CLOSED CONFIGURATION, sealingly enclosing an internal environment of the incubator; and at least one first OPEN CONFIGURATION, in which the MFP is deployable as a countertop, wherein the sliding mechanism is configured to guide the MFP to a closed configuration when inserted into the MRD.

Additionally or alternatively, the system is of a deployable incubator and a transport device, medical device, ambulance, etc. A transport device comprising an inner volume along a longitudinal axis having a distal and proximal ends, an aperture on the distal end, and a closeable door on the proximal end, and a an incubator, comprising n panels, at least one of which, or portion thereof, is a multi-functional panel (MFP), reversibly connected to at least one of the n panels; n is an integer equal to or greater than 3; the incubator having at least one first CLOSED CONFIGURATION, sealingly enclosing an internal environment of the incubator; and at least one first OPEN CONFIGURATION, in which the MFP is deployable as a countertop, wherein the transport device comprises a sliding mechanism that is configured to guide the incubator into a closed configuration when inserted into the inner volume of the transport device. Additionally or alternatively, the transport device, ambulance, medical device and etc., comprises a signal transmitting unit able to communicate with a receiving unit placed on the incubator, thereby transmitting a signal to an opening or closing mechanism of the incubator to provide an open or closed configuration.

According to another embodiment of the invention, a MRS as defined above is disclosed, wherein the incubator comprises at least one protrusion in the circumference of the MFP fitted to be at least partly guided with the sliding mechanism.

According to another embodiment of the invention, a MRS as defined above is disclosed, wherein at least a portion of the sliding mechanism is connected to the incubator.

According to one embodiment of the present invention, a magnetic resonance system (MRS), useful for imaging a patient, comprising: (a) a magnetic resonance device (MRD) at least partially encased in an envelope, having a main longitudinal axis with a distal and proximal ends, an open bore extended along the axis, and at least one signaling device connected to at least a portion of the envelope; and (b) an incubator, comprising n panels, at least one of which, or portion thereof, is a multi-functional panel (MFP), reversibly connected to at least one of the n panels; n is an integer equal to or greater than 3; at least one opening mechanism providing the incubator with at least one open configuration in which the MFP is deployable as a countertop and at least one closed configuration sealingly enclosing an internal environment of the incubator; the mechanism comprising maneuvering means and at least one signal receiving unit; wherein the mechanism is configured to alternate between open and closed configurations depending on a predefined signal or lack of signal received in the receiving unit.

According to one embodiment of the present invention, a method for closing a deployable incubator comprising the steps of: (a) obtaining a deployable neonate's incubator, comprising n panels, at least one of which or portion thereof is a multi functional panel (MFP), reversibly attached to at least one of the n panels; n is an integer greater than 3; The incubator further comprises at least one collapsible column, useful for supporting the MFP, the column comprising an elongated member having at least two opposite ends, at least one first end is maneuverably connected to the MFP, and at least one second end is reversibly connected to an element selected from a group consisting of: a cart, a storage unit, a transport device, a wall, the floor, an imaging apparatus, a treatment table, and any combination thereof maneuvering at least one MFP or a portion thereof; (b) collapsing the column to a position alongside the MFP, wherein the step of collapsing the column is deploying the incubator from at least one first OPEN CONFIGURATION, in which the neonate is loosely accommodated within of the incubator to at least one first CLOSED CONFIGURATION, in which the neonate is sealingly enclosed within the closed environment of the incubator.

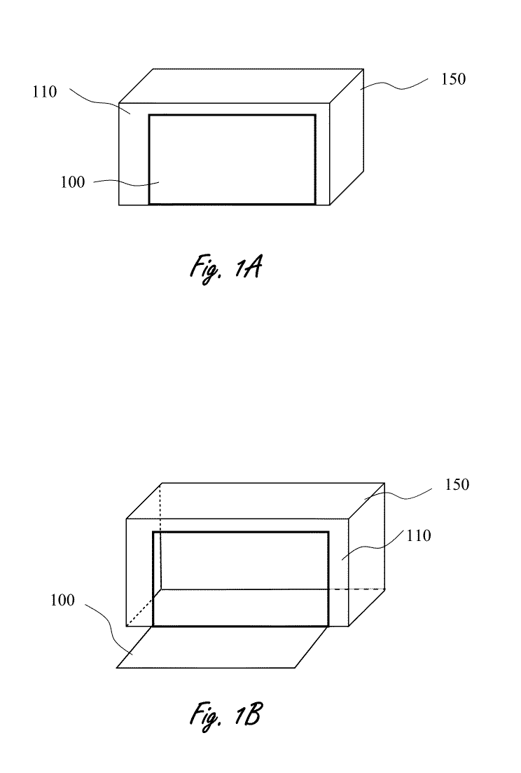

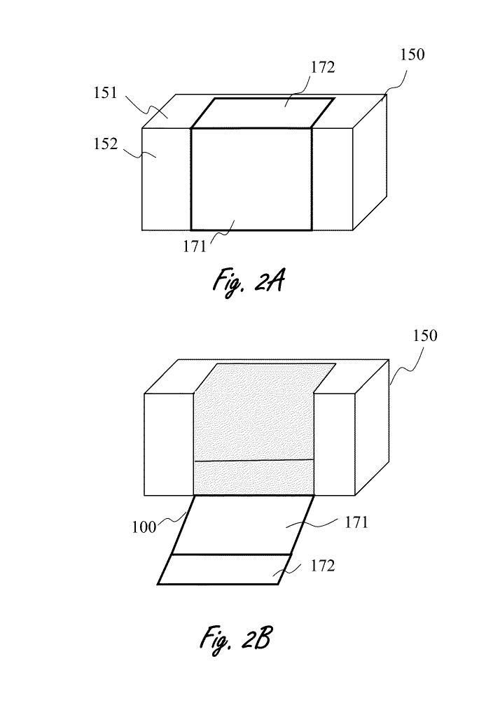

Reference is now made to FIG. 1A schematically illustrating, in an out of scale manner, an embodiment of the invention. An incubator (150), comprising a deployable MFP (100) providing closed and opened configurations of the incubator. The MFP is reversibly attachable to at least a portion the incubator. In a closed incubator configuration the MFP is integrated into a panel (110) of the incubator. In an embodiment this MFP comprises at least a portion of the incubator face.

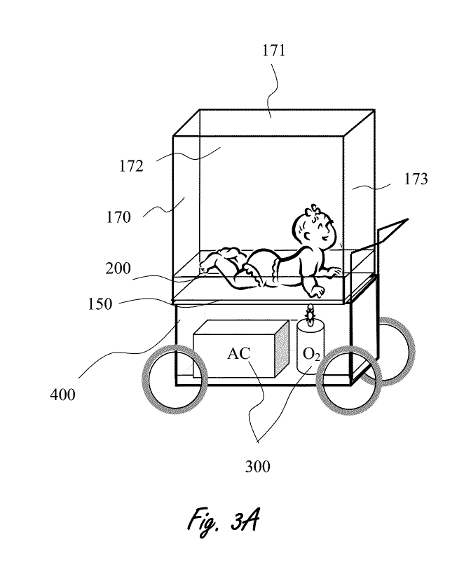

Reference is now made to FIG. 1B schematically illustrating, in an out of scale manner, an embodiment of the invention. An incubator (150), comprising a deployable MFP (100) providing closed and opened configurations. The MFP is maneuverably connected to the incubator. In an opened configuration (FIG. 2B) the MFP folds out and deploys to a planar surface (100). By remaining open, the neonate accommodated inside the incubator is accessible. The planar surface formed by the MFP in a folded, deployed configuration, comprises at least one life support element.

Reference is now made to FIG. 2A schematically illustrating, in an out of scale manner, an embodiment of the invention. A schematic illustrations of an embodiment of an incubator (150), comprising a deployable MFP (100), where the MFP comprises two sections (171, 172) and is integrated into two incubator faces (151, 152) when in closed configuration. In an embodiment the MFP is comprised of multiple sections, integrated into the same or different incubator panels.

Reference is now made to FIG. 2B schematically illustrating, in an out of scale manner, an embodiment of the invention. A deployable MFP (100) in an incubator (150), providing closed and opened configurations. The MFP is maneuverably connected to the incubator. In an opened configuration (FIG. 2B) the MFP folds out and deploys to at least a partially planar countertop (100). By remaining open the neonate accommodated inside the incubator is accessible. The planar surface formed by the MFP in a folded, deployed configuration, comprises at least one life support element. In an embodiment the MFP is folded out in at least one step.

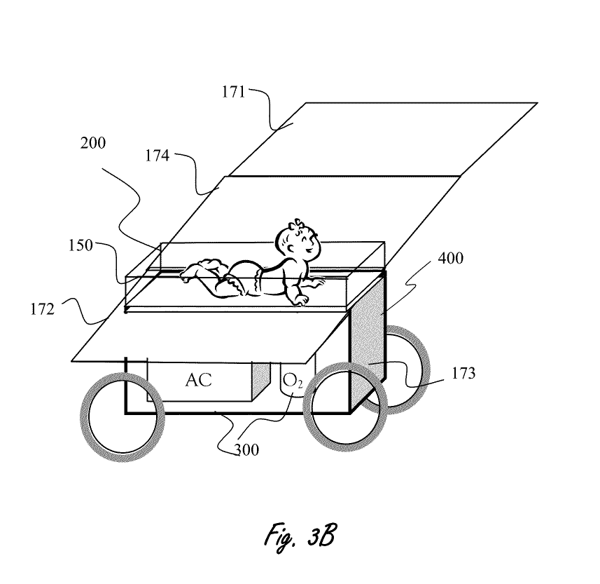

Reference is now made to FIG. 3A schematically illustrating, in an out of scale manner, an embodiment of the invention. An incubator (200), comprising an incubator base (150), further comprising multiple deployable MFPs (170, 171, 172, 173,) providing closed and opened configurations. The MFP is maneuverably connected to the incubator, accommodated upon a mobile cart (400). The cart further accommodates life support systems such as an air condition system and an oxygen tank (300). The planar countertop formed by the MFP in a folded, deployed configuration, comprises at least one life support element

Reference is now made to FIG. 3B schematically illustrating, in an out of scale manner, an embodiment of the invention. An incubator (200), comprising multiple deployable MFPs (171, 172, 173 and 174) providing closed and opened configurations. Illustrating an open configuration, where some of the incubator faces (171, 172 and 174) are deployed into a countertop and another incubator panel (173) is folded in a downward direction integrating with a panel of the connected mobile cart (400). The neonate is then placed in an accessible opened configuration in the incubators base (150). The planar surface formed by the MFP in a folded, deployed configuration, comprises at least one life support element.

Reference is now made to FIG. 3C schematically illustrating, in an out of scale manner, an embodiment of the invention. Deployable multi MFPs (170-174) in an incubator in a closed configuration, accommodated upon a mobile cart (400), having mechanical-means (410) for conveying the incubator into and out of an imaging-device (500). The incubator and the multiple MFPs are comprised of MRI-safe material. The cart at least partially accommodates life support systems (300) such as an air condition system and oxygen tank.

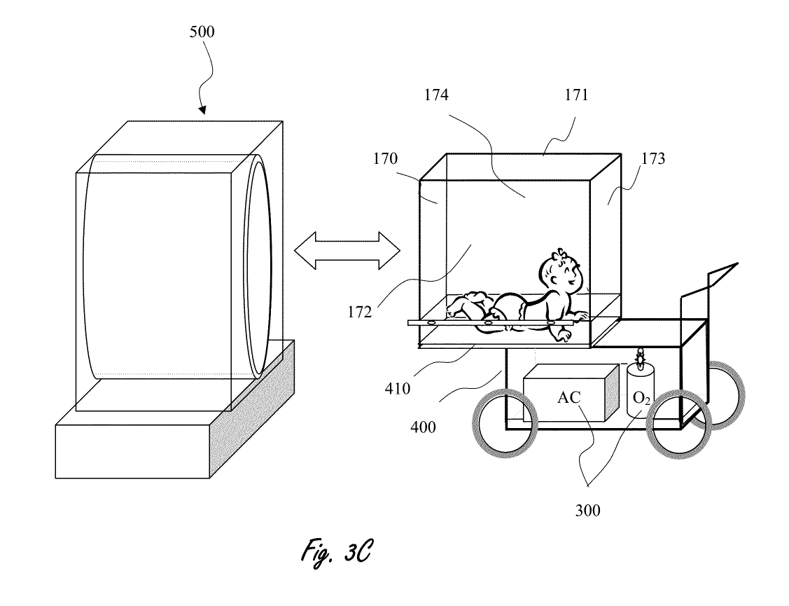

Reference is now made to FIG. 4 schematically illustrating, in an out of scale manner, an embodiment of the invention. In this embodiment the incubator (200) is in a cylindered shape having an MFP (170) and a non-mobile panel (172). The arrows depict the angle of opening the MFP, while the neonate is placed on a planar surface (150). The MFP comprises a handle (112).

Reference is now made to FIG. 5 schematically illustrating, in an out of scale manner, an embodiment of the invention. A schematic illustration of a rectangular embodiment of a deployable MFP (170) connected by a hinge in an incubator (200). The connection element (131) is selected from a group consisting of: a hinge, a pivot pin, sliding mechanism, telescopic mechanism, magnetic attachment and any combination thereof. The connection element provides movement provides movement of the MFP (170) in relation to the other incubator faces (150) remaining stable. In an open configuration the incubator base (134) is surrounded by side panels (155). The arrow indicates the opening angle of the MFP in relation the incubator connected with for example a hinge (131).

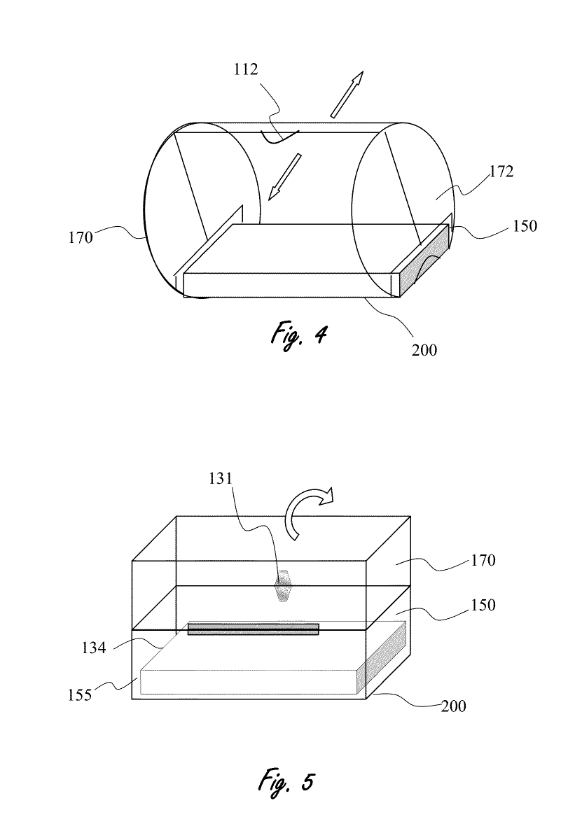

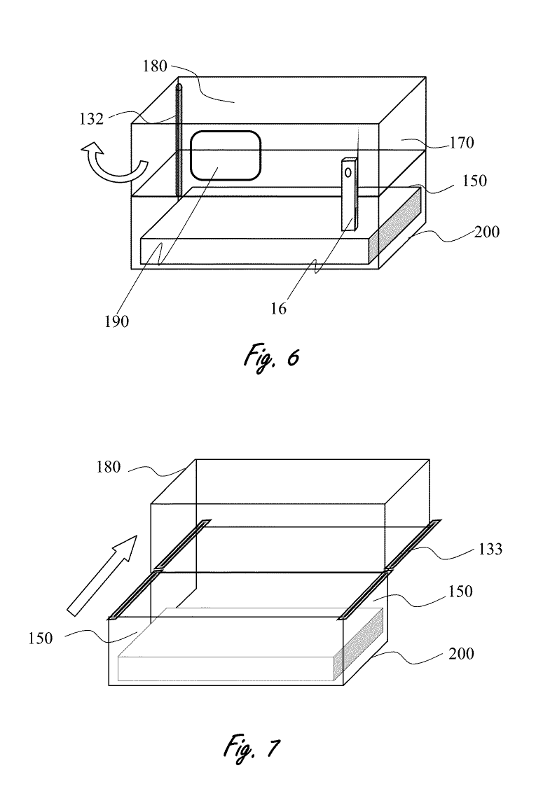

Reference is now made to FIG. 6 schematically illustrating, in an out of scale manner, an embodiment of the invention. A schematic illustration of a rectangular embodiment of a deployable MFP (180) connected by a pivotal point (132) in an incubator (200). The connection element (132) is selected from a group consisting of: a hinge, a pivot pin, sliding mechanism, telescopic mechanism, magnetic attachment and any combination thereof. The connection element provides movement provides movement of the MFP (180) in relation to the other incubator faces (150) remaining stable. The arrow indicates the opening angle of the MFP in relation the incubator connected with for example a pivot point (132). The MFP (180) comprises a portion of transparent material, enabling view of at least a portion of the neonate when the incubator (200) is in closed configuration. Further, the MFP (180) comprises a latching mechanism (16) securing the incubators closed or opened configurations.

Reference is now made to FIG. 7 schematically illustrating, in an out of scale manner, an embodiment of the invention. A schematic illustration of a rectangular embodiment of a deployable MFP (180) connected by a sliding mechanism (133) in an incubator (200). The connection element (133) is selected from a group consisting of: a hinge, a pivot pin, sliding mechanism, telescopic mechanism, magnetic attachment and any combination thereof. The connection element provides movement provides movement of the MFP (180) in relation to the other incubator faces (150) remaining stable. The arrow indicates the opening angle of the MFP in relation the incubator connected with for example a sliding mechanism (132).

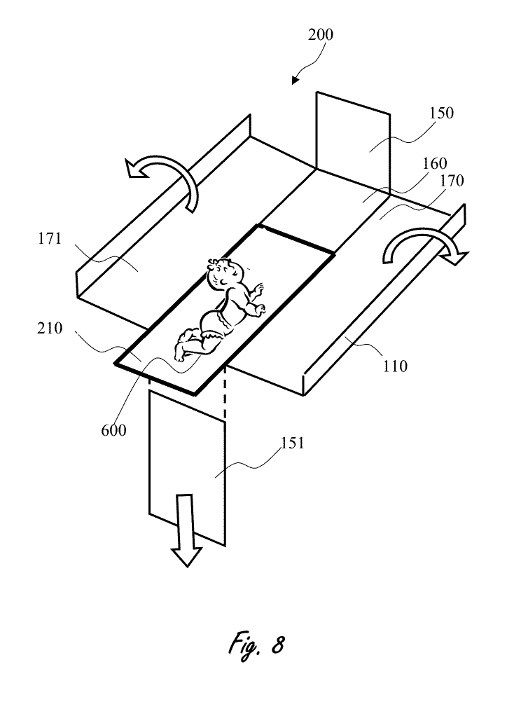

Reference is now made to FIG. 8 schematically illustrating, in an out of scale manner, an embodiment of the invention. A schematic illustration of a rectangular embodiment of an incubator (200) comprising multiple deployable MFPs (151, 170, 171). In this embodiment two of the MFPs (170, 171) deploy to a horizontal configuration, while MFP (151) deploys towards the bottom to a configuration perpendicular to the floor. The MFPs (170) and (171) contain side panels (110) that can be maneuvered to a perpendicular configuration when MFP is deployed as a countertop. The incubator perpendicular panel (150) remains in configuration. The neonate (600) is placed on a base (210) that can be stationary or completely detached as an independent module. The arrows indicate the direction in which the MFP (170, 171, 151) moves in relation to other incubator faces that remain stationary (150, 160).

Reference is now made to FIGS. 9A and 9B, schematically illustrating, in an out of scale manner, a rectangular embodiment of an MFP (100) deployable as a drawer in an incubator (150). The MFP further comprises a handle for the user. In this embodiment the incubator comprises a second MFP (140) interconnected to the incubator by a hinged connecting element (111) maneuverable towards the top of the incubator (155). This MFP (140) harbors a knob for easy opening. The arrows indicate the direction in which the MFPs are moveable in reference to the stationary parts of the incubator (150).

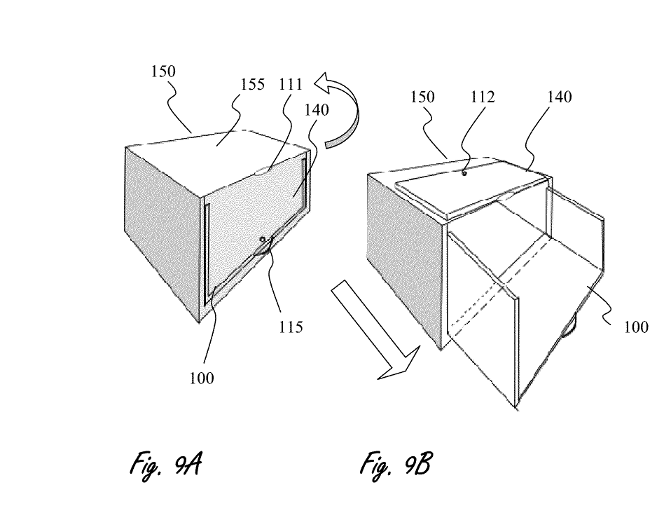

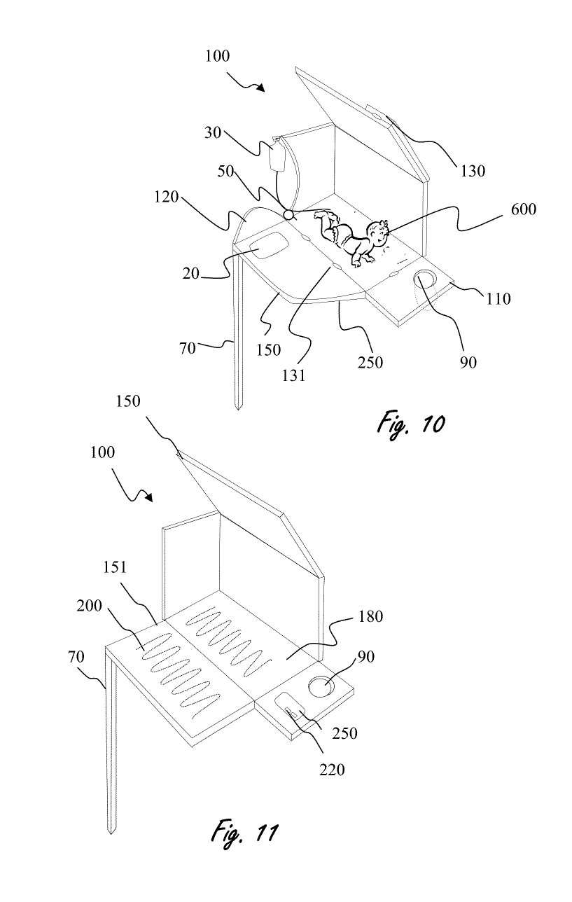

Reference is now made to FIG. 10 schematically illustrating, in an out of scale manner, an embodiment of the invention. In this embodiment the incubator (100) is portrayed deployed in an open configuration, while the neonate (600) is placed in an opened environment, on a stationary base (180). The incubator (100) comprises multi deployable MFPs (110, 120, 130, 140, 150, 160). The MFP can contain an opening connected to a disposable waste container (90). One of the MFPs (130) is held in an opened configuration by magnetic attachment element (132). Some MFPs remain in a configuration perpendicular to the floor (120) thereby forming a barrier protecting from the accidental fall of objects or patients. Another MFP (150) is maneuverable by a hinged connecting element (131). Further connected to this MFP (150) is a foldable support (70) connecting and stabilizing the MFP to the ground. In this embodiment an MFP (160) comprises medical equipment (30), and a placement for medical equipment tubing (50). Further, an MFP (150) can comprise a placement for sterilized medical treatment tools (20). In addition this embodiment portrays an MFP with a concaved shape (250) providing the handler easy wide access to the neonate when all MFPs of the incubator are fully deployed.

Reference is now made to FIG. 11 schematically illustrating, in an out of scale manner, an embodiment of the invention. A schematic illustration of multiple MFPs (150) in an incubator (100), comprising a foldable leg support (20). In this embodiment, the MFP (151) and the incubator base comprise a temperature regulating system (200) embedded within the panel. Further, the MFP (152) comprises a user interface (250) harboring indicators (220) selected from a group consisting of: visual, auditable and sensory indicators. This MFP (152) further comprises an opening (90) for the connection of exterior systems such as a ventilating system, oxygen supply, neonate when in a closed configuration.

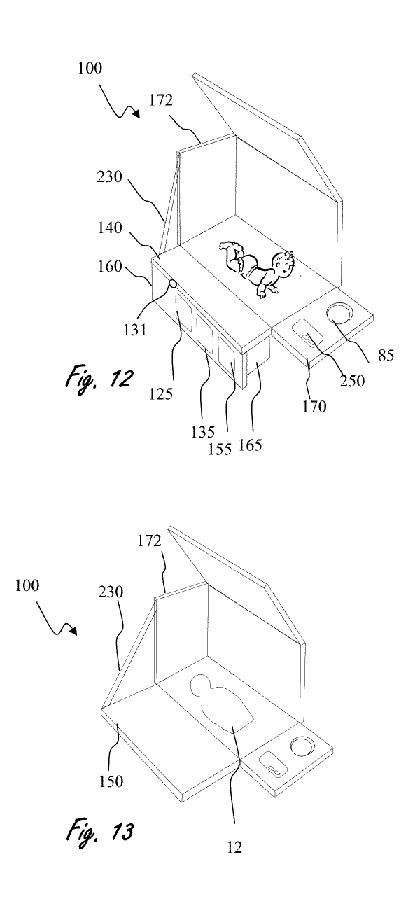

Reference is now made to FIG. 12 schematically illustrating, in an out of scale manner, an embodiment of the invention. A schematic illustration of an incubator (100) showing an embodiment of multiple MFPs. One of the MFP (170) comprises a user interface (250) and at least one opening (85). Another MFP (140) comprises two portions (145, 146) interconnected by a hinge element (131) providing motion there between. The MFP portion (146) is connected to a support element (230) connecting it to an incubator's panel (172). The MFP portion (145) further comprises openings (125, 135, 155) connected to modules (165) such as CPU, disposable waste container, interlock mechanism etc.

Reference is now made to FIG. 13 schematically illustrating, in an out of scale manner, an embodiment of the invention. A schematic illustration of an embodiment of multiple MFPs in an incubator (100), comprising an ergonomic placement for a neonate (12) placed on an incubator panel functioning as a base (180). A support element (230) connects one MFP (150) to another MFP (172).

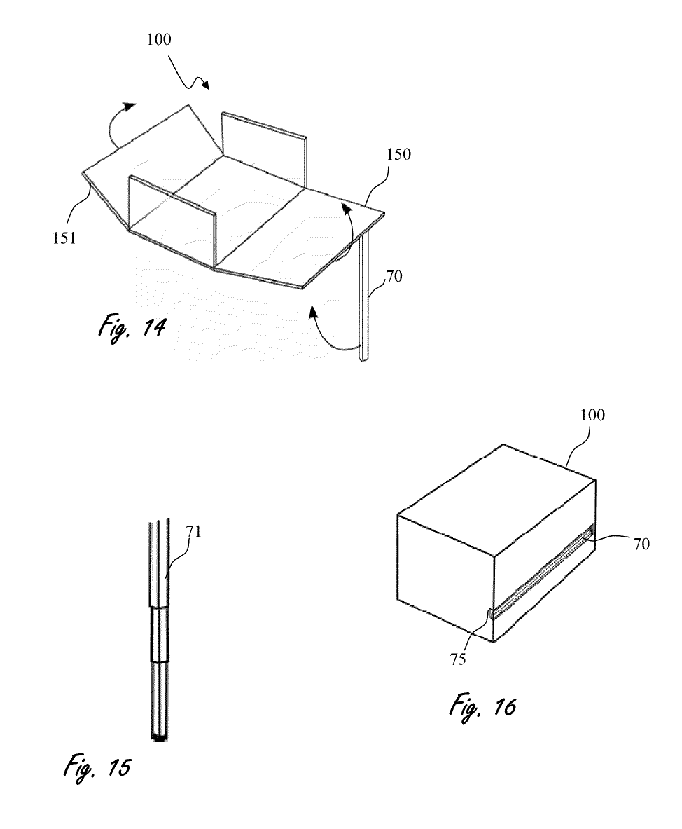

Reference is now made to FIG. 14 schematically illustrating, in an out of scale manner, an embodiment of the invention. A schematic illustration of a part of a deployable incubator (100) having multiple MFPs (150, 151). At least one MFP is connected to a collapsible column (70). Arrows A and B indicated the direction of closure for each MFP (151, 150) and arrow C shows the direction of the folding or collapsing of the column providing support to the MFP.

Reference is now made to FIG. 15 schematically illustrating, in an out of scale manner, an embodiment of the invention. A schematic illustration of a part of a column (71) having a telescopic mechanism for changing the length of the column, thereby providing adjustment of the height and angle of the MFP.

Reference is now made to FIG. 16 schematically illustrating, in an out of scale manner, an embodiment of the invention. A schematic illustration showing an embodiment of a column (70) in a folded position, connected to the incubator (100). In this example the column is embedded within at least one incubator panel, in a designated recess (75). The column can be alternatively only partially embedded or placed on top of the panel.

Reference is now made to FIG. 17 schematically illustrating, in an out of scale manner, an embodiment of the invention. A schematic illustration of a deployable incubator (100), having a multifunctional panel (MFP) (150). The panel (150) is connected to a mechanism (300) able to open, close or both the MFP to form a closed environment incubator. The mechanism (300) consists of a hinged arm, and can work as a hydraulic arm, an oil pressure system, a spring system, and etc. Further this mechanism can be within the internal environment of the incubator, on the outside, or any combination thereof.

Reference is now made to FIG. 18 schematically illustrating, in an out of scale manner, an embodiment of the invention. A schematic illustration of a part of a deployable incubator, where the MFP (150) is connected to one of n panels by a hinge mechanism (350) configured to enable opening and closing of the MFP (changing the angle of the MFP relative to one of n panels). This mechanism can be based on a hinge connected to at least one spring, further this mechanism can be a soft close or soft open mechanism. In an embodiment the mechanism has at least two predetermined resting positions, for example in a closed or opened position when the MFP is deployed as a life supporting countertop. The mechanism can be further connected by a series of levers to an external operating interface (35) such as a button or handle. This enables the handler to open the MPF from another location. Additionally or alternatively, this mechanism can be controlled by an electrical locking system, a magnet or a push to open mechanism.

Reference is now made to FIG. 19 schematically illustrating, in an out of scale manner, an embodiment of the invention. A schematic illustration representing a deployable incubator (100) connected to an external arm (360) providing means for opening, closing or both at least one panel of the deployable incubator. This mechanism can be configured to receive a signal in a designated receiver (385) and further this signal to a CPU controlling the movement of the connected arm. This mechanism includes an engine or any device transforming electrical power to a physical movement.

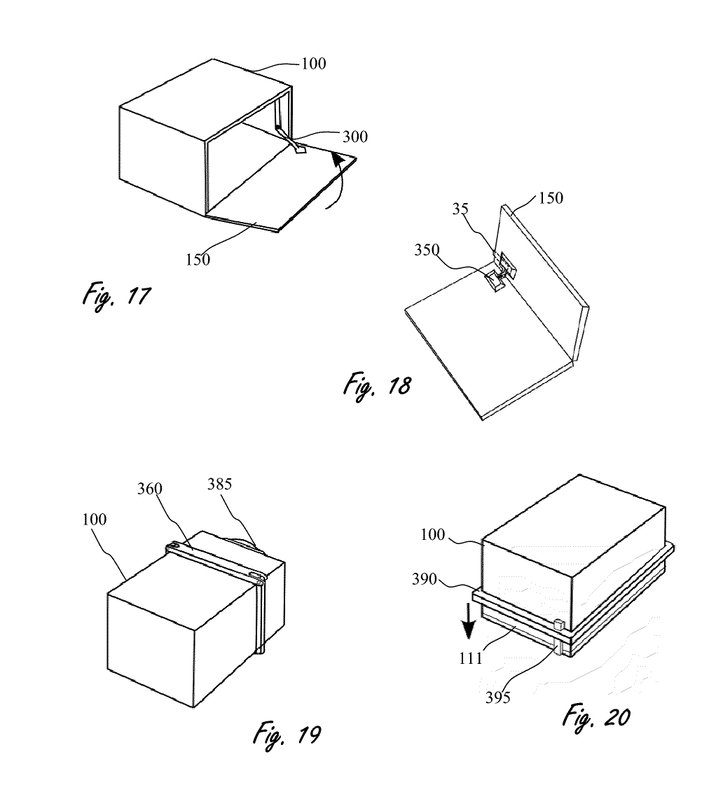

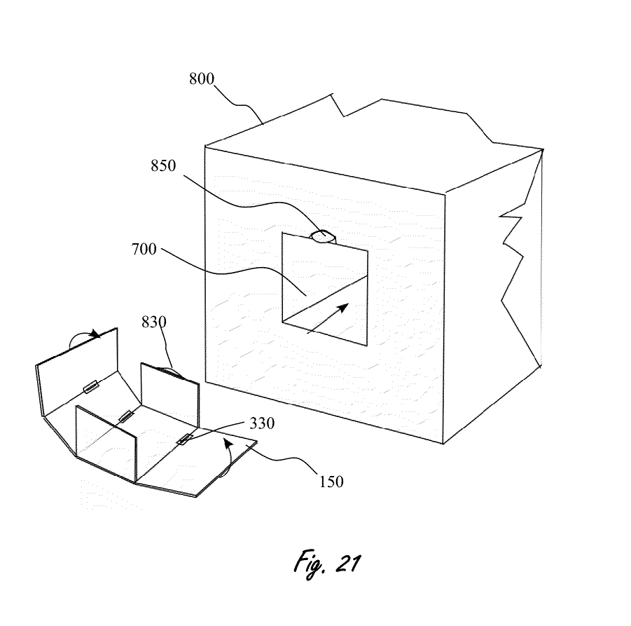

Reference is now made to FIG. 20 schematically illustrating, in an out of scale manner, an embodiment of the invention. A deployable incubator (100) having at least one MFP, closed by a vertical motion of a belt (390) along a designated track (395). When the belt is lowered, at least one incubator panel held by the closing force of the belt is released to open pivotally or around a hinge, along the line represented by (111), and contrariwise to close the MFP. The MFP in this embodiment can be a ‘normally opened’ panel, or a panel maneuverable automatically or manually.

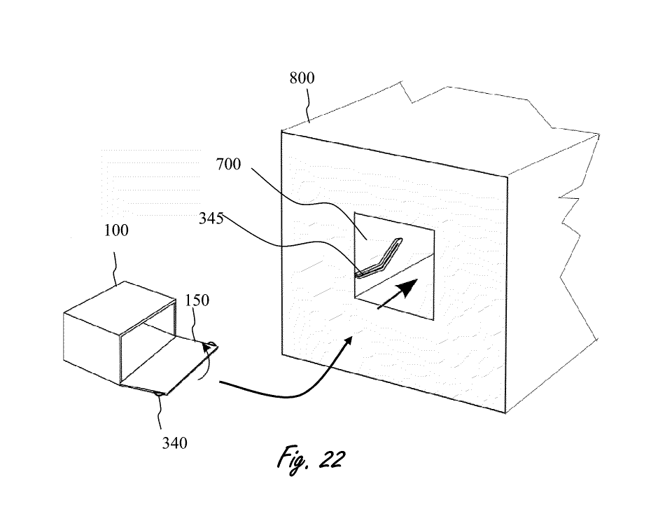

Reference is now made to FIG. 21 schematically illustrating, in an out of scale manner, an embodiment of the invention. A schematic representation of an device (800), This device is such as an MRD, an ambulance, a transport device, a treatment device, a medical device, etc., having an open bore (700) or an entrance to an inner volume, having a signaling device (850) communicating a signal receivable by a receiver unit placed connected to the deployed incubator. The incubator comprises means to close, open or move to a manual operating system for maneuvering at least one MFP (150) when detecting a signal transmitted by the MRD. The signal and response can be preprogrammed for example to close when the incubator is in proximity to the MRD or other device, and open when in a specific distance, or to operate manually is when absent of a signal, or when receiving a certain signal. The MFP is connected in a maneuverable manner to at least one of n panels, for example by a hinge (330), pivot point, sliding mechanism, magnetic connection and etc.

Reference is now made to FIG. 22 schematically illustrating, in an out of scale manner, an embodiment of the invention. A schematic representation of a device (800), this device is such as an MRD, an ambulance, a transport device, a treatment device, a medical device, etc., having an open bore (700) or an entrance to an inner volume, having a sliding mechanism (345) connected within the circumference of the open bore. The deployable incubator (100), presented in a perspective, comprises at least one MFP (150) having at least one protrusion (340) fitting to be inserted and maneuvered along the device or MRD (800) sliding mechanism (345). Inserting the incubator includes positioning the incubator with the open MFP toward the open bore, so that opposite sides of the MFP are inserted or guided with the sliding mechanism into the device or MRD. The sliding mechanism is configured so that the sliding track (345) is applying force in an angle so that the MFP (150) is maneuvered close an internal environment of the incubator when reaching the end of the track and the incubator is inserted within the device or MRD (800).

What is claimed is:

1. An incubator, comprising n panels, at least one of which or portion thereof is a multi functional panel (MFP), reversibly connected to said at least one of said n panels; n is an integer equal to or greater than 3; said incubator is characterized by at least one first CLOSED CONFIGURATION, sealingly enclosing an internal environment of said incubator; and at least one first OPEN CONFIGURATION, in which said MFP is deployable as a countertop.

2. The incubator according to claim 1, wherein said incubator comprising life support equipment.

3. The incubator according to claim 1, wherein said MFP is maneuverably connected to said incubator by a mechanism selected from a group consisting of: hinge mechanism, pivot point mechanism, sliding mechanism, telescopic mechanism, magnetic attachment mechanism and any combination thereof.

4. The incubator according to claim 1, wherein said MFP comprises at least two sections.

5. The according to claim 4, wherein said MFP sections are maneuverably connected therebetween by a mechanism selected from a group consisting of: hinge mechanism, pivot point mechanism, sliding mechanism, telescopic mechanism, magnetic attachment mechanism and any combination thereof.

6. The incubator according to claim 1, wherein at least a portion of said incubator comprising MRI safe material.

7. The incubator according to claim 1, wherein said incubator comprising at least one opening and closing mechanism, said mechanism is connected to at least a portion of said MFP, and to at least a portion of at least a second of said n incubator panels, further wherein said mechanism is configured to maneuver said MFP such that said incubator is provided with said at least one first open configuration and said at least one first closed configuration.

8. The incubator according to claim 1, wherein said incubator comprising at least one collapsible column, useful for supporting said MFP, said column comprising an elongated member having at least two opposite ends, further wherein at least one first end is maneuverably connected to said MFP, and at least one second end is reversibly connected to an element selected from a group consisting of: a cart, a storage unit, a transport device, a wall, the floor, an imaging apparatus, a treatment table, and any combination thereof.

9. The incubator according to claim 8, wherein said column is configured to be NORMALLY DEPLOYED when said incubator is in an open configuration.

10. The incubator according to claim 8, comprising a collapsible column, wherein said column is connected to a mechanism configured to close said MFP when column is collapsed.

11. The incubator according to claim 8, comprising a collapsible column, wherein said column is connected to said MFP by a mechanism configured to collapse said column when said incubator is in a closed configuration.

12. In an incubator, comprising n panels, a multi-functional panel (MFP) reversibly connected to at least a one of said n panels; n is an integer equal to or greater than 3; characterized by at least one first CLOSED CONFIGURATION, sealingly enclosing internal environment of said incubator; and at least one first OPEN CONFIGURATION, in which said MFP is deployable as a countertop.

13. The MFP according to claim 12, wherein said incubator comprising life support equipment.

14. The MFP according to claim 12, wherein said MFP is at least a portion of at least one of n panels.

15. The MFP according to claim 12, wherein said MFP is maneuverably connected to said incubator by a mechanism selected from a group consisting of: hinge mechanism, pivot point mechanism, sliding mechanism, telescopic mechanism, magnetic attachment mechanism and any combination thereof.

16. The MFP according to claim 12, wherein said MFP comprises at least two sections.

17. The MFP according to claim 16, wherein said MFP sections are maneuverably connected therebetween by a mechanism selected from a group consisting of: hinge mechanism, pivot point mechanism, sliding mechanism, telescopic mechanism, magnetic attachment mechanism and any combination thereof.

18. The MFP according to claim 12, wherein at least a portion of said incubator comprising MRI safe material.

19. The MFP according to claim 12, wherein said incubator comprising at least one opening and closing mechanism, said mechanism is connected to at least a portion of said MFP, and to at least a portion of one of said n incubator panels, further wherein said mechanism is configured to maneuver said MFP such that said incubator is provided with said at least one first open configuration and said at least one first closed configuration.

20. The MFP according to claim 12, wherein said incubator comprising at least one collapsible column, useful for supporting said MFP, said column comprising an elongated member having at least two opposite ends, further wherein at least one first end is maneuverably connected to said MFP, and at least one second end is reversibly connected to an element selected from a group consisting of: a cart, a storage unit, a transport device, a wall, the floor, an imaging apparatus, a treatment table, and any combination thereof.

21. The MFP according to claim 20, wherein said column is configured to be NORMALLY DEPLOYED when said incubator is in an open configuration.

22. The MFP according to claim 20, comprising a collapsible column, wherein said column is connected to a mechanism configured to close said MFP when column is collapsed.

23. The MFP according to claim 20, comprising a collapsible column, wherein said column is connected to said MFP by a mechanism configured to collapse said column when said incubator is in a closed configuration.

24. A method for manufacturing an incubator, comprising steps of:
a. obtaining an incubator, comprising n panels; n is an integer equals to or greater than 3;
b. obtaining at least one panel or portion thereof a multi-functional panel (MFP); and
c. reversibly connecting said MFP to said at least one of said n panels;
wherein said step of reversibly connecting said MFP to said at least one of said n panels is characterized by creating at least one first CLOSED CONFIGURATION, sealingly enclosing internal environment of said incubator; and at least one first OPEN CONFIGURATION, in which said MFP is deployed as a countertop.

25. The method of claim 24, additionally comprising a step of constructing said incubator having life support equipment.

26. A method for deploying an incubator's panel or a portion thereof into a countertop, comprising steps of:
a. obtaining an incubator comprising n panels, at least one of which or portion thereof is a multi functional panel (MFP), reversibly connecting to at least one of said n panels; n is an integer greater than 3;
b. maneuvering at least one said MFP or a portion thereof;
wherein said step of maneuvering at least one said MFP is deploying said incubator from at least one first CLOSED CONFIGURATION, sealingly enclosing internal environment of said incubator; and at least one first OPEN CONFIGURATION, in which said MFP is deployable as a countertop.

27. The method of claim 26, additionally comprising a step of connecting life support equipment to said incubator.
